(19) United States
(12) Patent Application Publication
(10) Pub. No.: US 2004/0133979 A1
(43) Pub. Date: Jul. 15, 2004

(54) Orthopedic table apparatus

(76) Inventors: David C. Newkirk, Lawrenceburg, IN (US); Richard L. Borders, Erie, CO (US); Richard H. Heimbrock, Cincinnati, OH (US)

Correspondence Address: BARNES & THORNBURG, 11 South Meridian Street, Indianapolis, IN, 46204, US

(21) Appl. No.: 10/341,289

(22) Filed: Jan. 13, 2003

(51) Int. Cl. A61G 13/08; A61G 13/12

(52) U.S. Cl. 5/600; 5/623; 5/624; 5/618

(57) ABSTRACT

According to an aspect of this disclosure, a surgical table is convertible from a general-purpose surgical table to an orthopedic surgical table. The surgical table includes a base module and a number of modular attachments that couple to the base module to configure the surgical table for various types of orthopedic surgery.

### BACKGROUND

The present disclosure relates to surgical tables, and particularly to an orthopedic table apparatus. More particularly, the present disclosure relates to an orthopedic table apparatus that is configurable for various types of orthopedic surgery.

Orthopedic surgery is surgery performed on a patient's bones and related nerves and connective tissue. Examples of common orthopedic surgeries include joint replacement, joint reconstruction, and fracture repair. Orthopedic surgery dealing with a patient's legs, shoulders, or spine are quite common. Some known surgical tables are usable for multiple types of surgeries, including orthopedic surgery.

### SUMMARY

According to an aspect of this disclosure, a surgical table is convertible from a general-purpose surgical table to an orthopedic surgical table. The surgical table includes a base module and a number of modular attachments that couple to the base module to configure the surgical table for various types of orthopedic surgery.

In illustrative embodiments, a patient support apparatus comprises a first section configured to support a first portion of a patient and a pair of articulated traction bar assemblies coupled to the first section. In these illustrative embodiments, a plurality of orthopedic surgery modules are configured to couple to the pair of traction bar assemblies. The plurality of orthopedic surgery modules includes a pair of first modules that are configured to apply traction to a patient's legs. A second module of the plurality of orthopedic surgery modules is configured to support an upper portion of a patient during shoulder surgery. A third module of the plurality of modules is configured to support an upper portion of a patient during spinal surgery.

Also according to this disclosure, a patient support apparatus comprises an elongated patient support deck having a first section configured to support a first portion of a patient, a transverse bar coupled to the first section and a pair of traction bar assemblies coupled to the transverse bar. Each of the pair of traction bar assemblies is movable transversely along the transverse bar.

In illustrative embodiments, a seat section is coupleable to the transverse bar and is movable transversely along the transverse bar. Also in illustrative embodiments, any one of the following is attachable to the traction bar assemblies: a trauma surgery module configured to apply traction to a patient's legs, a spinal surgery module configured to support a patient's upper body during spinal surgery, and a shoulder surgery module configured to support a patient's upper body during shoulder surgery.

In another illustrative embodiment, a spinal surgery module configured for attachment to a surgical table has a plurality of air bladders that are inflatable in various ways to support a patient in a desired position. In an illustrative embodiment, the bladders are inflatable to a first configuration in which a central region of an upper surface of the spinal surgery module is higher in elevation than head end and foot end regions of the upper surface of the spinal surgery module and the bladders are inflatable to a second configuration in which the head end and foot end regions of the upper surface of the spinal surgery module are higher in elevation than the central region of the upper surface of the spinal surgery module. In the illustrative embodiment six bladders, which are arranged in three pairs of side-by-side bladders, are provided in the spinal surgery module.

In a further illustrative embodiment, a patient support apparatus has a patient support deck with a plurality of articulated deck sections. The patient support deck is movable to a configuration to support a patient in a kneeling, face-down position having knees of the patient resting upon a first deck section. The first deck section has at least one bladder that, when inflated, raises the knees of the patient to arch the patient's spine more than the patient's spine is arched when the at least one bladder is deflated.

According to illustrative embodiments, a patient support apparatus has a patient support deck with a plurality of articulated deck sections. The patient support deck is movable to a configuration to support a patient in a kneeling, face-down position. A hip lift is disclosed herein for coupling to the patient support deck. The hip lift is configured to engage the hips of the patient. The hip lift is movable to raise the patient's hips to increase arching of the patient's spine.

According to another illustrative embodiment, a spinal surgery module configured for attachment to a surgical table has a pair of spaced, elongated bars and a plurality of patient support sections coupled to the bars. At least some of the plurality of patient support sections are adjustable about respective pivot axes that are parallel to the bars.

According to yet another aspect of this disclosure, a patient support apparatus comprises a first section having a first portion and a second portion extending longitudinally away from a central region of the first portion. The first portion has a first transverse width and the second portion has a second transverse width that is smaller than the first transverse width such that a pair of cut-out areas are defined alongside opposite sides of the second portion. A pair of shoulder sections are coupled to the first portion for pivoting movement between respective first coplanar positions received in the respective cut-out areas and respective second out-of-the-way positions away from the first coplanar positions. A head section of the patient support apparatus has a frame with a pair of posts, a panel coupled to the frame and a mattress pad coupled to the panel. The pair of shoulder sections have a first pair of sockets that are configured to receive the pair of posts when the shoulder sections are in the first coplanar positions. The first section has a second pair of sockets that are configured to receive the posts when the shoulder sections are in the second out-of-the-way positions.

According to a further aspect of this disclosure, a bariatric overlay apparatus is provided for use with a patient support apparatus having a first section including a pair of cut-out areas and a pair of shoulder sections coupled to the first section for pivoting movement between respective first coplanar positions received in the respective cut-out areas and respective second out-of-the-way positions away from the first coplanar positions. The bariatric overlay apparatus has a first bariatric section that is attachable to the first section and that is wider than the first section. The bariatric overlay has a pair of bariatric shoulder sections that are attachable to the pair of shoulder sections and that are wider than the shoulder sections. The bariatric shoulder sections are pivotable along with the shoulder sections when the bariatric shoulder sections are attached to the shoulder sections.

According to yet another aspect of this disclosure, a patient support apparatus comprises a patient support deck having a first deck section and a pair of first couplers coupled to the first deck section for pivoting movement. A pair of drivers are coupled to the first deck section and to the pair of couplers. The pair of drivers are operable to pivot the couplers relative to the first deck section. The patient support apparatus further comprises a plurality of orthopedic surgery modules. Each orthopedic surgery module has a pair of second couplers that mate with the first couplers to couple the respective orthopedic surgery module to the first deck section for pivoting movement. Each of the pair of second couplers has a lobe-receiving space. Each of the pair of first couplers has a lobe that is received in the lobe-receiving space when respective second couplers are mated with the first couplers.

According to yet a further aspect of this disclosure, an orthopedic surgery system comprises a base module and a cart that docks to the base module. The base module has a patient support deck configured to support a torso of a patient. The cart has wheels to permit maneuvering of the cart along a floor. The cart also has a pair of traction boot assemblies that are operable to apply traction forces to legs of the patient when the cart is docked to the base module.

Additional features will become apparent to those skilled in the art upon consideration of the following detailed description of illustrative embodiments exemplifying the best mode of carrying out the orthopedic table apparatus as presently perceived.

### BRIEF DESCRIPTION OF THE DRAWINGS

The detailed description particularly refers to the accompanying figures, in which:

FIG. 1 is a perspective view of a portion of a first embodiment of a surgical table according to this disclosure showing a base, a column extending upwardly from the base, a patient support deck situated atop the column, the patient support deck having a first section supported by the column, a transverse bar coupled to the first section, and a pair of traction bar assemblies coupled to outer lateral regions of the transverse bar,

FIG. 2 is a perspective view, similar to FIG. 1, showing the traction bar assemblies moved along the transverse bar from the outer lateral regions of the transverse bar to a central region of the transverse bar,

FIG. 3 is a perspective view, similar to FIG. 1, showing the traction bar assemblies articulated to positions having a first traction bar of each traction bar assembly abducted outwardly and angling upwardly relative to the transverse bar and having a second traction bar of each traction bar assembly angling downwardly relative to the respective first bar,

FIG. 4 is a perspective view, similar to FIG. 2, showing a seat section coupled to the transverse bar, the seat section having a central portion, a countertraction post coupled to the central portion, and a pair of side portions laterally outboard of the central portion,

FIG. 5 is a perspective view, similar to FIG. 4, showing the seat section moved laterally toward one side of the transverse bar and showing one of the side portions of the seat section removed from the seat section,

FIG. 6 is a perspective view, similar to FIG. 4, showing a pair of triangular thigh sections coupled to respective first bars of the traction bar assemblies, a pair of calf sections coupled to respective second bars of the traction bar assemblies, a pair of traction boot assemblies coupled to the second bars of the traction bar assemblies, and each of the traction boot assemblies being in a storage position,

FIG. 7 is a perspective view of one of the calf sections and traction boot assemblies of FIG. 6 showing the traction boot assembly in the storage position having a traction boot of the traction boot assembly situated partly beneath the calf section,

FIG. 8 is a perspective view, similar to FIG. 7, showing an elongated rod of the traction boot assembly extended longitudinally outwardly relative to the respective second bar and showing an adjustment assembly coupled to a distal end of the elongated rod and supporting the traction boot of the traction boot assembly at a position out from underneath the calf section,

FIG. 9 is a perspective view, similar to FIG. 8, showing a housing of the adjustment assembly pivoted relative to the elongated rod to a position supporting the traction boot in a first orientation above the rod,

FIG. 10 is a perspective view, similar to FIG. 9, showing the traction boot decoupled from an elongated tube that extends from the housing of the adjustment assembly and the traction boot being oriented in a position having a post of the traction boot aligned vertically with a perpendicularly-extending first opening formed in a side wall of the tube,

FIG. 11 is a perspective view, similar to FIG. 10, showing the traction boot still decoupled from the elongated tube of the adjustment assembly but oriented in a position having the post of the traction boot aligned horizontally with a axially-extending second opening of the tube,

FIG. 12 is a perspective view, similar to FIG. 11, showing the traction boot coupled to the tube of the adjustment assembly in a second orientation having the post of the traction boot received in the axially-extending second opening of the tube,

FIG. 13 is a perspective view, similar to FIG. 12, showing the traction boot having a first portion configured to engage a heel and a sole of a patient's foot, the traction boot having a second portion configured to engage a top of the patient's foot, the second portion being pivoted to a position allowing insertion of the patient's foot into the traction boot, and the traction boot having a strap coupled to a first side of the first portion,

FIG. 14 is a perspective view, similar to FIG. 13, showing a patient's foot received in the traction boot,

FIG. 15 is a perspective view, similar to FIG. 14, showing the second portion of the traction boot pivoted to a position engaging the top of the patient's foot and the strap of the traction boot extending over the second portion and coupling to a second side of the first portion to prevent the second portion from moving away from the top of the patient's foot,

FIG. 16 is a perspective view, similar to FIG. 15, showing the calf section removed from the second bar of the traction bar assembly after the patient's foot is secured to the traction boot,

FIG. 17 is a perspective view of the surgical table of FIG. 6 showing the thigh and calf sections removed from the traction bar assemblies, the traction bar assemblies abducted slightly with the countertraction post between the patient's legs and engaging the patient's pelvic region, and the pair of traction boot assemblies coupled to respective feet of a patient to apply bilateral hip traction to the patient,

FIG. 18 is a perspective view, similar to FIG. 17, showing the traction bar assembly associated with the patient's right leg articulated so that the respective calf section supports the patient's right leg in an elevated position and showing the traction boot assembly associated with the patient's left leg applying unilateral hip traction to the patient,

FIG. 19a is a perspective view, similar to FIG. 17, showing the surgical table supporting the patient in a position for a lateral intramedullary nailing procedure, and showing the head section moved to a position slightly higher in elevation than the back section,

FIG. 19b is an enlarged view of a portion of the surgical table of FIG. 19, showing shoulder support portions of the back section pivoted downwardly away from cutouts formed in a back support portion of the back section and a frame member of the head section received in a socket formed in the back support portion,

FIG. 20 is a perspective view of a portion of the surgical table of FIG. 18 showing an alternative embodiment of a countertraction post engaging the patient's pelvic region,

FIG. 21 is a cross sectional view, taken along line 21-21 of FIG. 4, showing a first C-shaped bracket of one of the traction bar assemblies coupled to one portion of the transverse bar and showing a second C-shaped bracket of the seat section coupled to another portion of the transverse bar,

FIG. 22 is a cross sectional view, taken along line 22-22 of FIG. 6, showing a bracket of one of the thigh sections coupled to the associated first traction bar of one of the traction bar assemblies,

FIG. 23 is a cross sectional view, taken along line 23-23 of FIG. 26, showing one of the calf sections pivoted beneath the associated thigh section, and showing first and second brackets of the thigh and calf sections, respectively, coupled to the associated first and second traction bars of one of the traction bar assemblies,

FIG. 24 is a perspective view of the surgical table of FIG. 2, showing thigh and calf sections coupled to the traction bar assemblies, a narrow head section coupled to the patient support deck near the head end, and a back section of the patient support deck pivoted upwardly relative to the column to support the patient in a sitting-up position for shoulder surgery,

FIG. 25 is a perspective view, similar to FIG. 24, showing a shoulder support portion of the back section pivoted away from a cut-out formed in the back section to expose a posterior portion of the patient's left shoulder for shoulder surgery,

FIG. 26 is a perspective view of the surgical table of FIG. 6, showing the calf sections pivoted beneath the seat and thigh sections, and showing the seat, thigh, and calf sections (along with the countertraction post, the transverse bar and the traction bar assemblies) being decoupled, as a unit, from the remainder of the patient support deck,

FIG. 27 is a perspective view of the surgical table of FIG. 26 after the seat, thigh, and calf sections along with the transverse bar and traction bar assemblies have been removed,

FIG. 28 is a perspective view of the surgical table of FIG. 27, showing a spinal surgery board or module being arranged for coupling to the patient support deck,

FIG. 29 is a perspective view of the surgical table of FIG. 28, showing the head section removed from the back section and coupled instead to the spinal surgery module, and showing a patient resting on the patient support deck for spinal surgery,

FIG. 30 is a perspective view of a portion of a second embodiment of a surgical table according to this disclosure showing a base, a column extending upwardly from the base, a patient support deck situated atop the column, the patient support deck having a first section supported by the column, a transverse bar forming a part of a frame of the first section, and a pair of traction bar assemblies coupled to outer lateral regions of the transverse bar,

FIG. 31 is a perspective view, similar to FIG. 30, showing the traction bar assemblies moved along the transverse bar from the outer lateral regions of the transverse bar to a central region of the transverse bar,

FIG. 32 is a perspective view, similar to FIG. 31, showing one of the traction bar assemblies in an in-line configuration extending longitudinally from one of the lateral outer regions of the transverse bar, and showing the other of the traction bar assemblies in an abducted and articulated configuration extending from the central region of the transverse bar,

FIG. 33 is a perspective view of the table of FIG. 30 showing a seat section coupled to the patient support deck and thigh and calf sections coupled to the traction bar assemblies, and showing a pair of alternative traction boot assemblies coupled to distal ends of respective traction bar assemblies and the traction boot assemblies in storage positions beneath the associated calf sections,

FIG. 34 is a perspective view, similar to FIG. 33, of the surgical table with the seat section removed from the patient support deck, and the thigh and calf sections removed from the traction bar assemblies,

FIG. 35 is a perspective view of one of the alternative traction boot assemblies and the associated traction bar assembly, showing an elongated rod of the traction boot assembly extended out of a second bar of the associated traction bar assembly, an adjustment assembly at a distal end of the rod pivoted to an angled position relative to the rod, and a traction boot of the traction boot assembly raised vertically relative to the adjustment assembly,

FIG. 36 is a perspective of the surgical table of FIG. 33 in a compact storage configuration showing a head section of the patient support deck pivoted to a position beneath a back section of the patient support deck, and showing the traction bar assemblies articulated to a position in which the traction boot assemblies are situated beneath the back section,

FIG. 37 is a perspective view of the surgical table of FIG. 36, showing the traction bar assembly associated with the patient's right leg articulated so that the respective calf section supports the patient's right leg in an elevated position, and showing the traction boot assembly associated with the patient's left leg applying unilateral hip traction to the patient,

FIG. 38 is a cross sectional view, taken along line 38-38 of FIG. 30, showing a C-shaped bracket of one of the traction bar assemblies coupled to the transverse bar,

FIG. 39 is a cross sectional view, taken along line 39-39 of FIG. 33, showing a bracket of one of the thigh sections coupled to a respective first traction bar of one of the traction bar assemblies,

FIG. 40 is a cross sectional view, similar to FIG. 39, showing an alternative thigh section having an alternative bracket coupling the alternative thigh section to the first traction bar of one the traction bar assemblies,

FIG. 41 is a perspective view of the surgical table of FIG. 30 showing a first spinal surgery section and a second spinal surgery section coupled to the first and second traction bars of the traction bar assemblies,

FIG. 42 is cross sectional view, taken along line 42-42 of FIG. 41, showing a pair of brackets of the first spinal surgery section coupled to respective first traction bars of the traction bar assemblies,

FIG. 43 is a perspective view, similar to FIG. 41, showing the head section decoupled from the back section of the patient support deck and coupled instead to the second spinal surgery section,

FIG. 44 is a perspective view of the surgical table of FIG. 43, showing the traction bar assemblies articulated to a position having the first spinal surgery section angling upwardly relative to the back section, the second spinal surgery section extending horizontally from the first spinal surgery section, and the head section moved to a position slightly higher in elevation than the second spinal surgery section,

FIG. 45 is a perspective view of the surgical table of FIG. 44, showing a patient supported by the patient support deck in a kneeling, face-down position,

FIG. 46 is a perspective view of the surgical table of FIG. 45, showing a hip lift coupled to the traction bar assemblies beneath the first spinal surgery section,

FIG. 47 is a perspective view, similar to FIG. 46, showing a pair of hip pads of the hip lift moved to positions engaging the hips of the patient and lifted upwardly by a crank mechanism of the hip lift to increase the amount of arch in the patient's spine,

FIG. 48 is a perspective view, similar to FIG. 44, showing an alternative embodiment back section having an internal air bladder (in phantom),

FIG. 49 is a perspective view, similar to FIG. 48, showing a patient being supported in a kneeling, face-down position with the air bladder deflated beneath the patient's knees,

FIG. 50 is a perspective view, similar to FIG. 49, showing the air bladder being inflated to raise the patient's knees to increase arching of the patient's spine,

FIG. 51 is a perspective view of the surgical table of FIG. 43, showing the second spinal surgery section removed from the traction bar assemblies and replaced by a pair of rectangular, side-by-side spinal surgery sections that are coupled to the second traction bars of the traction bar assemblies between the head section and the first spinal surgery section,

FIG. 52 is a perspective view, similar to FIG. 51, showing each of the side-by-side spinal surgery sections having a set of three internal air bladders (in phantom),

FIG. 53 is a perspective view of the surgical table of FIG. 52, showing a patient lying on the patient support deck in a face-down position with the air bladders deflated beneath the patient's torso,

FIG. 54 is a perspective view, similar to FIG. 53, showing the side-by-side spinal surgery sections altered to a partial single-humped configuration by inflating the central regions of the side-by-side spinal surgery sections more than the head end and foot end regions of the side-by-side spinal surgery sections are inflated so that the arch in the patient's spine is decreased,

FIG. 55 is a perspective view, similar to FIG. 54, showing the side-by-side spinal surgery sections altered further to a full single-humped configuration by further inflating the central regions of the side-by-side spinal surgery sections more than the head end and foot end regions of the side-by-side spinal surgery sections are inflated so that the arch in the patient's spine is further decreased,

FIG. 56 is a perspective view, similar to FIG. 55, showing the approximate shape of three of the air bladders (in phantom) of the side-by-side spinal surgery sections when in the full single-humped configuration,

FIG. 57 is a perspective view, similar to FIG. 53, showing the side-by-side spinal surgery sections altered to a full double-humped configuration by inflating the head end and foot end regions of the side-by-side spinal surgery sections more than the central region is inflated so that the arch in the patient's spine is increased,

FIG. 58 is a perspective view, similar to FIG. 57, showing the approximate shape of three of the air bladders (in phantom) of the side-by-side spinal surgery sections when in the full double-humped configuration,

FIG. 59 is a perspective view of the surgical table of FIG. 51, showing the rectangular, side-by-side spinal surgery sections removed and replaced with a pair of multi-piece side-by-side spinal surgery sections that are coupled to the second traction bars of the traction bar assemblies between the head section and the first spinal surgery section,

FIG. 60 is a perspective view, similar to FIG. 59, showing head end and foot end sections of the multi-piece side-by-side spinal surgery sections each having internal gel pad layers (in phantom),

FIG. 61 is a perspective view, similar to FIG. 59, showing middle sections of the multi-piece side-by-side spinal surgery sections removed from the second traction bars of the traction bar assemblies,

FIG. 62 is a perspective view, similar to FIG. 61, showing the head end and foot end sections of the multi-piece side-by-side spinal surgery sections pivoted inwardly about respective pivot axes that are parallel with a longitudinal dimension of the traction bar assemblies,

FIG. 63 is a perspective view, similar to FIG. 62, showing a patient supported by the patient support deck in a face-down position with the patient's torso being supported by the head end and foot end sections of the multi-piece side-by-side spinal surgery sections,

FIG. 64 is a perspective view of a portion of the surgical table of FIG. 33, showing standard-width seat and back sections comprising part of the patient-support deck,

FIG. 65 is a perspective view, similar to FIG. 64, showing the seat section removed from the traction bar assemblies and showing mattress pads removed from a back portion of a back section of the patient support deck and from a pair of shoulder portions of the back section,

FIG. 66 is a perspective view, similar to FIG. 65, showing a bariatric overlay arranged above the back section of the patient support deck, the bariatric overlay having a bariatric seat section and a bariatric back section, the bariatric back section configured to couple to the back section of the patient support deck, and the bariatric back section including bariatric shoulder portions configured to couple to the shoulder portions of the back section of the patient support deck,

FIG. 67 is a perspective view, similar to FIG. 66, showing the bariatric overlay coupled to the patient support deck,

FIG. 68 is a perspective view of another embodiment of a surgical table according to this disclosure showing a base, a column extending upwardly from the base, a patient support deck situated atop the column, the patient support deck having a first section supported by the column, a head section coupled to the first section, a second section coupled to the first traction bars of a pair of traction bar assemblies adjacent to the first section, and a third section coupled to second traction bars of the pair of traction bar assemblies adjacent to the foot end,

FIG. 69 is a perspective view, similar to FIG. 68, showing the head section removed from the first section of the patient support deck, and showing the third section articulated upwardly and the first and second section articulated downwardly,

FIG. 70 is a perspective view, similar to FIG. 69, showing the third section removed from the second traction bars of the pair of traction bar assemblies,

FIG. 71 is a perspective view, similar to FIG. 70, showing a shoulder surgery module coupled to the second traction bars of the pair of traction bar assemblies, and showing a narrow head section coupled to a back section of the shoulder surgery module,

FIG. 72 is a perspective view, similar to FIG. 71, showing shoulder sections of the shoulder surgery module removed from the back section of the shoulder surgery module,

FIG. 73 is a perspective view of a further embodiment of a surgical table according to this disclosure, showing a base, a column extending upwardly from the base, a first section of a patient support deck situated atop the column, the first section having first and second pairs of powered pivot couplers adjacent to the head and foot ends thereof, a shoulder surgery module arranged for coupling to the first pair of powered pivot couplers adjacent to the head end, and a trauma surgery module coupled to the second pair of powered pivot couplers adjacent to the foot end,

FIG. 74 is a perspective view of yet another embodiment of a surgical table according to this disclosure showing a head section pivoted beneath an upper back section of a patient support deck near the head end and a trauma surgery module coupled to powered pivot couplers of the patient support deck near the foot end,

FIG. 75 is a perspective view, similar to FIG. 74, showing calf sections of the trauma surgery module pivoted to storage positions beneath the seat section and the thigh sections of the trauma surgery module,

FIG. 76 is a perspective view, similar to FIG. 75, showing the trauma surgery module removed from the powered pivot couplers and a shoulder surgery module arranged for coupling to the powered pivot couplers,

FIG. 77 is a perspective view, similar to FIG. 76, showing the shoulder surgery module coupled to the powered pivot couplers,

FIG. 78 is a perspective view of a surgery system according to this disclosure, showing a surgical table similar to the table of FIG. 74, a trauma surgery cart arranged for docking to the surgical table, and the trauma surgery cart having a set of wheels, a push handle, a pair of traction bar assemblies and a pair of traction boot assemblies,

FIG. 79 is a perspective view, similar to FIG. 78, showing the trauma surgery cart docked to the surgical table,

FIG. 80 is a perspective view, similar to FIG. 79, showing a seat section with a countertraction post arranged for coupling to a pair of powered pivot couplers of the surgical table near the foot end,

FIG. 81 is a perspective view, similar to FIG. 80, showing the seat section coupled to the powered pivot couplers of the surgical table,

FIG. 82 is a perspective view, similar to FIG. 81, showing a patient lying on the surgical table and showing the traction boot assemblies coupled to the patient's feet to apply bilateral hip traction to the patient, and

FIG. 83 is a perspective view, similar to FIG. 82, showing the patient support deck and the traction boot assemblies raised in a coordinated manner.

### DETAILED DESCRIPTION OF THE DRAWINGS

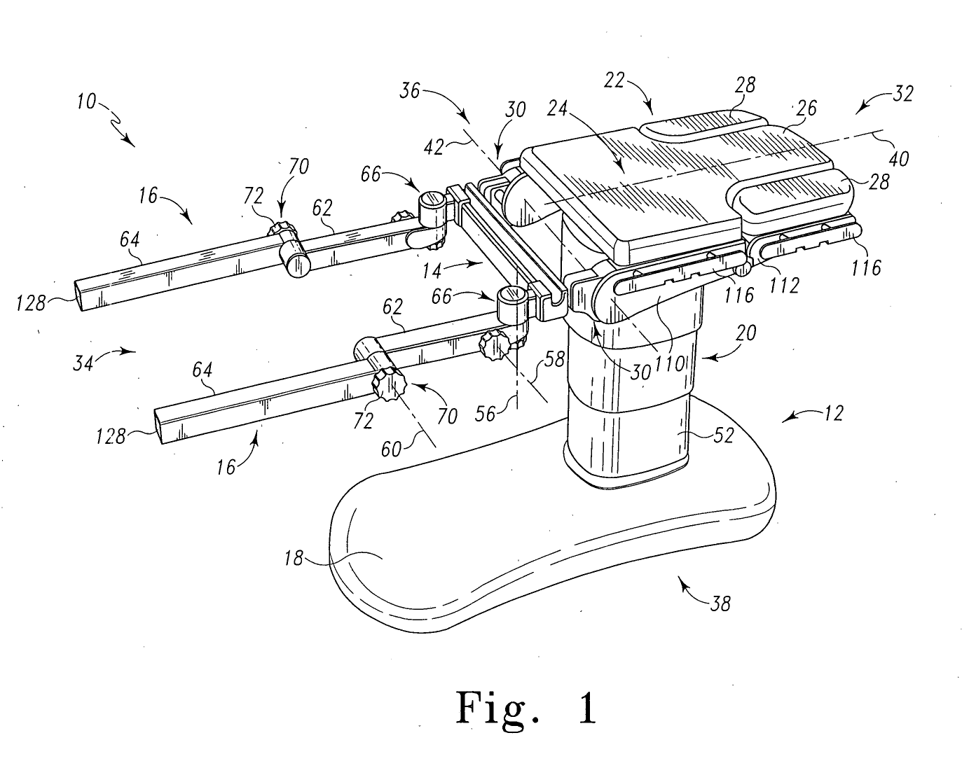

An illustrative patient-support apparatus or surgical table 10 comprises a base module 12, a transverse bar 14 coupled to the base module 12 and a pair of traction bar assemblies 16 coupled to the transverse bar 14 as shown in FIGS. 1-3. The base module 12 has a base 18, an extendable and retractable vertical column 20 and a patient support deck 22 supported atop the column 20. The illustrative patient support deck 22 includes a back section 24 having a back support portion 26 and a pair of shoulder support portions 28. The patient support deck 22 further includes a pair of powered pivot couplers 30 to which the transverse bar 14 removably couples as shown, for example, in FIG. 21.

The surgical table 10 has a head end 32, a foot end 34, a first side 36, a second side 38, a longitudinal axis 40 and a transverse axis 42. As used in this description, the phrase “head end 32” will be used to denote the end of any referred-to object that is positioned to lie nearest the head end 32 of the table 10, and the phrase “foot end 34” will be used to denote the end of any referred-to object that is positioned to lie nearest the foot end 34 of the table 10. Likewise, the phrase “first side 36” will be used to denote the side of any referred-to object that is positioned to lie nearest the first side 36 of the table 10, and the phrase “second side 38” will be used to denote the side of any referred-to object that is positioned to lie nearest the second side 38 of the table 10.

The vertical column 20 has a number of telescopic shroud segments 52 that shield from view a hi/lo drive mechanism of the surgical table 10 which is operable to raise and lower the patient support deck 22 and any components coupled to the patient support deck 22. In some embodiments, the hi/lo drive mechanism includes a hydraulic actuator, such as the one shown and described in U.S. patent application Ser. No. 10/056,916, which was filed Jan. 25, 2002, which is assigned to the same assignee as the present disclosure, and which is hereby incorporated by reference herein. The surgical table 10 further includes other drive mechanisms (not shown) that are operable to tilt the patient support deck 22 front to rear relative to the column 20 about a pivot axis that is parallel to the transverse pivot axis 42, to tilt the patient support deck 22 side to side relative to the column 20 about a pivot axis that is parallel to the longitudinal pivot axis 40, and to pivot the powered pivot couplers 30 relative to the back section 24 about the transverse pivot axis 42. In some embodiments, these drive mechanisms include hydraulic actuators such as the ones shown and described, for example, in U.S. patent application Ser. Nos. 10/056,552 and 10/056,959, both of which were filed on Jan. 25, 2002, both of which are assigned to the same assignee as the present disclosure, and both of which are hereby incorporated by reference herein.

In embodiments of the surgical table 10 having hydraulic actuators, one or more reservoirs of hydraulic fluid, pumps, manifolds, valves, and hydraulic lines are housed within the base 18, the column 20 and portions of the patient support deck 22 in any suitable arrangement as is well-known in the art. In addition, the surgical table 10 has a user input device, such as a hand-held remote or pendant controller, that is used to command the operation of the various drive mechanisms of the surgical table 10. Examples of suitable user input devices that may be included in the surgical table 10 are shown and described in U.S. Pat. No. 6,351,678, which issued Feb. 26, 2002 and which is hereby incorporated by reference herein.

It will be appreciated that various mechanical and electromechanical actuators and drivers may be used to raise and lower the patient support deck 22 relative to the base 18, to tilt the patient support deck 22 relative to the base 18 and to articulate sections of the patient support deck 22. It is well known in the art that electric, hydraulic and pneumatic actuators in combination with various types of transmission elements including lead screw drives and various types of mechanical linkages may be used to create relative movement of portions of the patient support devices. As a result, terms such as “drive mechanism(s),” “drive assembly,” “drive assemblies,” “driver(s)” and the like, are intended to cover all types of mechanical, electromechanical, hydraulic and pneumatic mechanisms, including manual cranking mechanisms of all types, and including combinations thereof such as hydraulic cylinders in combination with electromechanical pumps for pressurizing fluid received by the hydraulic cylinders.

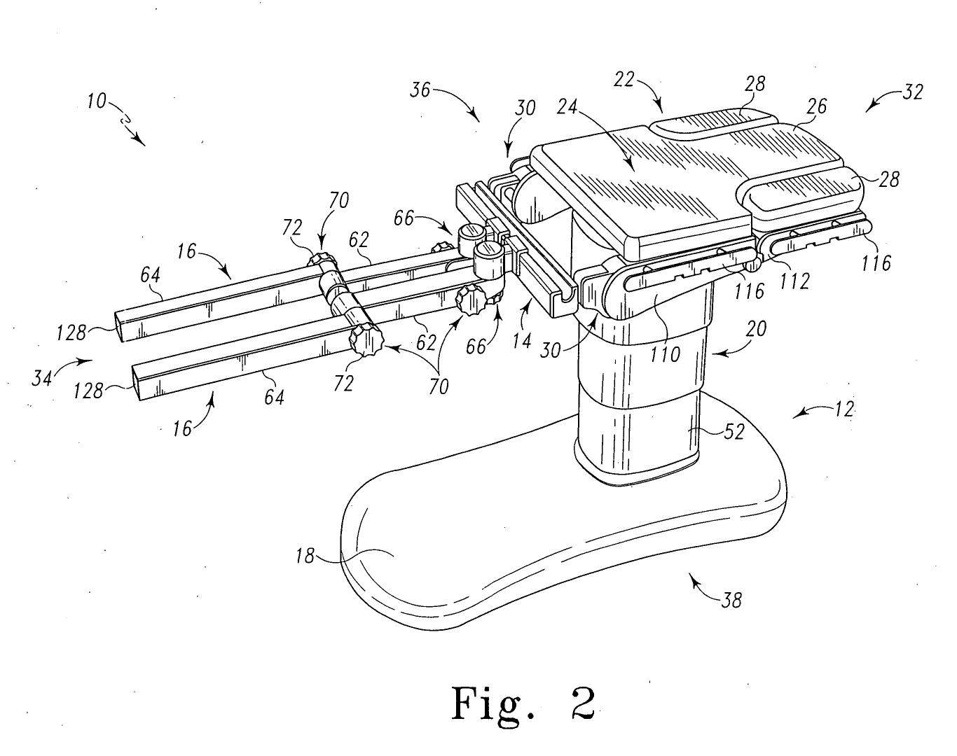

The traction bar assemblies 16 are each independently movable to any desired position along the transverse bar 14. For example, the traction bar assemblies 16 are movable from first positions coupled to lateral outer regions of the transverse bar 14 as shown in FIG. 1, to second positions coupled to a central region of the transverse bar 14 as shown in FIG. 2. When in desired positions, the traction bar assemblies 16 lock in place on the transverse bar 14 via mechanisms that are described in further detail below. The powered pivot couplers 30, along with the transverse bar 14, the traction bar assemblies 16 and any orthopedic surgery modules coupled to the traction bar assemblies 16 are pivotable about the transverse pivot axis 42, shown, for example, in FIG. 1.

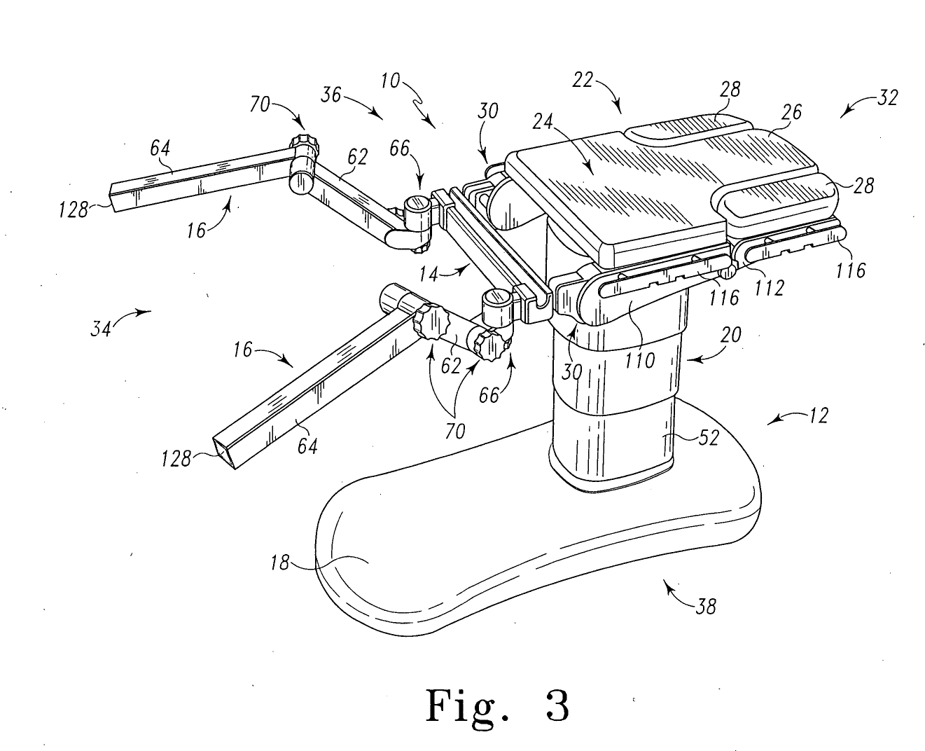

The traction bar assemblies 16 each include a first traction bar 62, a second traction bar 64 and a multi-joint coupler 66 as shown in FIGS. 1-3. The first traction bar 62 is coupled to the multi-joint coupler 66 for pivoting movement about a first pivot axis 56 and a second pivot axis 58 that, in the illustrative embodiment, is orthogonal to the first pivot axis 56. The second traction bar 64 is coupled to the first traction bar 62 for pivoting movement about a third pivot axis 60. Thus, the first and second traction bars 62, 64 are configured to articulate relative to the transverse bar 14 to a variety of articulated positions. For example, the traction bars 62, 64 are movable between longitudinally extending in-line positions shown in FIGS. 1 and 2 in which the traction bars 62, 64 are horizontal and extend parallel to the longitudinal axis 40 of the surgical table 10, and exemplary articulated positions shown in FIG. 3 in which the first traction bars 62 of each traction bar assembly 16 are abducted outwardly and angled upwardly relative to the transverse bar 14 and in which the second traction bars 64 of each traction bar assembly 16 are angled downwardly from the respective first traction bars 62. In the illustrative embodiment, the first pivot axis 56 is vertical and the second and third axes 58, 60 are horizontal when the back section 24 is in a horizontal position and the powered pivot couplers 30 are in respective raised positions relative to the back section 24 as shown in FIGS. 1-3.

Each traction bar assembly 16 has manual adjusters 70 that are movable to loosen the connections between the first and second traction bars 62, 64, between the first traction bar 62 and the multi-joint coupler 66 and between the multi-joint coupler 66 and the transverse bar 14, thereby permitting articulation of the first and second traction bars 62, 64 relative to the transverse bar 14. Likewise, the manual adjusters 70 are movable to tighten the connections between the first and second traction bars 62, 64, between the first traction bar 62 and the multi-joint coupler 66 and between the multi-joint coupler 66 and the transverse bar 14, thereby locking the first and second traction bars 62, 64 in the desired positions relative to the transverse bar 14. In the illustrative embodiment, the manual adjusters 70 each comprise a knob 72 and a threaded shaft (not shown) extending from the respective knob. The threaded shafts of the illustrative manual adjusters 70 of the traction bar assemblies 16 extend along the respective axes 56, 58, 60. In addition, the knobs 52 rotate about the respective axes 56, 58, 60 in one direction, such as clockwise, to tighten the corresponding connections, and the knobs 52 rotate about the respective axes 56, 58, 60 in an opposite direction, such as counterclockwise, to loosen the corresponding connections.

As shown in FIG. 21, each multi-joint coupler 66 comprises a bracket 80 that removably couples to the transverse bar 14, a cylinder 82, a block 84 that interconnects the bracket 80 and the cylinder 82, and a clevis 86 that is rotatably coupled to cylinder 82. Each clevis 86 has a main body portion that is situated beneath the cylinder 82 and a pair of flange portions that extend rearwardly from the respective main body portion to define a bar-receiving space which receives a proximal end of the associated first traction bar 62. In the illustrative embodiment, serrations or teeth are provided at the interface between a top surface of the main body portion of each clevis 86 and a bottom surface of the associated cylinder 82 so that tightening of the corresponding manual adjusters 70 causes the teeth to intermesh to prevent rotation of devises 86 about their respective vertical axes 56 relative to the associated cylinders 82 and so that loosening of the corresponding manual adjusters 70 allows the teeth to separate to permit rotation of devises 86 about their respective vertical axes 56 relative to the associated cylinders 82. In the illustrative embodiment, serrations or teeth are provided at the interface between the flange portions of the devises 86 and the proximal ends of the associated first traction bars 62 so that tightening of the corresponding manual adjusters 70 causes the teeth of the flange portions and the first traction bars 62 to intermesh to prevent the first traction bars 62 from rotating about their respective transverse axes 58 relative to the associated devises 86, and so that loosening of the manual adjusters 70 allows the teeth to separate to permit the first traction bars 62 to rotate about their respective transverse axes 58 relative to the devises 86. In this description, “forwardly” means toward the head end 32 and “rearwardly” means toward the foot end 34.

In the illustrative embodiment, proximal ends of the second traction bars 64 are coupled to respective distal ends of the first traction bars 62 such that the second traction bars 64 are situated laterally outboard of the associated first traction bars 62. In some embodiments, serrations or teeth are provided at the interface between the first and second traction bars 62, 64 so that tightening of the manual adjusters 70 causes the teeth of the first and second traction bars 62, 64 to intermesh to prevent the second traction bars 64 from rotating about the respective transverse axes 60 relative to the associated first traction bars 62 and so that loosening of the manual adjusters 70 allows the teeth to separate to permit the second traction bars 64 to rotate about the respective transverse axes 60 relative to the first traction bars 62.

Alternative mechanisms for releasably locking the clevis 86 relative to the associated cylinder 82, for releasably locking the first traction bar 62 relative to the associated clevis 86, and for releasably locking the second traction bar 64 relative to the associated first traction bar 62 are contemplated by this disclosure. For example, various types of manually operated clutch and release mechanisms, such as lever operated clutches and push button operated clutches like those shown and described in U.S. patent application Ser. Nos. 10/056,552 and 10/056,959 may be used in the traction bar assemblies 16 in lieu of the manual adjusters 70 and the associated teeth or serrations, if any.

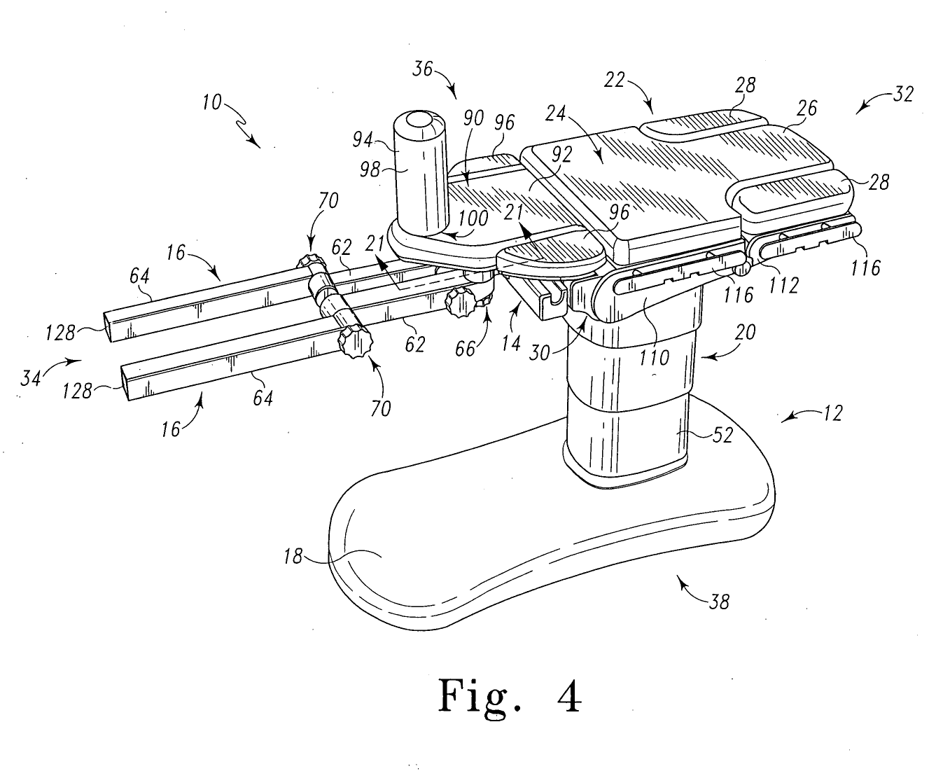

Various modules, deck sections, accessories, and the like are attachable to the base module 12 to configure the surgical table 10 for various types of surgeries, such as trauma, shoulder and spinal surgeries. Some of these modules, deck sections, etc. are coupled to the base module 12 by the traction bar assemblies 16. Some of these modules, deck sections, etc., on the other hand, are instead directly coupled to the transverse bar 14. For example, a seat section 90 of the patient support deck 22 is coupleable to the transverse bar 14 as shown in FIG. 4. The seat section 90 has a central portion 92, a countertraction post 94 extending upwardly from the central portion 92 and removably coupled thereto, and a pair of side portions 96 laterally outboard of the central portion 92. The countertraction post 94 includes a rigid vertical bar (not shown) and a padding 98 surrounding a majority of the rigid vertical bar, including the middle and the upper regions of the rigid vertical bar. A lower region of the rigid vertical bar (not shown) extends downwardly from the padding 98, and is removably received in a vertical socket 100 (shown, for example, in FIG. 4) formed in the central portion 92 of the seat section 90.

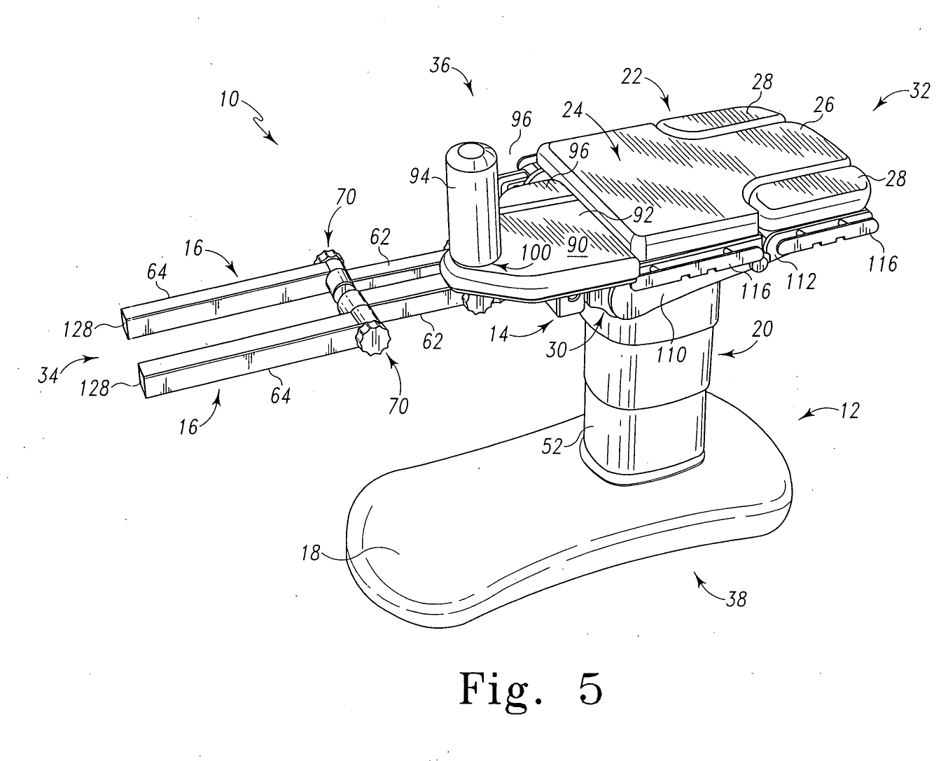

The seat section 90 is movable transversely along the transverse bar 14, and is lockable in desired positions. For example, the seat section 90 is movable from a centered position having the countertraction post 94 centered with respect to the remainder of the surgical table 10, as shown in FIG. 4, to an offset position having the countertraction post 94 closer to the second side 38 of the surgical table 10 than the first side 36, as shown, for example, in FIG. 5. The side portions 96 of the seat section 90 are detachably coupled to the central portion 92 with suitable couplers, such as, for example, pins, latches, tabs, hooks, and the like. It may be desirable, although not necessary, to detach one or both side portions 96 from the central portion 92. For example, when the seat section 90 is in an offset position moved laterally along the transverse bar 14 toward the second side 38 of the surgical table 10 as shown in FIG. 5, removal of the side portion 96 on the second side 38 increases C-arm access of imaging equipment (not shown) and also enhances caregiver access to the patient from the second side 38. Of course, when the seat section 90 is shifted away from the centered position toward the first side 36 of the surgical table 10, the side portion 96 on the first side 36 may be removed to increase C-arm and caregiver access to the patient from the first side 36.

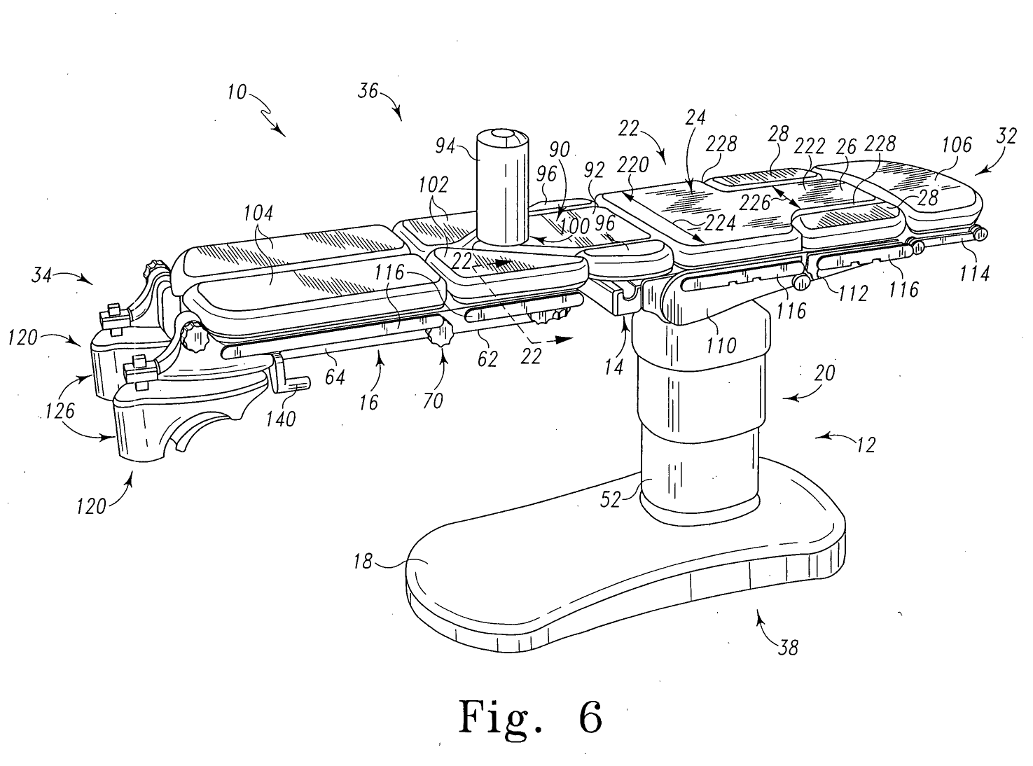

Other components that removably attach to the traction bar assemblies 16 include thigh sections 102, calf sections 104 and traction boot assemblies 120 as shown in FIG. 6. The thigh sections 102 attach to the respective first traction bars 62 of the traction bar assemblies 16 and, in the illustrative embodiment, are generally triangular in shape to accommodate the triangular shape of seat section 90. The calf sections 104 attach to respective second traction bars 64 and, in the illustrative embodiment, are generally rectangular in shape. The thigh and calf sections 102, 104 are each configured to support a portion of a patient's legs and therefore, the thigh and/or calf sections 102, 104 are sometimes referred to herein as “the leg section(s).” The traction boot assemblies 120 also couple to the respective second traction bars 64. The surgical table 10 further includes a head section 106 that removably attaches to the back section 24.

Each of deck sections 102, 104, 106, each of portions 26, 28 of the back section 24 and each of portions 92, 96 of the seat section 90 comprises a mattress pad and a panel to which the associated mattress pad removably couples, such as with hook and loop fasteners, snaps, straps, and the like. Each of the panels of the respective sections 26, 28, 92, 96, 102, 104, 106 underlie and have the same general shape as the associated mattress pads, although, in some embodiments, the mattress pads overhang the edges of the associated panels by some amount. The illustrative back section 24 has a pair of laterally-spaced first frame members 110 to which the panel associated with the back support portion 26 is coupled, and a pair of laterally-spaced second frame members 112 to which the panels associated with the shoulder support portions 28 are coupled as shown in FIGS. 1-6. Additional frame members (not shown) are included in the back section 24 in some embodiments. Such additional frame members include, for example, one or more cross frame members that interconnect the laterally-spaced first frame members 110. If the additional frame members are part of the back section, they can't underlie the back section. Likewise, the head section 106 has a pair of laterally-spaced frame members 114 that are configured to permit adjustment of the position of the associated panel and mattress pad relative to the back section 24. The transverse bar 14 serves as a frame member for the seat section 90, and the first and second traction bars 62, 64 serve as frame members for the thigh and calf sections 102, 104, respectively.

The surgical table 10 also has a plurality of accessory rails 116 to which various types of accessory equipment may be coupled as desired. Such accessory equipment includes, for example, armboards, shoulder braces, hip braces, lateral braces, patient restraint straps, stirrups, knee crutches, arm suspension equipment, hand traction equipment, anesthesia screens, and the like. The accessory rails 116 associated with the back section 24 are coupled to the frame members 110, 112, whereas the accessory rails 116 associated with the thigh and calf sections 102, 104 are coupled to the panels underlying the mattress pads of the respective thigh and calf sections 102, 104. In some embodiments of the head sections 106, one or more of the frame members 114 of the head section 106 are configured for attachment of accessory equipment.

When the surgical table 10 is in the configuration shown in FIG. 6, the surgical table 10 may be used for general surgical procedures. For purposes of this disclosure, general surgical procedures means any type of surgical procedures not classified as orthopedic surgical procedures. For general surgical procedures, the countertraction post 94 may be detached from the central portion 92 of the seat section 90 and the traction boot assemblies 120 may be detached from the traction bar assemblies 16. In addition, the head section 106, the back section 24, the seat section 90, the thigh sections 102 and the calf sections 104 may be articulated to various positions and the entire patient support deck 22 may be tilted to various inclinations to place the patient in desired positions for general surgical procedures. In the illustrative embodiment of the surgical table 10, the position of the head section 106 relative to the back section 24 and the positions of the thigh and calf sections 102, 104 relative to the seat section 90 are adjusted manually. On the other hand, the position of the back section 24 relative to the vertical column 20, the position of shoulder support portions 28 relative to back support portion 26 of the back section 24, and the position of the powered pivot couplers 30 (along with the transverse bar 14 and the seat section 90 coupled thereto) relative to the vertical column 20 are all adjusted by powered drive mechanisms.

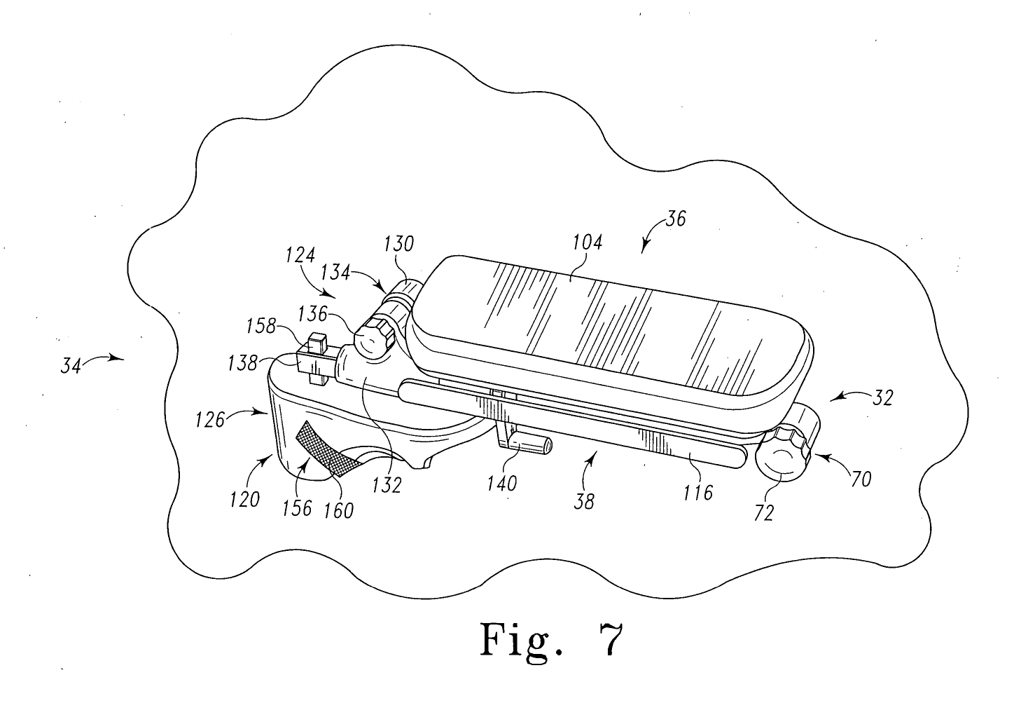

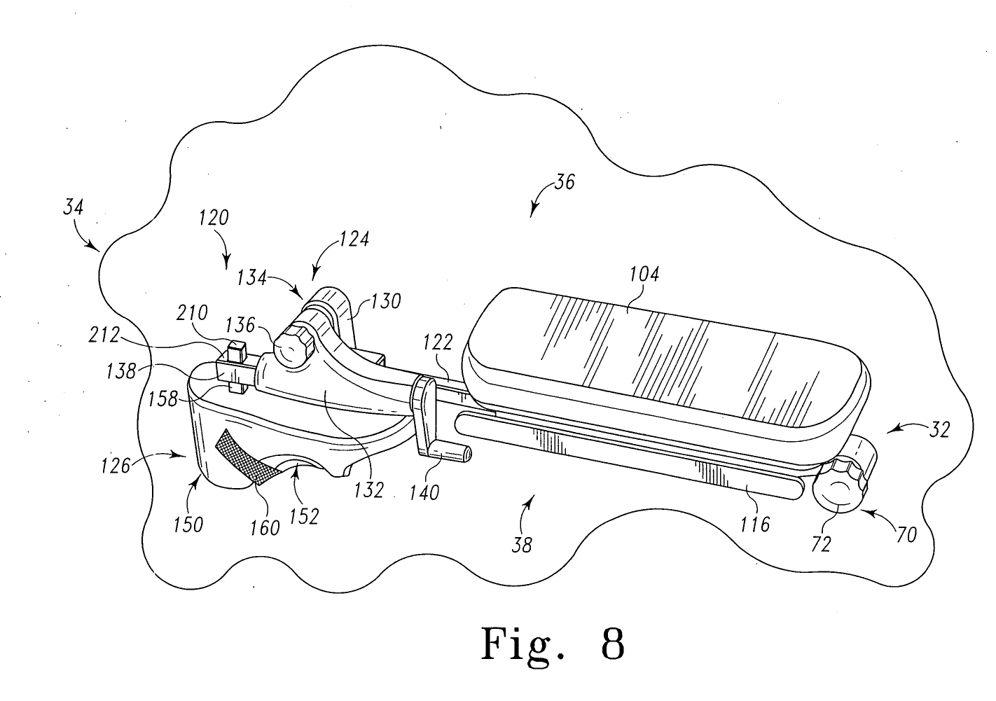

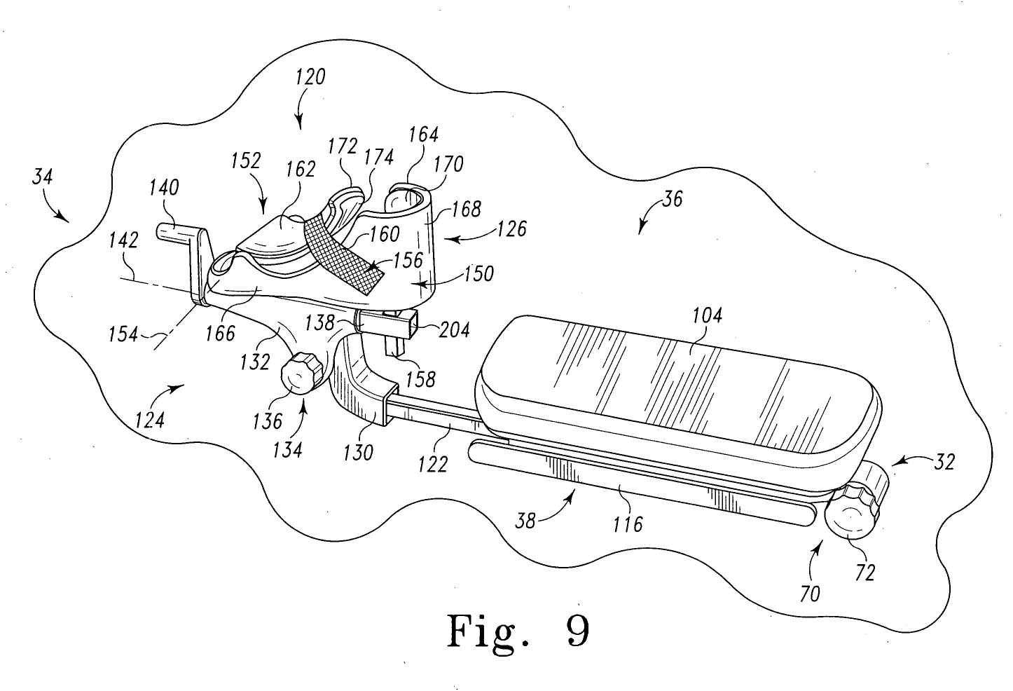

The following description of one of traction boot assemblies 120 with reference to FIGS. 7-16 is applicable to both traction boot assemblies 120 unless specifically noted otherwise. The traction boot assembly 120 comprises an elongated rod 122 (see FIGS. 8 and 9, for example), an adjustment assembly 124 and a traction boot 126. The second traction bar 64 of the traction bar assembly 16 is tubular and has an open end 128, as shown, for example, in FIGS. 1-3, through which the elongated rod 122 is inserted into the interior region of the second traction bar 64 to couple the traction boot assembly 120 to the traction bar assembly 16. The second traction bar 64 and the elongated rod 122 are each nonround in transverse cross-section to prevent rotation of the elongated rod 122 relative to the second traction bar 64 about an axis defined along the lengths thereof. In the illustrative embodiment, the traction bar 64 and the elongated rod 122 are each square-shaped in transverse cross section. However, other nonround cross sections, such as semicircular, rectangular, oval, triangular, pentagonal, hexagonal, octagonal, and so on are contemplated by this disclosure.

The elongated rod 122 is received in the interior region of the second traction bar 64 for axial telescopic movement. Thus, the position of the traction boot assemblies 120 relative to the second traction bars 64 is adjustable along the longitudinal axes of the respective second traction bars 64. For example, the elongated rod 122 is movable between a retracted position shown in FIG. 7 and an extended position shown in FIGS. 8-16. It is within the scope of this disclosure for the elongated rod 122 to be moved to other positions relative to the second traction bar 64 in addition to the illustrative retracted and extended positions.

Suitable locking mechanisms (not shown) are provided to lock the position of the traction boot assemblies 120 relative to the second traction bar 64. For example, in some embodiments the elongated rod 122 has a plurality of holes spaced longitudinally therealong and a spring-biased pin extends through either one of the side walls or the bottom wall of the second traction bar 64 such that an end of the pin enters into whichever of the holes in the elongated rod 122 is aligned therewith to lock the elongated rod 122 from moving relative to the second traction bar 64. In such embodiments having a spring-biased pin, a caregiver pulls the pin away from the elongated rod 122 against the bias of the associated spring to unlock the elongated rod 122 for axial movement relative to the second traction bar 64.

In other embodiments, a threaded shaft is received by a threaded aperture formed in either one of the side walls or the bottom wall of the second traction bar 64 and is turned by a handle, a knob, or the like that is coupled to the threaded shaft and that is accessible to the caregiver to tighten an end of the threaded shaft against the elongated rod 122 with sufficient force to prevent movement of the elongated rod 122 relative to the second traction bar 64. In such embodiments having a threaded shaft, the caregiver rotates the threaded shaft in an opposite direction to loosen the threaded shaft allowing the elongated rod 122 to move relative to the second traction bar 64.

In still other embodiments, the elongated rod 122 has a plurality of notches spaced longitudinally therealong and a spring-biased latch is coupled to either of the side walls or the bottom wall of the second traction bar 64 for pivoting movement so that a lug of the latch is received in whichever of the notches is aligned with the lug to lock the elongated rod 122 from moving relative to the second traction bar 64. In such embodiments, the latch is movable against the bias of the associated spring to withdraw the lug from the associated notch to permit axial movement of the elongated rod 122 relative to the second traction bar 64.

The adjustment assembly 124 comprises a first member 130 mounted to a distal end of the elongated rod 122, a housing 132 and a ball joint 134 that couples the housing 132 to the first member 130 for pivoting movement about a plurality of pivot axes. The ball joint 134 has, for example, a ball that is situated in an interior region of the housing 132 and that is fixed to a distal end of a shaft which extends in a cantilevered manner from the first member 130. The adjustment assembly 124 further comprises a manual adjuster 136 that, when rotated in a first direction, tightens the ball joint 134, such as by clamping a saddle or the like against the ball, to prevent the housing 132 from pivoting relative to the first member 130 and that, when rotated in a second direction opposite to the first direction, loosens the ball joint 134 to allow the housing 132 to pivot relative to the first member 130 about any of the plurality of pivot axes. Illustrative manual adjuster 136 comprises a knob or the like. However, in alternative embodiments, the manual adjuster 136 comprises other types of handles, buttons, or levers.

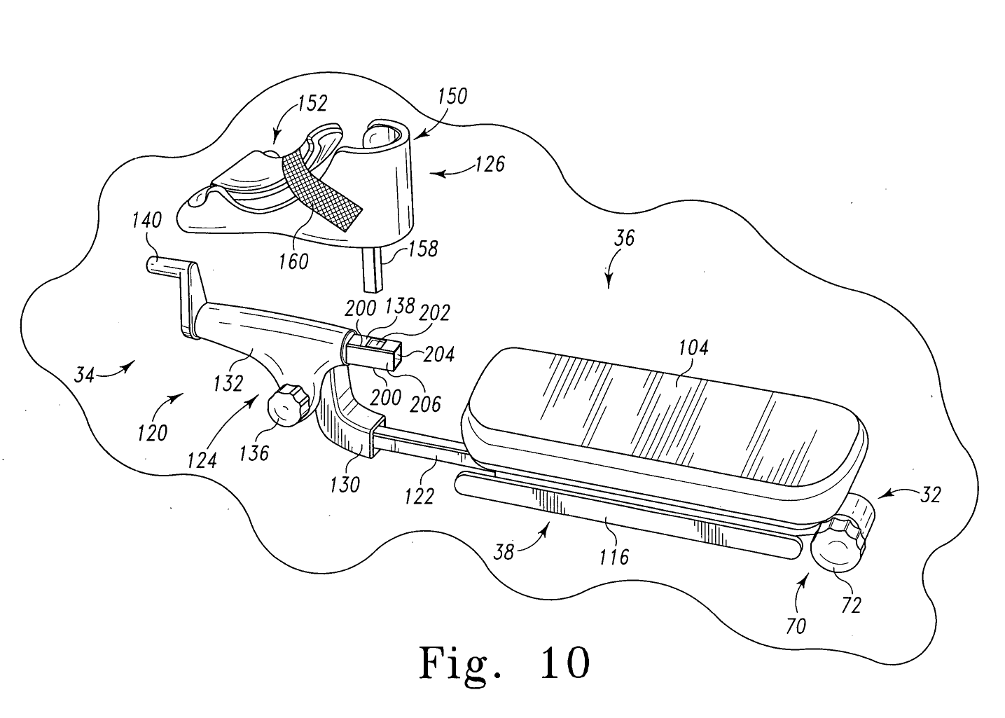

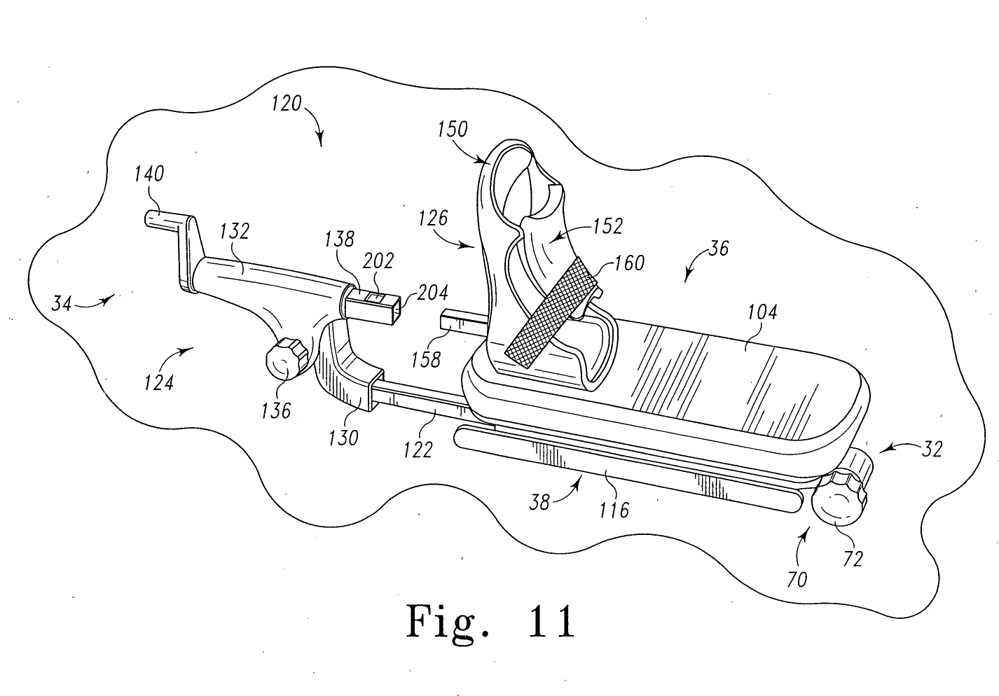

The adjustment assembly 124 further comprises an elongated tube 138, shown best in FIGS. 10 and 11, that extends from the housing 132, and a crank 140 that is coupled to the housing 132 for rotation about a crank axis 142 shown in FIG. 9. When the crank 140 is rotated in one direction about the crank axis 142, the tube 138 retracts relative to the housing 132, and when the crank 140 is rotated in an opposite direction about the crank axis 142, the tube 138 extends relative to the housing 132. Thus, the adjustment assembly 124 has a mechanism (not shown) that converts the rotary motion of the crank 140 into translational motion of the tube 138 relative the housing 132 of the adjustment assembly 124.

In some embodiments, a threaded shaft (not shown) is situated in the interior region of the housing 132 and is coupled to the crank 140 to rotate therewith about the crank axis 142. In such embodiments, a nut is coupled to the tube 138 and receives the threaded shaft so that the rotation of the threaded shaft translates the nut and the tube 138 linearly along the threaded shaft. The housing 132 or, alternatively, elements coupled to the housing 132, provide guide surfaces that permit the tube 138 to extend and retract linearly relative to the housing 132, but that prevent the tube 138 from rotating relative to the housing 132. Of course the tube 138 and the crank 140 pivot along with the housing 132 when the housing 132 is pivoted about any of the plurality of axes relative to the first member 130.

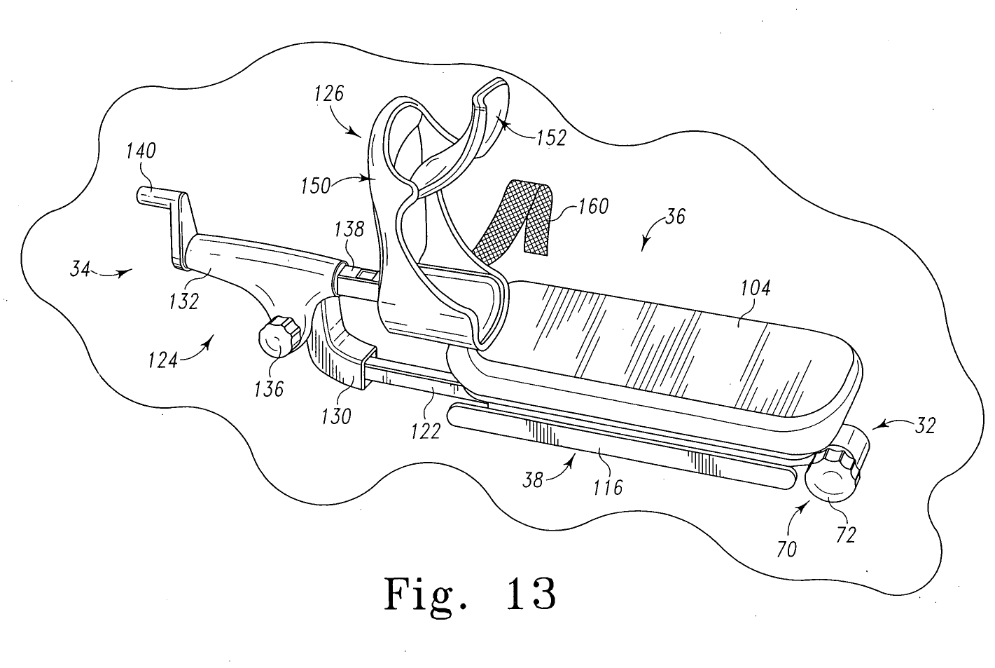

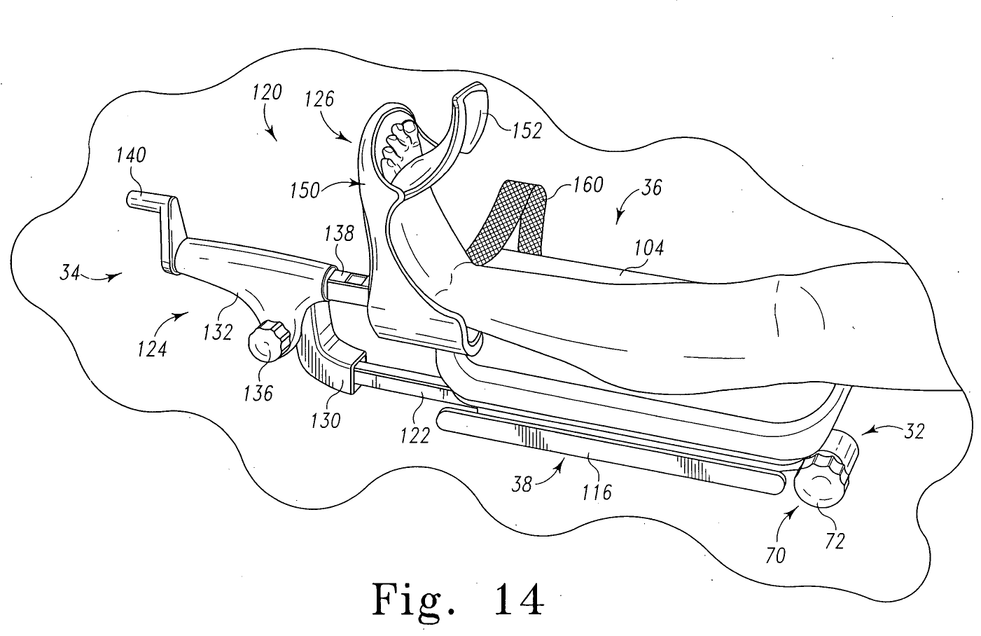

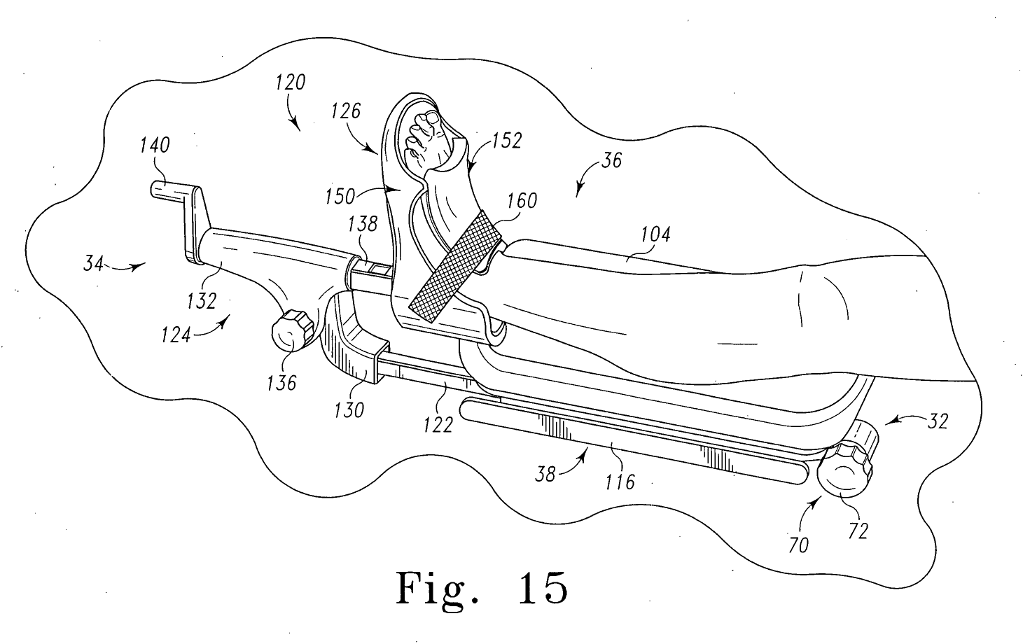

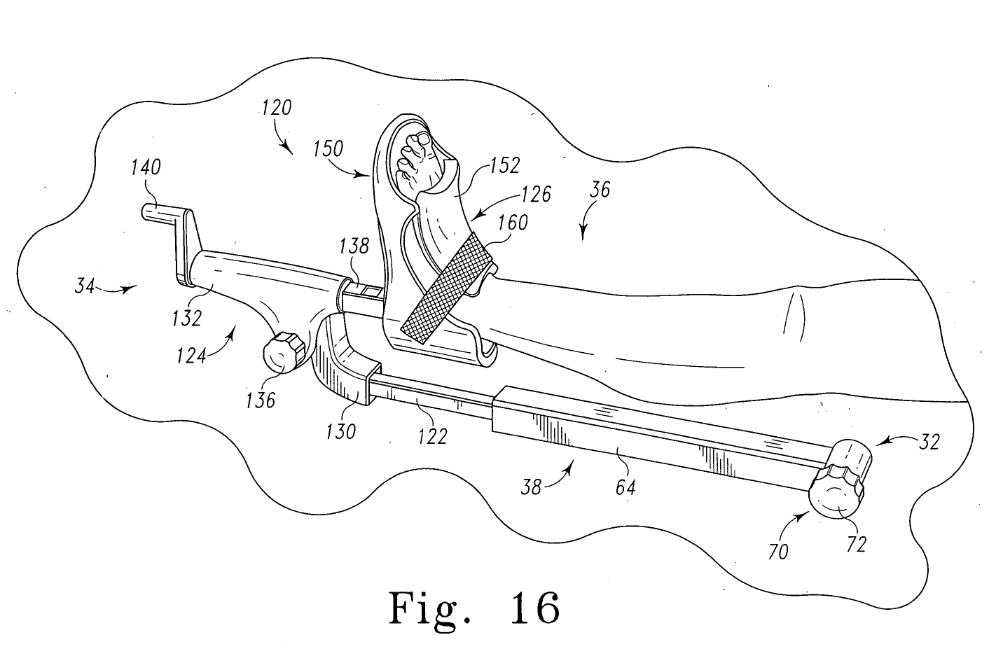

The traction boot 126 is configured to couple to a patient's foot as shown in FIGS. 15 and 16. Illustrative traction boot 126 has a first portion 150, a second portion 152 coupled to the first portion 150 for pivoting movement about an axis 154 (FIG. 9), a lock 156 (FIG. 9) and a post 158 as shown in FIGS. 9-16. The first portion 150 is configured to engage both the sole of a patient's foot and the back of the patient's heel. The second portion 152 is movable about the axis 154 to a variety of positions including an illustrative opened position shown in FIG. 13 in which a patient's foot may be inserted into the traction boot 126 as shown in FIG. 14, and a closed position engaging a top of the patient's foot as shown in FIGS. 15 and 16.

In the illustrative embodiment, the lock 156 comprises a strap 160 that extends across a top surface 162 of the second portion 152 between a first side 164 of the first portion 150 and a second side 166 of the first portion 150 to lock the second portion 152 in the first position as shown in FIGS. 15 and 16. The top surface 162 of the second portion 152 and the first and second sides 164, 166 of the first portion 150 are all shown in FIG. 9. In other embodiments, the lock 156 includes one or more bails that engage associated hooks, such as are used in ski boots, or latches that engage associated latch members.

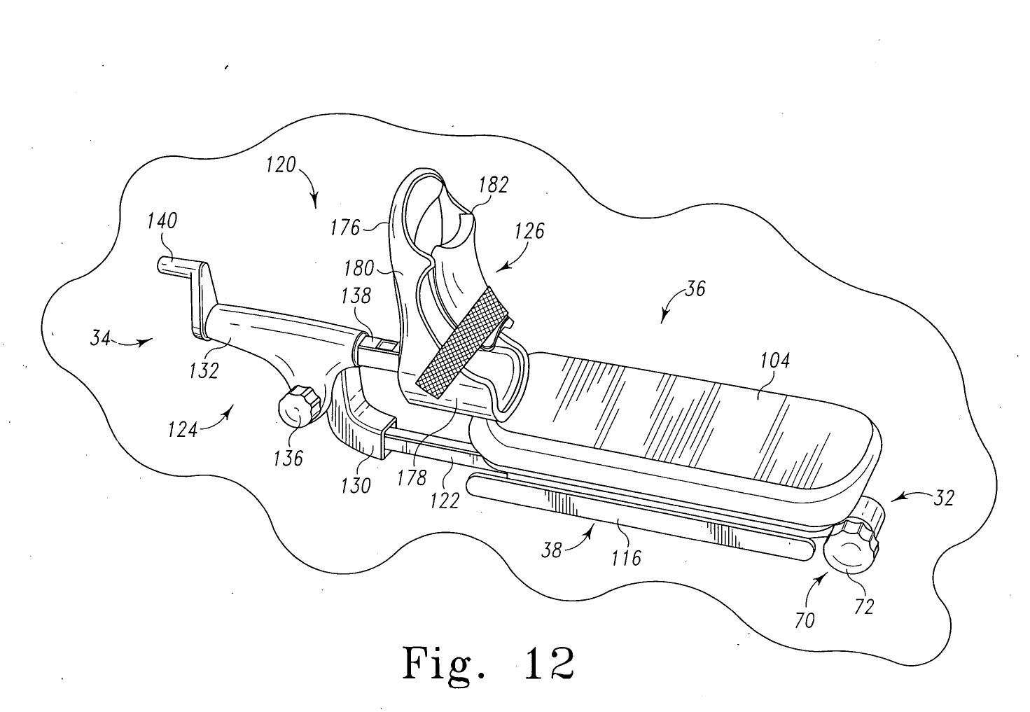

When not in use, the traction boot assembly 120 is normally placed in a storage position shown in FIGS. 6 and 7 in which the elongated rod 122 is retracted into the traction bar 64 and the adjustment assembly 124 is moved to an orientation having a portion of the traction boot 126, a portion of the housing 132 and the crank 140 situated beneath the calf section 104, and having the traction boot 126 hanging upside down. During movement of the traction boot assembly 120 from the storage position shown in FIGS. 6 and 7 to an exemplary use position shown in FIGS. 12-16, the elongated rod 122 is moved from the retracted position shown in FIGS. 6 and 7 to a desired extended position, one of which is shown in FIG. 8, and then the housing 132 of the adjustment assembly 124 is pivoted relative to the first member 130 from a first position shown in FIG. 8 to a second position shown in FIG. 9.

When the housing 132 is in the position shown in FIG. 8, the portion of the housing 132 that carries the tube 138 and the crank 140 are situated beneath the manual adjuster 136 and alongside the elongated rod 122. Also when the housing 132 is in the position shown in FIG. 8, the traction boot 126 hangs upside down from the tube 138 and is situated beneath the housing 132. When the housing 132 is in the position shown in FIG. 9, the portion of the housing 132 that carries the tube 138 and the crank 140 are situated above the manual adjuster 136 and the traction boot 126 is situated above the housing 132. Of course the manual adjuster 136 is tightened when the housing 132 is to be locked in one of these two positions shown in FIGS. 8 and 9, and the manual adjuster 136 is loosened when the housing 132 is to be moved between these positions.

The illustrative tube 138 is square-shaped in transverse cross section, and the post 158 is also square-shaped in transverse cross section. As shown in FIG. 10, a pair of opposed walls 200 of the tube 138 are each formed to include a square-shaped perpendicularly-extending first opening 202 near a distal end portion 206 of the tube 138. The post 158 is inserted in the pair of the perpendicularly-extending first openings 202 when the traction boot 126 is coupled to the tube 138 in an illustrative first orientation as shown in FIGS. 6-8. A portion of the post 158 is situated within each of the first openings 202 and within the interior region of the tube 138 when the traction boot 126 is coupled to the tube 138. A distal end portion 210 of the post 158 extends beyond the top wall 212 of the tube 138 as shown, for example, in FIG. 8. Additionally, the edges of the tube 138 that define the first openings 202 are in close proximity to the outer side surfaces of the post 158 to prevent rotation of the traction boot 126 relative to the tube 138. Because the post 158 and the first openings 202 are both square-shaped, the post 158 may be inserted into the first openings 202 in any one of four orientations. However, if compact storage of the traction boot assembly 120 is desired, the post 158 is inserted into the first openings 202 in the so-called first orientation having the long dimension of the traction boot 126 parallel with the long dimension of the housing 132 and having the toe region of the traction boot 126 adjacent to the crank 140 and pointing toward the head end 32 as shown in FIGS. 6-8.

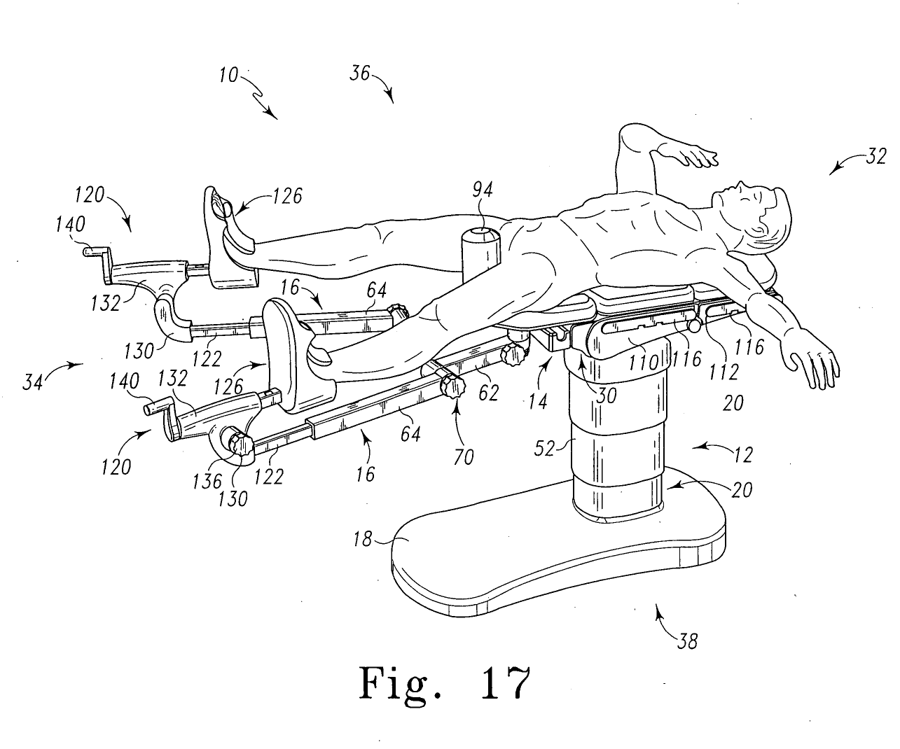

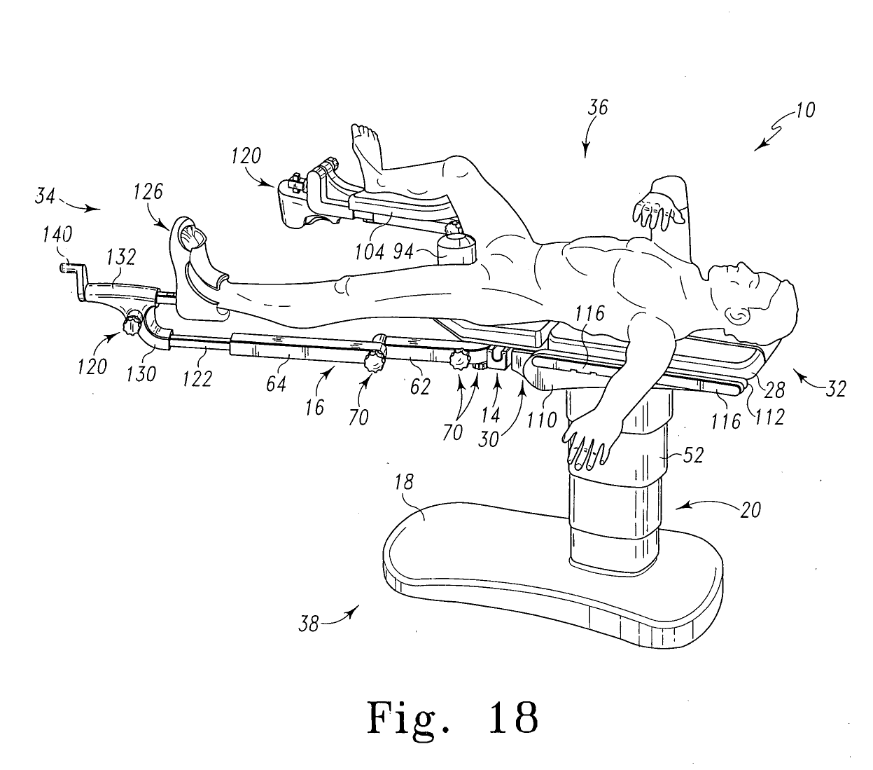

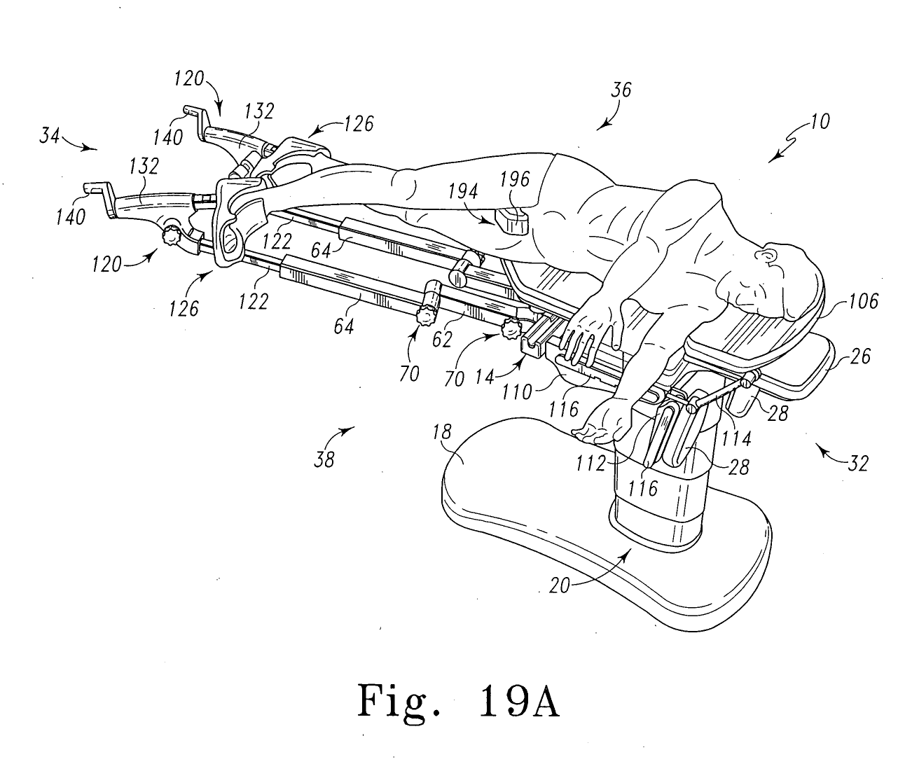

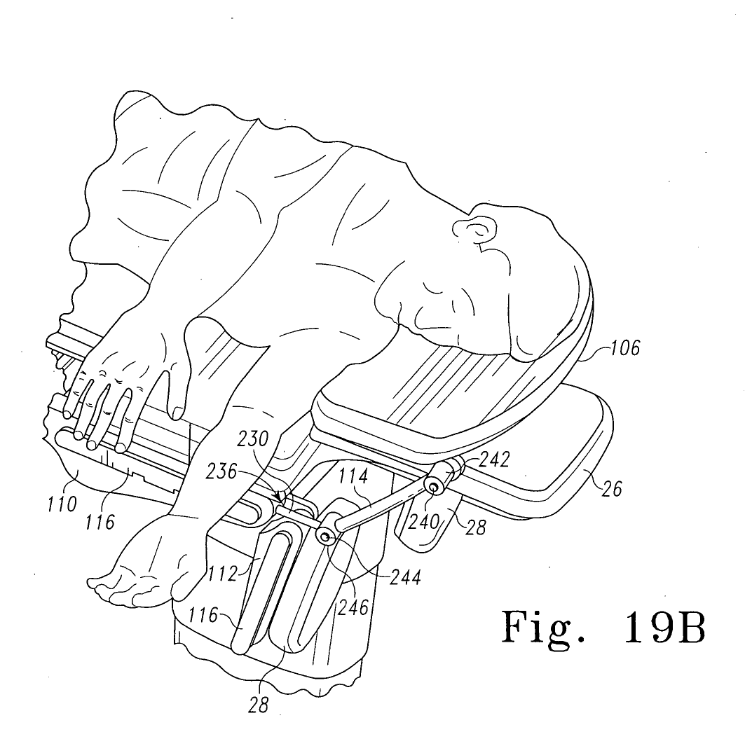

The distal end portion 206 of the tube 138 of the adjustment assembly 124 defines a square-shaped axially-extending second opening 204 in communication with the interior region of the tube 138 as shown, for example, in FIGS. 9-11. The post 158 is inserted into the interior region of the tube 138 through the axially-extending second opening 204 to couple the traction boot 126 to the tube 138 in an illustrative second orientation as shown in FIGS. 12-16. The interior surfaces of the tube 138 are in close proximity to the outer side surfaces of the post 158 to prevent rotation of the traction boot 126 relative to the tube 138 when the traction boot 126 is coupled to the tube 138 in the second orientation. Because the post 158 and the tube 138 both have square-shaped cross sections, the post 158 may be inserted into the tube 138 through the axially-extending second opening 204 in four different orientations. A surgeon will choose which of these four orientations is best suited for the particular surgical procedure to be performed on the patient. For example, the orientation shown in FIGS. 17 and 18 is selected for applying bilateral and unilateral hip traction to a patient, respectively, whereas the orientation shown in FIG. 19 is selected for performing a lateral intramedullary nailing procedure, for example. Although the illustrative tube 138, the post 158 and the perpendicularly and axially-extending openings 202, 204 are each square-shaped in cross section, it is within the scope of this disclosure for the tube 138, the post 158 and the openings 202, 204 to have other nonround cross sections, such as semicircular, rectangular, oval, triangular, pentagonal, hexagonal, octagonal, and so on.

The traction boot assembly 120 includes one or more suitable locking mechanisms (not shown) that releasably lock the traction boot 126 in the first and second orientations relative to the tube 138. In some illustrative embodiments, such locking mechanisms includes, for example, a spring-biased latch or pin having a first portion that is situated in the interior region of the tube 138 and configured for receipt in one or more notches, grooves, or holes (not shown) formed in the post 158 to lock the traction boot 126 to the tube 138 as shown, for example, in FIGS. 9 and 12, and having a second portion that is accessible to the caregiver for manipulation to withdraw the first portion against the spring bias from the notch, groove, or hole to permit decoupling of the traction boot 126 from the tube 138.

In other embodiments, the locking mechanisms for releasably locking the traction boot 126 relative to the tube 138 include, for example, a set of members, such as pins, prongs, tabs, or the like, that are coupled to the post 158 and that are biased outwardly toward extended positions projecting from each of the sides of the post 158 and that are movable manually to retracted positions in which the members are retracted into the post 158. Such members may be configured to automatically cam inwardly to the retracted positions due to engagement with the tube 138 during insertion of the post 158 through the pair of perpendicularly-extending first openings 202 or through the axially-extending second opening 204, and that spring outwardly to the extended positions upon the post 158 reaching full insertion through either the pair of the perpendicularly-extending first openings 202 or the axially-extending second opening 204, as the case may be. In such an embodiment, the members associated with all four side surfaces of the post 158 are in the extended positions projecting away from the side surfaces of the post 158 adjacent to the top wall 212 of the tube 138 when the traction boot 126 is coupled to the tube 138 in the first orientation, but only the members associated with the two side surfaces of the post 158 facing the opposed walls 200 are in the extended positions and projecting into the pair of the perpendicularly-extending first openings 202 when the traction boot 126 is coupled to the tube 138 in the second orientation.

In an alternative embodiment, the locking mechanism for releasably locking the traction boot 126 to the tube 138 includes a pin that is inserted through an aperture formed in the post 158 after the traction boot 126 is placed in the first orientation or the second orientation relative to the tube 138. In such an embodiment, the pin couples to the distal end region of the post 158 and has end portions that project beyond the side surfaces of the post 158. The end regions of the pin engage the top wall 212 of the tube 138 to lock the traction boot 126 to the tube 138 in the first orientation, and are received in the perpendicularly-extending first openings 202 in the tube 138 to lock the traction boot 126 to the tube 138 in the second orientation. In some embodiments, the pin has a head associated with one end region and has a movable element, such as a ball retainer, associated with the other end region. The head and ball retainer prevent inadvertent removal of the pin from the aperture formed in the post 158. In such an embodiment, a push button adjacent to the head is engageable to allow the ball retainer to retract into the pin so that the pin can be decoupled from the post 158.

To move the traction boot 126 from the first orientation shown in FIG. 9 to the second orientation shown in FIG. 12, the traction boot 126 is decoupled from the tube 138 as shown in FIG. 10. The traction boot 126 is then moved to a position having the post 158 aligned with the tube 138 as shown in FIG. 11. After the post 158 is aligned with the tube 138, the post 158 is inserted into the tube 138 through the axially-extending second opening 204 as shown in FIG. 12. Thus, the post 158 is perpendicular to the tube 138 when the traction boot 126 is in the first orientation as shown in FIG. 9 (or in any of the other three orientations in which the post 158 may be inserted into the pair of perpendicularly-extending first openings 202), and the post 158 is substantially coaxial with the tube 138 when the traction boot 126 is in the second orientation as shown in FIG. 12 (or in any of the other three orientations in which post 158 may be inserted into the axially-extending second opening 204).

After the traction boot 126 is in the second orientation, the second portion 152 of the traction boot 126 is moved to the opened position as shown in FIG. 13 to allow the patient's foot to be inserted into the traction boot 126 as shown in FIG. 14. The second portion 152 of the traction boot 126 is then moved back to the closed position engaging the top of the patient's foot as shown in FIG. 15. After the patient's foot is inserted into the traction boot 126 and the second portion 152 is moved to the closed position engaging the top of the patient's foot, the strap 160 is manipulated to prevent the second portion 152 from being able to pivot away from the patient's foot toward the opened position. Prior to placement of the patient's foot in the traction boot 126, the patient's lower leg is supported by the calf section 104. After the patient's foot is securely fastened in the traction boot 126, the calf section 104 is removed from the traction bar 64 to increase access to the patient's leg as shown in FIG. 16. The crank 140 may then be rotated, as desired, to extend or retract the tube 138 relative to the housing 132 to increase or decrease the amount of traction applied to the patient's leg. The elongated rod 122 and the tube 138 each may include visible indicia, such as graduated markings, to indicate the amount by which the rod 122 is extended out of the second traction bar 64 and to indicate the amount by which the tube 138 is extended out of the housing 132.

In some embodiments in which the strap 160 is provided for locking the second portion 152 in place against a patient's foot, suitable couplers are provided on opposite ends of the strap 160 and on the first portion 150 to allow releasable coupling of the strap 160 to the first portion 150. In other embodiments, one end of the strap 160 is anchored to the first portion 150 and the opposite end of the strap 160 is releasably coupleable to the first portion 150 via any suitable coupler. In further embodiments, one end of the strap 160 is anchored to one side of the first portion 150 and an opposite free end of the strap 160 is threaded through an eyelet formed in or mounted to the opposite side of the first portion 150 and then the free end of strap is releasably fastened to a middle region of the strap 160, such as with hook and loop fasteners. In still further embodiments, a middle region of the strap 160 is anchored to the second portion 152 and the opposite ends of the strap 160 releasably couple to the respective sides 144, 146 of the first portion 150 with suitable couplers.

Suitable couplers for providing releasable coupling of the strap 160 to the first portion 150 or to the second portion 152, as the case may be, may include, for example, hook and loop fasteners (e.g., VELCRO brand hook and loop fasteners). As another example, elements that snap together may be provided to couple the strap 160 to the first portion 150 or to the second portion 152. As a further example, buckles may be coupled to the first portion 150 and the strap 160 may have a series of holes that are each configured to receive a prong of the buckle. As yet another example, a post or hook may extend from the first portion 150 and the strap 160 may have a series of apertures that are each configured to receive the post or hook. In those embodiments having one end of the strap 160 anchored to the first portion 150, such anchoring may be accomplished, for example, by rivets or by clips or by threading an end of the strap 160 through an eyelet that is permanently coupled to the first portion 150 or that is formed integrally with the first portion 150 and then sewing the end of the strap 160 to another portion thereof. Another example of anchoring the strap 160 to the first portion 150 is to thread an end of the strap 160 through a slot formed in the first portion 150 and to couple an anchor member that is larger than the slot to the end of the strap 160. In those embodiments having a middle region of the strap 160 anchored to the second portion 152, such anchoring may be accomplished by rivets or by clips or by threading the strap 160 through one slot formed in the second portion 152 and then through a second slot formed in the second portion 152. The examples of releasable coupling and anchoring enumerated above are in no way intended to be limiting, but rather, it is intended that all types of releasable couplers and anchors usable with straps are within the scope of this disclosure.

The first portion 150 of the traction boot 126 has a substantially rigid shell 168 and a cushioning material or padded liner 170 that is coupled to at least a portion of the shell 168 as shown in FIG. 9. Similarly, the second portion 152 of the traction boot 126 has a substantially rigid shell 172 and a cushioning material or padded liner 174 that is coupled to at least a portion of the shell 172. The shells 168, 172 are made from, for example, a radiolucent plastic material that is blow molded, injection molded, cast, or machined into the desired shape. It is within the scope of this disclosure for the shells 168, 172 to be made of any material that is sufficiently rigid and durable enough to withstand the traction forces applied thereto. Illustrative shell 168 has a generally flat portion 176 that covers the sole of a patient's foot, a generally semi-cylindrical portion 178 that covers the back of the patient's heel, a pair of side walls 180 that lie generally alongside the sides of the patient's foot, and a pair of pivot portions 182 that extend from the side walls 180. The second portion 152 is coupled to the pivot portions 182 of the shell 168 with pivot pins, for example. The post 158 is substantially perpendicular to the flat portion 176 of the shell 168, and extends outwardly from the region of the flat portion 176 associated with the patient's heel.

In some embodiments, the liner 170 lines substantially the entire interior surface of the rigid shell 168 (i.e., the surface of the shell facing the patient's foot). In other embodiments, the liner 170 lines only part of the interior surface of the rigid shell 168. Likewise, the liner 174 lines substantially the entire interior surface of the rigid shell 172 in some embodiments, and lines only a portion of the interior surface of the rigid shell 172 in other embodiments. In each of these particular embodiments, the liner 174 engages the top of the patient's foot when the second portion 152 is in the closed position. In still other embodiments, liners 170, 174 are omitted. The liners 170, 174 each comprise one or more layers of foam, such as viscoelastic foam, and a cover that encases the one or more layers. In some embodiments, layers other than foam, such as a gel pad layer, are included in liners 170, 174. The liners 170, 174 attach to the associated rigid shells 168, 172, respectively, with suitable couplers such as hook and loop fasteners. Reusable liners 170, 174 and disposable liners 170, 174 are contemplated by this disclosure.

Referring now to FIGS. 17-19a, the surgical table 10 may be placed in a variety of positions to apply traction to one or both of a patient's legs. FIG. 17 shows application of bilateral hip traction to a patient supported on the surgical table 10. For applying bilateral hip traction, the thigh sections 102 are detached from the respective first traction bars 62 and the countertraction post 94 is attached to the seat section 90. The traction boot assemblies 120 are moved from the storage positions shown in FIG. 6 to the use positions shown in FIG. 9, and the traction boots 126 are moved from the first orientations shown in FIG. 9 to the second orientations shown in FIG. 13. The traction bar assemblies 16 are abducted slightly so that the patient's legs can be supported comfortably on the respective calf sections 104 with the countertraction post 94 disposed between the patient's legs, and engaging the patient's pelvic region. After the patient's feet are inserted into the respective traction boots 126 as shown in FIG. 14, the second portions 152 of the traction boots 126 are moved back to the closed positions engaging the tops of the patient's feet and the straps 160 are securely fastened to secure the patient's feet in the respective traction boots 126 as shown in FIG. 15. The calf sections 104 are then removed from the second traction bars 64 to increase access to the patient's legs as shown in FIG. 16. The crank 140 may then be rotated, as desired, to increase (or decrease) the amount of traction applied to the patient's legs as shown in FIG. 17. The countertraction post 94 prevents the patient from sliding toward the foot end 34 of the surgical table 10 when traction is applied to the patient's feet.

FIG. 18 shows application of unilateral hip traction to a patient supported on the surgical table 10. As shown therein, only the traction boot assembly 120 associated with the traction bar assembly 16 on the patient's left side has the respective boot 126 securely fastened to the patient's left leg for applying unilateral hip traction to the patient. The traction boot assembly 120 associated with the traction bar assembly 16 on the patient's right side is not coupled to the patient's right leg. Instead, the traction bar assembly 16 associated with the patient's right leg is articulated so that the calf section 104 underlying the patient's right leg supports the patient's right leg in an elevated position. The crank 140 may then be rotated, as desired, to increase (or decrease) the amount of traction applied to the patient's left leg. Although unilateral hip traction is applied to the patient's left leg in the illustration of FIG. 18, the unilateral hip traction may very well be applied to a patient's right leg.

FIG. 19a shows a patient resting on his left side on the surgical table 10 and positioned for the application of a lateral intramedullary nailing procedure. For this procedure, the countertraction post 94 shown in FIGS. 17 and 18 is replaced with a countertraction post 194, and the head section 106 is moved to a position slightly higher in elevation than, and overlying a portion of, the back support portion 26 as shown in FIGS. 19a and 19b. The countertraction post 194 has a vertically-extending first portion that is removably received in the vertical socket 100 formed in the seat section 90. The countertraction post 174 has a laterally-extending second portion 196 that is received between the patient's legs and engages the patient's pelvic region as shown. The posts 158 of the traction boot assemblies 120 are inserted into the associated tubes 138 of the adjustment assemblies 124 so that the long dimensions of the traction boots 126 extend horizontally, and the toes of the traction boots 126 point in the same direction as the patient as shown in FIG. 19a. The traction boot assembly 120 on the left side of table 10 is coupled to the right foot of the patient, and the traction boot assembly 120 on the right side of table 10 is coupled to the left foot of the patient as shown. The cranks 140 may be rotated, as desired, to increase (or decrease) the amount of traction applied to the patient's legs. Although the patient is shown resting on his left side on the surgical table 10 for application of lateral intramedullary nailing procedure in FIG. 19a, he may very well be resting on his right side for the lateral intramedullary nailing procedure.

As mentioned above, the head section 106 is moved to a position slightly higher in elevation than, and overlying a portion of, the back support portion 26 to comfortably support a patient's head for lateral intramedullary nailing procedure. Head section 106 may be positioned similarly for other surgical procedures as well. To this end, the head section 106 is detached from the shoulder support portions 28, the shoulder support portions 28 are pivoted away from their respective coplanar positions, and the head section 106 is then reattached to the back support portion 26 instead of the shoulder support portions 28. After reattaching the head section 106 to the back support portion 26, the head section 106 is moved to a higher elevation relative to the back support portion 26.

A mechanism that permits raising and lowering of the head section 106 will now be explained with reference to FIG. 19b. A pair of laterally-spaced members or posts 230 are pivotally coupled to the laterally-spaced frame members 114 of the head section 106. One end of each frame members 114 is pivotally coupled to the associated post 230 and an opposite end is pivotally coupled to the panel of the head section 106. A first pair of laterally-spaced sockets (not shown) are provided in the laterally-spaced frame members 112 of the shoulder support portions 28. A second pair of laterally-spaced sockets 236 are provided in the laterally-spaced frame members 110 of the back support portion 26. The laterally-spaced posts 230 of the head section 106 are configured for reception in the first pair of laterally-spaced sockets of the shoulder support portions 28 when the shoulder support portions 28 are in their respective first coplanar positions as shown in FIG. 6. On the other hand, the laterally-spaced posts 230 of the head section 106 are configured for reception in the second pair of laterally-spaced sockets 236 of the back support portion 26 when the shoulder support portions 28 are pivoted to their respective out-of-the-way second positions as shown best in FIG. 19b.

As previously indicated, one end of each frame members 114 is pivotally coupled to the associated post 230 and an opposite end is pivotally coupled to the panel of the head section 106. A transversely-extending post or pin 240 pivotably couples a sleeve 242 attached to one end of the frame member 114 to a pin receiver (not shown) mounted on an undersurface of the panel of the head section 106. A second transversely-extending pin 244 pivotably couples the post 230 to a second sleeve 246 attached to the opposite end of the frame member 114. In some embodiments, the transversely-extending pins 240, 244 are sized for friction fit reception into the associated sleeves 242, 246. Alternatively, suitable clutch and release mechanisms may be provided for locking the head section 106 relative to the back section 24. For example, various types of manually operated clutch and release mechanisms, such as lever or push button operated clutches like those shown and described in U.S. patent application Ser. Nos. 10/056,552 and 10/056,959 may be used.

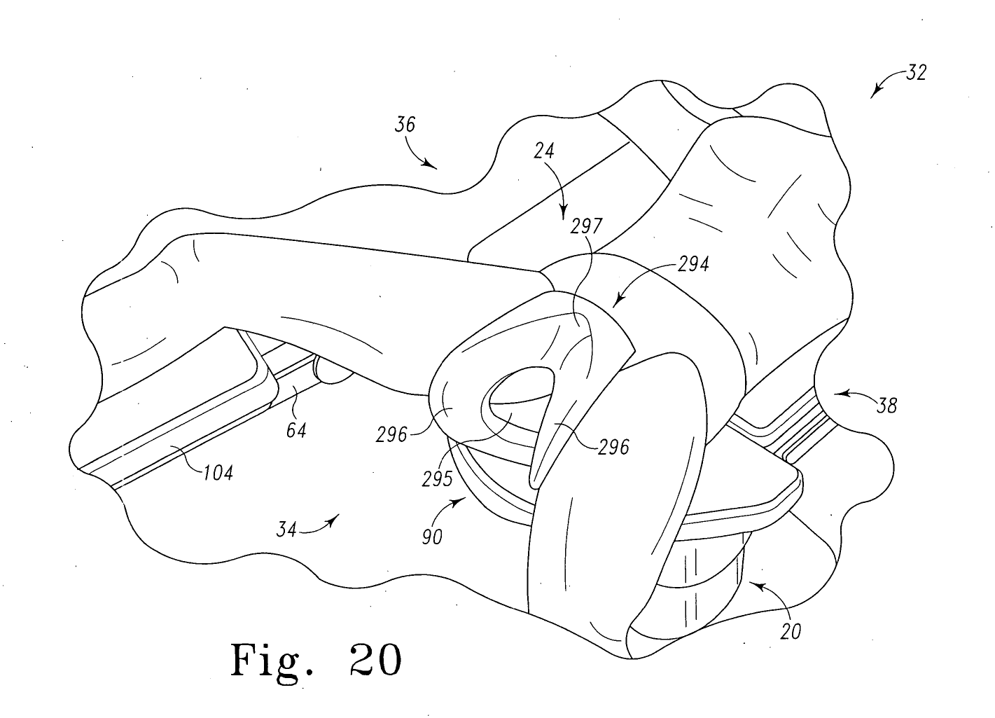

The countertraction post 94 shown in FIGS. 17 and 18 may be replaced with a countertraction saddle 294 shown in FIG. 20. The countertraction saddle 294 has a vertically-extending first portion or post (obscured from view) that is removably received in the vertical socket 100 formed in the seat section 90. The countertraction saddle 294 has generally C-shaped second portions 296 that are interconnected by a bridge portion 297 which overlies the first portion when saddle 294 is coupled to seat section 90. Saddle 294 is disposed between the patient's legs so that portions 296 engage the upper regions of the patient's inner thighs and so that portion 297 engages the top of the patient's pelvis, thereby preventing the patient from sliding toward the foot end 34 of the surgical table 10 when traction is applied to the patient's feet. A hole 295 in saddle 294 is surrounded by portions 296, 297 and accommodates the patient's pubic area and genitalia.

As previously mentioned, the surgical table 10 includes a drive mechanism that is operable to pivot the powered pivot couplers 30 relative to the vertical column 20 about the transverse pivot axis 42, shown, for example, in FIG. 1. As shown in FIG. 21, the transverse bar 14 is releaseably coupled to the powered pivot couplers 30 by a pair of brackets 250 that are fixedly attached to the transverse bar 14 and that extend forwardly from the transverse bar 14. Each powered pivot coupler 30 is formed to include a rearwardly and upwardly-extending catch or lobe 252. Each bracket 250 is formed to include a complementary forwardly and downwardly-extending catch-receiving space 254 for receiving the associated catch 252, thereby releasably securing the transverse bar 14 to the powered pivot couplers 30. In some embodiments, an additional latch or lock is provided to enhance the coupling between bracket 250 and couplers 30. Articulation of the powered pivot couplers 30 about the transverse pivot axis 42 causes articulation of the transverse bar 14 about the pivot axis 42. Articulation of the transverse bar 14, in turn, causes articulation of any orthopedic surgery modules coupled to the transverse bar 14, such as the traction bar assemblies 16 coupled to the traction bar 14 and the traction boot assemblies 120 coupled to the traction bar assemblies 16. As used in this description, the term “forwardly” means toward the head end 32, and the term “rearwardly” means toward the foot end 34.

The two traction bar assemblies 16 are each independently movable laterally along the transverse bar 14 to any desired position and lockable in place on the bar 14 as previously mentioned. To this end, the top surface of the transverse bar 14 has a transversely-extending guide channel 260 that divides the transverse bar 14 into two oppositely-facing transversely-extending guideways 262 as shown in FIG. 21. The bracket 80 of each traction bar assembly 16 includes a first portion 264 that is attached to the block 84 of the multi-joint coupler 66, top and bottom flange portions 266 that extend forwardly from the ends of the first portion 264 and a catch portion 268 that extends downwardly from the end of the top flange portion 266 and that is configured for reception in the transversely-extending guide channel 260 of the transverse bar 14. The first portion 264, the top and bottom flange portions 266 and the catch portion 268 of each bracket 80 define a guideway-receiving space 270 in which the rearwardly-facing guideway 262 of the transverse bar 14 is received, thereby permitting lateral movement of the traction bar assemblies 16 along the transverse bar 14. Each traction bar assembly 16 includes a manual adjuster 70 that is movable to loosen the connection between the bracket 80 and the transverse bar 14 to allow lateral translation of the associated traction bar assembly 16 along the bar 14. Likewise, each manual adjuster 70 is movable to tighten the connection between the bracket 80 and the transverse bar 14 to lock the associated traction bar assembly 16 in place on the bar 14.

As previously mentioned, the seat section 90 is likewise independently movable laterally along the transverse bar 14 to any desired position and lockable in place on the transverse bar 14. The seat section 90 includes a mattress pad 278 and a panel 280 to which the mattress pad 278 removably attaches as shown in FIG. 21. One or more laterally spaced brackets 282 are attached to the underside of the panel 280 of the seat section 90 by any suitable means, such as a pair of threaded screws or studs as shown. Each bracket 282 includes a first portion 284, top and bottom flange portions 286 that extend rearwardly from the ends of the first portion 284 and a catch portion 288 that extends downwardly from the end of the top flange portion 286 and that is configured for reception in the transversely-extending guide channel 260 of the transverse bar 14. The first portion 284, the top and bottom flange portions 286 and the catch portion 288 of each bracket 284 define a guideway-receiving space 290 in which the forwardly-facing guideway 262 of the transverse bar 14 is received, thereby allowing lateral movement of the seat section 90 along the transverse bar 14. Each bracket 282 includes a manual adjuster 70 that is movable to loosen the connection between the bracket 282 and the transverse bar 14 to allow lateral translation of the seat section 90 along the bar 14. Likewise, each manual adjuster 70 is movable to tighten the connection between the bracket 282 and the transverse bar 14 to lock the seat section 90 in place on the bar 14. In the illustrative embodiment, each of the adjusters 70 associated with brackets 80, 282 comprises a threaded shaft or bolt and a knob for turning the bolt.

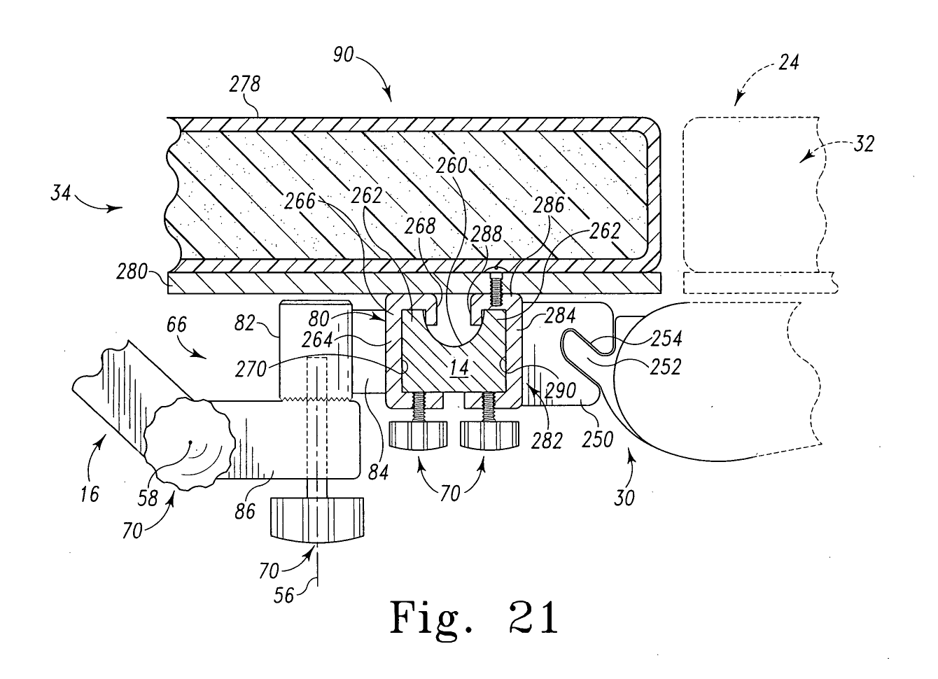

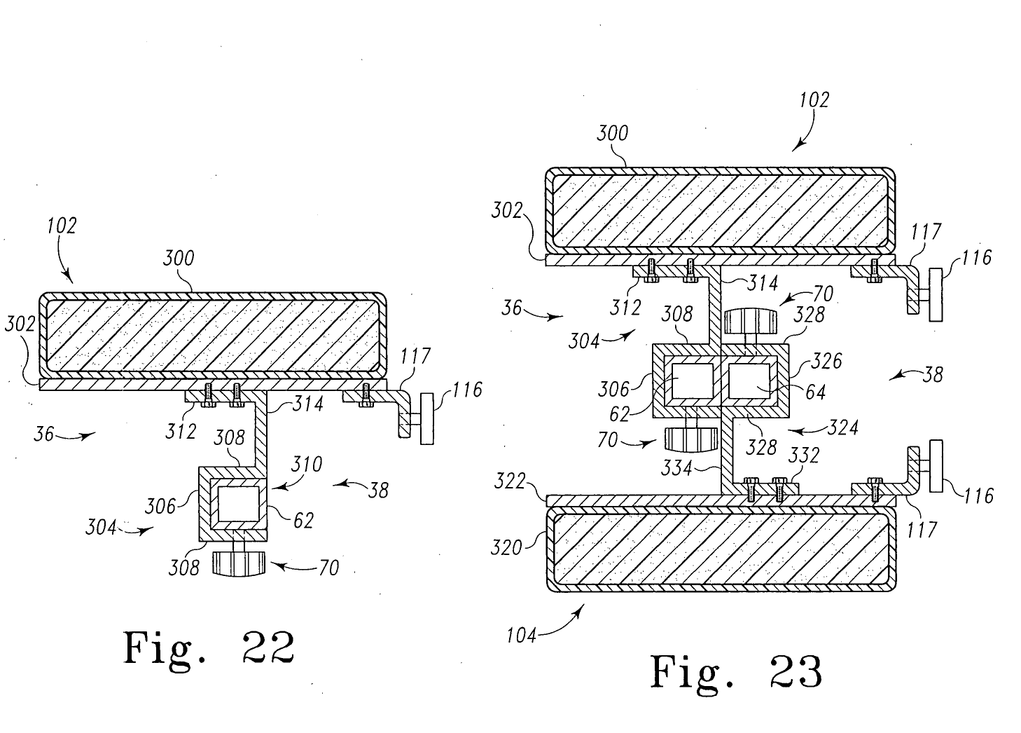

Each thigh section 102 includes a mattress pad 300 and a panel 302 to which the mattress pad 300 removably attaches as shown in FIG. 22. One or more brackets 304 are attached to the underside of the panel 302 by any suitable means, such as a pair of threaded screws or studs as shown. Each bracket 304 includes a first portion 306 and top and bottom flange portions 308 that extend laterally outwardly from the ends of the first portion 306 to define a bar-receiving space 310 in which the associated first traction bar 62 is received. Each bracket 304 further includes a horizontally-extending portion 312 that is secured to the underside of the panel 302 of the thigh section 102 by threaded screws or studs and a vertically-extending portion 314 that extends between the horizontally-extending portion 312 and the top flange portion 308. Each bracket 304 includes a manual adjuster 70 that is movable to loosen the connection between the bracket 304 and the associated first traction bar 62 to allow removal of the thigh section 102 from the bar 62. Likewise, the manual adjuster 70 is movable to tighten the connections between the bracket 304 and the associated first traction bar 62 to lock the thigh section 102 in place on the bar 62. Accessory rail 116 associated with the thigh section 102 is coupled to the underside of panel 302 by one or more L-shaped brackets 117 as shown in FIG. 22.

FIG. 23 shows one of the calf sections 104 pivoted beneath the associated thigh section 102. Each calf section 102 includes a mattress pad 320 and a panel 322 to which the mattress pad 320 removably attaches. One or more brackets 324 are attached to the underside of the panel 322 by any suitable means, such as a pair of threaded screws or studs as shown. Each bracket 324 includes a first portion 326 and top and bottom flange portions 328 that extend laterally inwardly from the ends of the first portion 326 to define a bar-receiving space 330 in which the associated second traction bar 64 is received. Each bracket 324 further includes a horizontally-extending portion 332 that is secured to the underside of the panel 322 of the calf section 104 by threaded screws or studs and a vertically-extending portion 334 that extends between the horizontally-extending portion 332 and the top flange portion 328. Each bracket 324 includes a manual adjuster 70 that is movable to loosen the connection between the bracket 324 and the associated second traction bar 64 to allow removal of the calf section 104 from the bar 64. Likewise, the manual adjuster 70 is movable to tighten the connections between the bracket 324 and the associated second traction bar 64 to lock the calf section 104 in place on the bar 64. Accessory rail 116 associated with the calf section 104 is coupled to panel 322 by one or more L-shaped brackets 117.

Brackets 304, 324 are configured to permit the traction bars 62, 64 to fold into a compact storage configuration as shown in FIG. 23. Illustrative brackets 304, 324 extend around three of the walls of the traction bars 62, 64, respectively. The walls of the traction bars 62, 64 which are not covered by the brackets 302, 324 confront one another when the traction bars 62, 64 are in the storage configuration shown in FIG. 23.

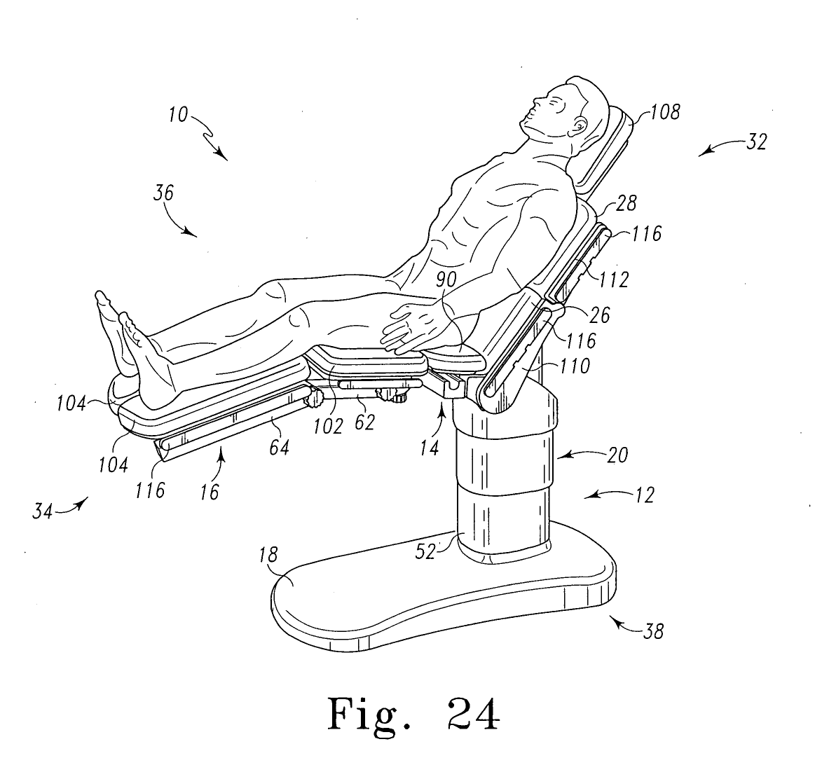

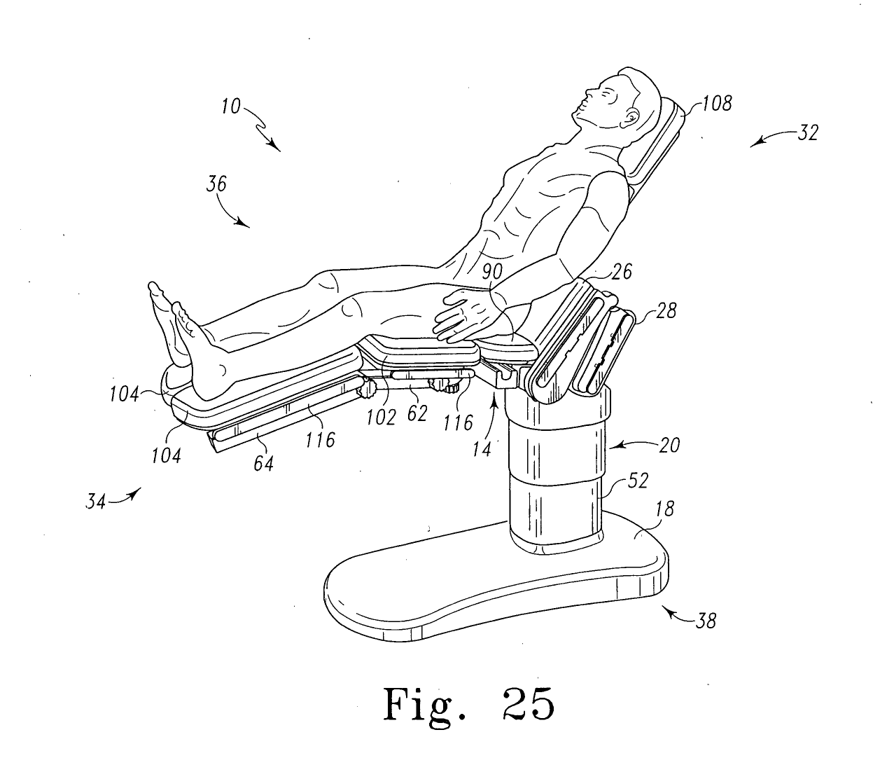

Referring again to FIG. 6, the back section 24 comprises the back support portion 26 and the shoulder support portions 28. The back support portion 26 includes a relatively wide first portion 220 near the seat section 90 and a relatively narrow second portion 222 near the head section 106. The relatively wide first portion 220 of the back support portion 26 has a first transverse width 224, and the relatively narrow second portion 222 of the back support portion 26 has a second transverse width 226 that is smaller than the first transverse width 224 such that a pair of cut-outs 228 are defined alongside the opposite sides 36, 38 of the relatively narrow second portion 222 near the head end 32. The generally rectangular shoulder support portions 28 are movable between a first position where the shoulder support portions 28 are coplanar with the back support portion 26 and are received in the respective cut-outs 228 of the back support portion 26, and a second position out of the cut-outs 228 and away from the first position. In the illustrative embodiment, the shoulder support portions 28 are pivotable about respective transversely-extending axes between the first coplanar position shown in FIG. 24 and the second out-of-the-way position shown in FIG. 25.

For shoulder surgery, the relatively wide head section 106 is detached from the back section 24 of the surgical table 10 of FIG. 6, and a relatively narrow head section 108 is instead attached to the back section 24 as shown in FIG. 24 to support a patient's head. In addition, the countertraction post 94 and the traction boot assemblies 120 may be detached from the seat section 90 and the traction bar assemblies 16, respectively. In FIGS. 24 and 25, the back section 24 of the patient support deck 22 is articulated upwardly relative to the vertical column 20, the seat section 90 and the thigh sections 102 are pivoted slightly upwardly relative to the vertical column 20 and the calf sections 104 are pivoted slightly downwardly relative to thigh sections 102 to support the patient in a sitting-up position. One of the shoulder support portions 28 of the back section 24, for example, the shoulder support portion 28 on the left side of the patient, is pivoted away from the cut-out 228 formed in the back section 24 to expose a posterior portion of the patient's left shoulder for shoulder surgery as shown in FIG. 25.

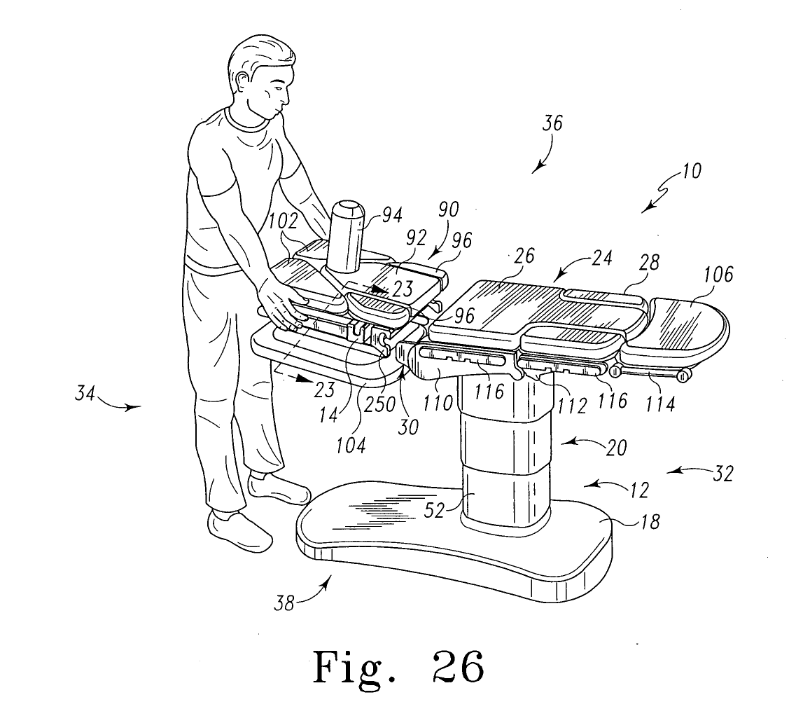

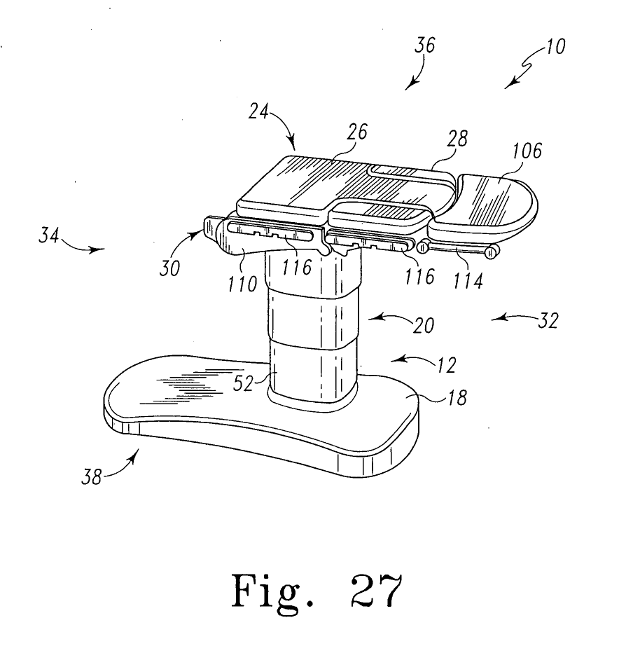

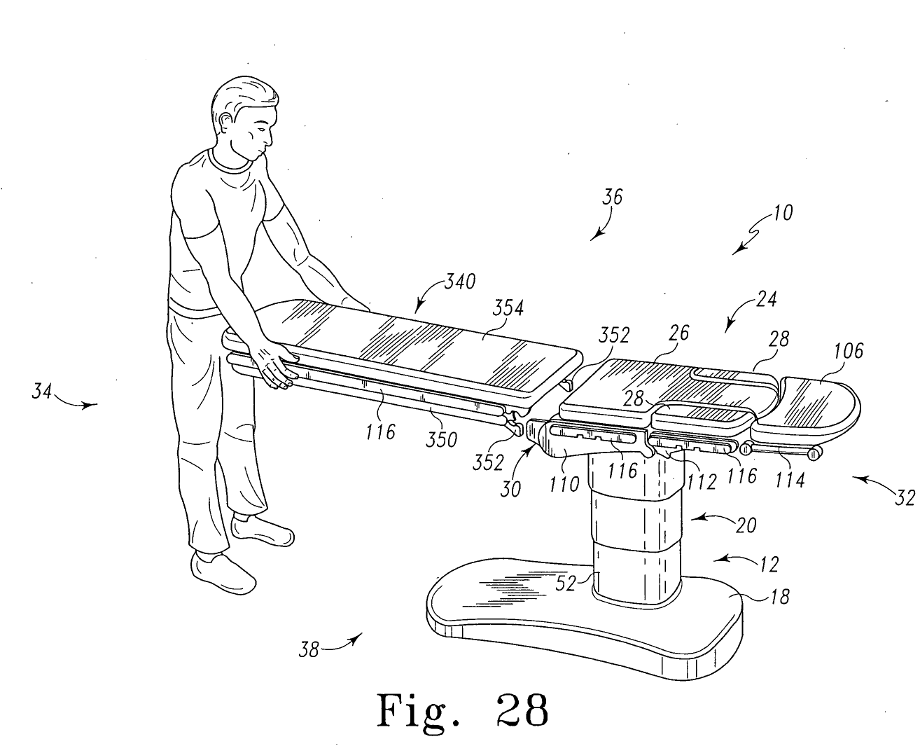

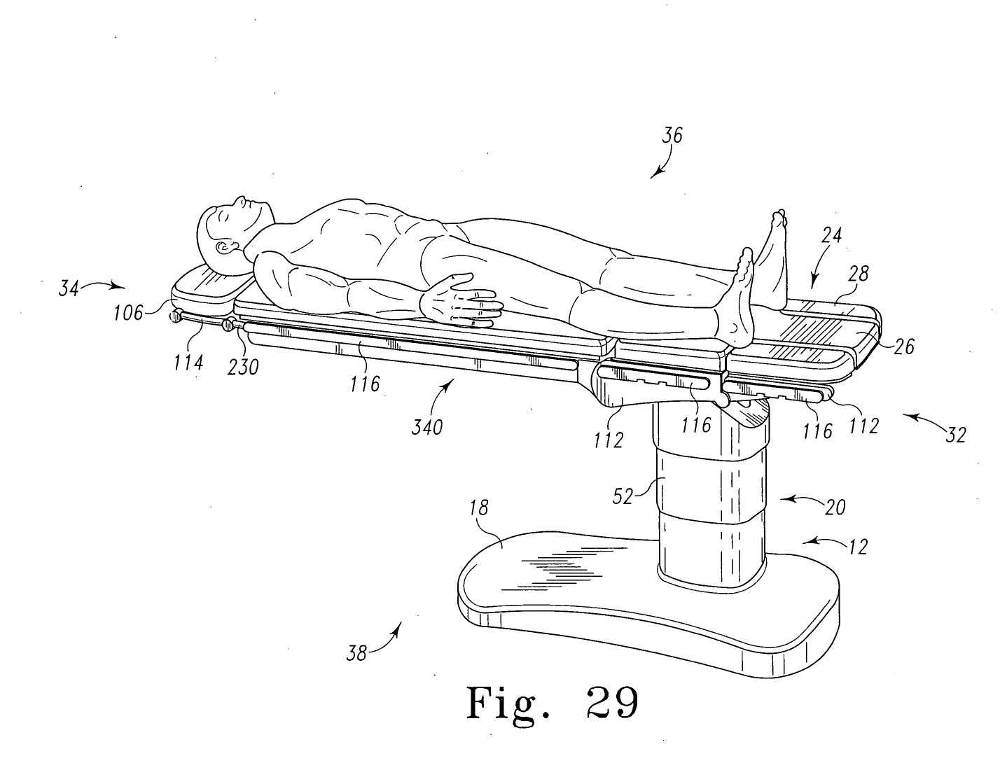

For spinal surgery, the traction boot assemblies 120 are detached from the surgical table 10, and the calf sections 104 are pivoted beneath the seat and thigh sections 90, 102 as shown in FIG. 26. The seat section 90, the thigh sections 102, the calf sections 104 (along with the countertraction post 94, the transverse bar 14 and the traction bar assemblies 16) are decoupled, as a module or unit, from powered pivot couplers 30 of the patient support deck 24. FIG. 27 shows the surgical table 10 after the seat, thigh, and calf sections 90, 102, 104 (along with the countertraction post 94, the transverse bar 14 and the traction bar assemblies 16) have been removed. A spinal surgery board or module 340 is then attached to the powered pivot couplers 30 of the surgical table 10 as shown in FIGS. 28 and 29. Thus, board 340 replaces sections 90, 102, 104 for spinal surgery. The spinal surgery board 340 includes an elongated frame 350, a pair of brackets 352 that are releasably attachable to couplers 30, an elongated mattress pad 354, a radiolvent panel (not shown) coupled to frame 350 to support mattress pad 354, and a pair of elongated accessory rails 116 coupled to the panel or to frame 350 on opposite sides of module. The head section 106 may be removed from the back section 24 and coupled to the spinal surgery module 340 as shown in FIG. 29. Thus, frame 350 has a pair of longitudinally extending, laterally spaced-apart sockets (not shown) that receive posts 230 of head section 106.

To recapitulate, the surgical table 10 is configurable for different types of orthopedic surgical procedures as well as being usable for general surgery. For example, for trauma surgery, the traction boot assemblies 120 are used to apply traction to a patient's legs as shown in FIGS. 17-19. For shoulder surgery, the back section 24 is articulated to a raised position as shown in FIG. 24, and one or both of the shoulder support portions 28 are pivoted away to expose the posterior portions of a patient's shoulders as shown in FIG. 25. For spinal surgery, the transverse bar 14, the traction bar assemblies 16 and any leg support section or surgery module coupled thereto are decoupled from the powered pivot couplers 30 as shown in FIGS. 26 and 27, and a spinal surgery board or module 340 is instead coupled to the powered pivot couplers 30 as shown in FIGS. 28 and 29.

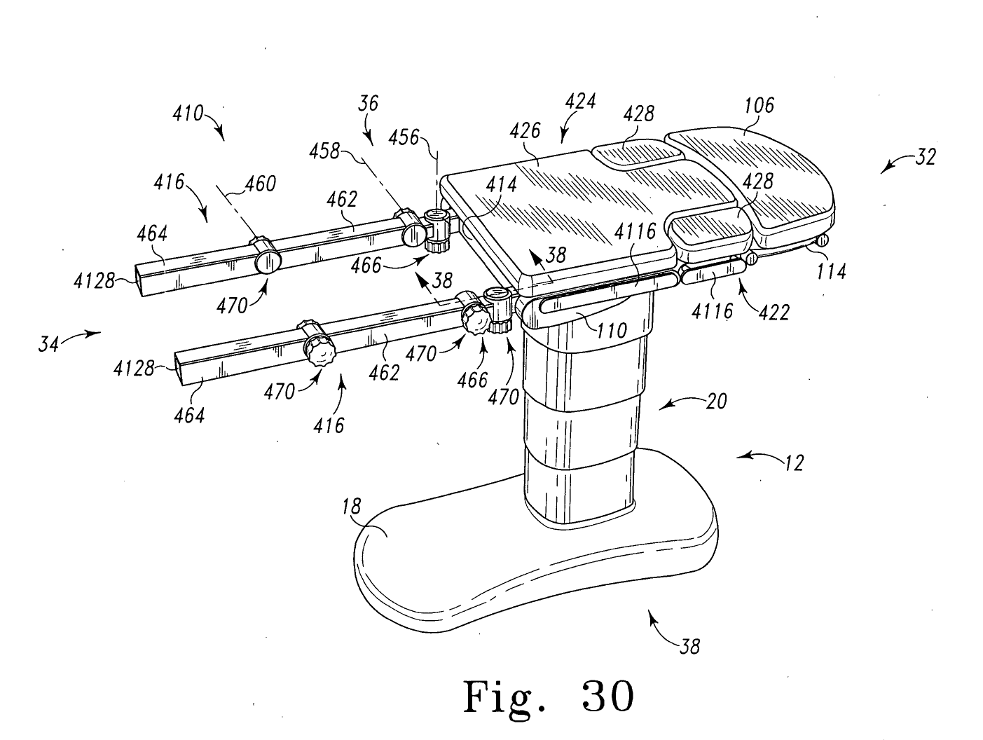

FIGS. 30-67 illustrate a second embodiment 410 of a surgical table according to this disclosure. As a general rule, the same components in the two surgical tables 10, 410 are identified in the description below using the same reference numerals. For example, both surgical tables 10 and 410 include the base 18, the vertical column 20, the head end 32 and the foot end 34. On the other hand, the components which are similar or perform similar functions in the two surgical tables 10, 410 bear the same reference numerals except that they are preceded by numeral “4” in the embodiment of FIGS. 30-67. For example, the traction bar assemblies are identified by numeral “16” in the embodiment of FIGS. 1-29, and identified by numeral “416” in the embodiment of FIGS. 30-67.

Although the two surgical tables 10, 410 are similar, there are some differences. For example, the surgical table 10 of FIGS. 1-29 includes powered pivot couplers 30, and the transverse bar 14 is removably coupled to the powered pivot couplers 30 as shown, for example, in FIG. 21. In contrast, the surgical table 410 of FIGS. 30-67 does not include powered pivot couplers 30, and the transverse bar 414 is instead fixedly attached to the frame members 110 of the back section 24 or formed integrally therewith.

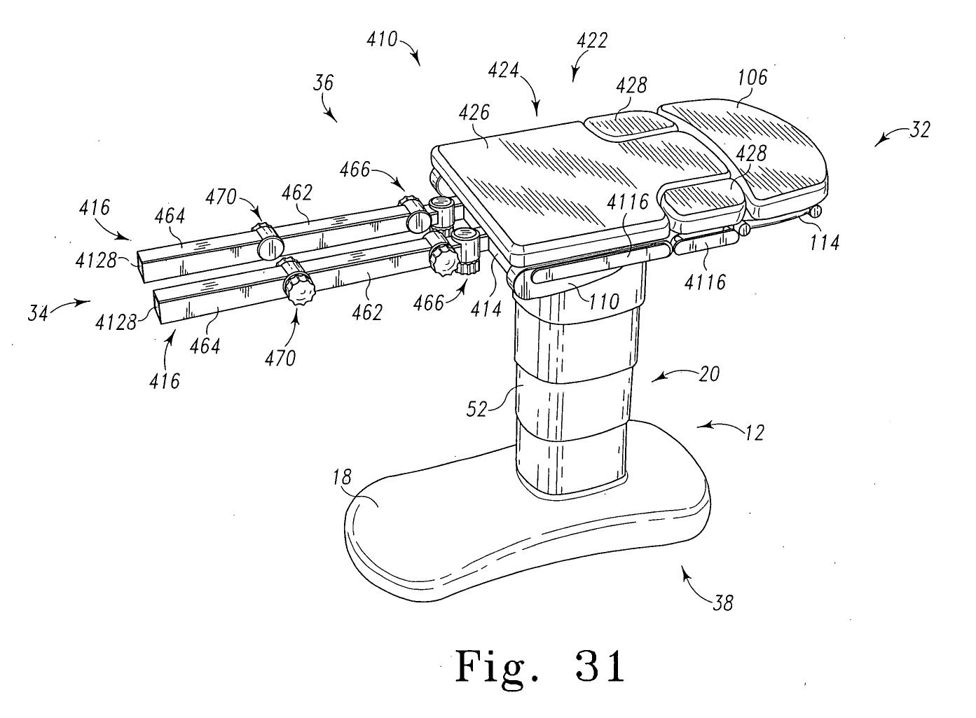

Referring to FIGS. 30-32, a pair of traction bar assemblies 416 are coupled to the transverse bar 414. Each traction bar assembly 416 is independently movable to any desired position along the transverse bar 414. For example, the traction bar assemblies 416 are movable from first positions coupled to lateral outer regions of the transverse bar 414 as shown in FIG. 30, to second positions coupled to a central region of the transverse bar 414 as shown in FIG. 31. When in desired positions, the traction bar assemblies 416 are locked in place on the transverse bar 414 using associated manual adjusters 470. The traction bar assemblies 416 of FIGS. 30-32 are similar to the traction bar assemblies 16 of FIGS. 1-3. However, in the first embodiment of FIGS. 1-29, the second traction bars 64 are situated laterally outboard of the associated first traction bars 62 as shown in FIGS. 1-3. In contrast, in the second embodiment of FIGS. 30-67, the second traction bars 464 are arranged in an in-line configuration with the associated first traction bars 462 as shown in FIGS. 30-32.

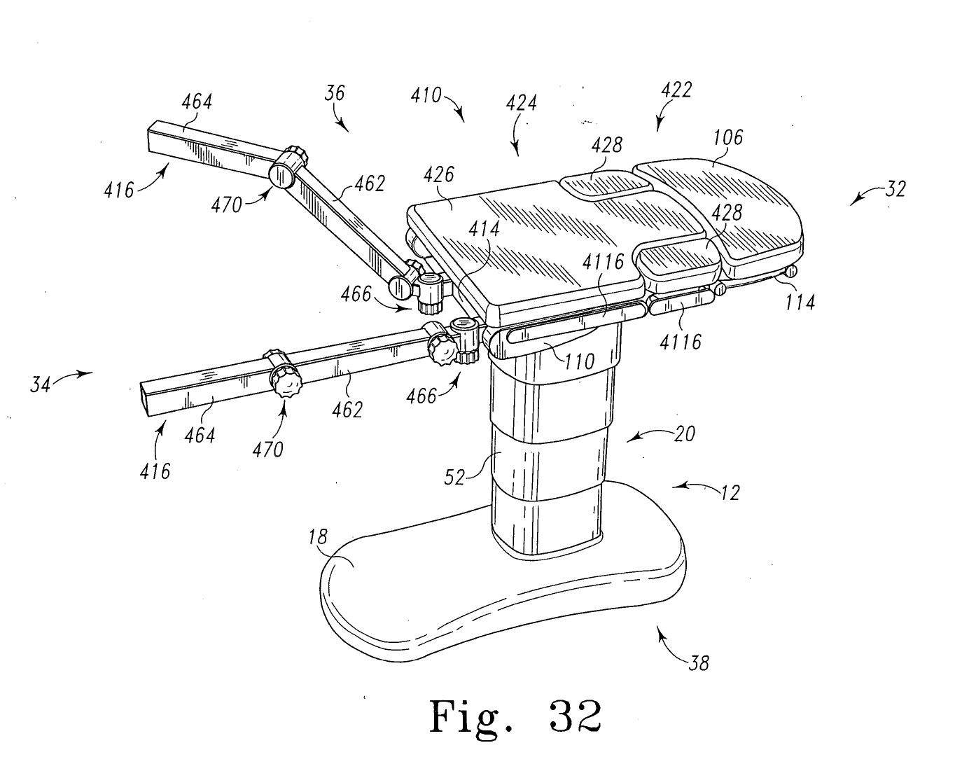

The traction bar assemblies 416 each include a first traction bar 462, a second traction bar 464 and a multi-joint coupler 466. The first traction bar 462 is coupled to the multi-joint coupler 466 for pivoting movement about a first pivot axis 456 and a second pivot axis 458 that, in the illustrative embodiment, is orthogonal to the first pivot axis 456. The second traction bar 464 is coupled to the first traction bar 462 for pivoting movement about a third pivot axis 460. Thus, the first and second traction bars 462, 464 are configured to articulate relative to the transverse bar 414 to a variety of articulated positions. For example, the traction bars 462, 464 are movable between a longitudinally extending in-line position shown in FIGS. 30 and 31, and an exemplary articulated position shown in FIG. 32. In the longitudinally extending in-line position shown in FIGS. 30 and 31, the traction bars 462, 464 are horizontal and extend parallel with the longitudinal axis 40 of the surgical table 410. In the exemplary articulated position shown in FIG. 32, the first traction bar 462 of the traction bar assembly 416 on the first side 36 is abducted outwardly and angled upwardly relative to the transverse bar 414 and the second traction bar 464 is angled slightly downwardly from the associated first traction bar 462. In the illustrative embodiment, the first pivot axis 456 is vertical and the second and third axes 458, 460 are horizontal when deck 422 is horizontal as shown, for example, in FIG. 30.

Each traction bar assembly 416 has manual adjusters 470 that are movable to loosen the connections between the first and second traction bars 462, 464, between the first traction bar 462 and the multi-joint coupler 466 and between the multi-joint coupler 466 and the transverse bar 414, thereby permitting articulation of the first and second traction bars 462, 464 relative to the transverse bar 414. Likewise, the manual adjusters 470 are movable to tighten the connections between the first and second traction bars 462, 464, between the first traction bar 462 and the multi-joint coupler 466 and between the multi-joint coupler 466 and the transverse bar 414, thereby locking the first and second bars 462, 464 in the desired positions relative to the transverse bar 414.

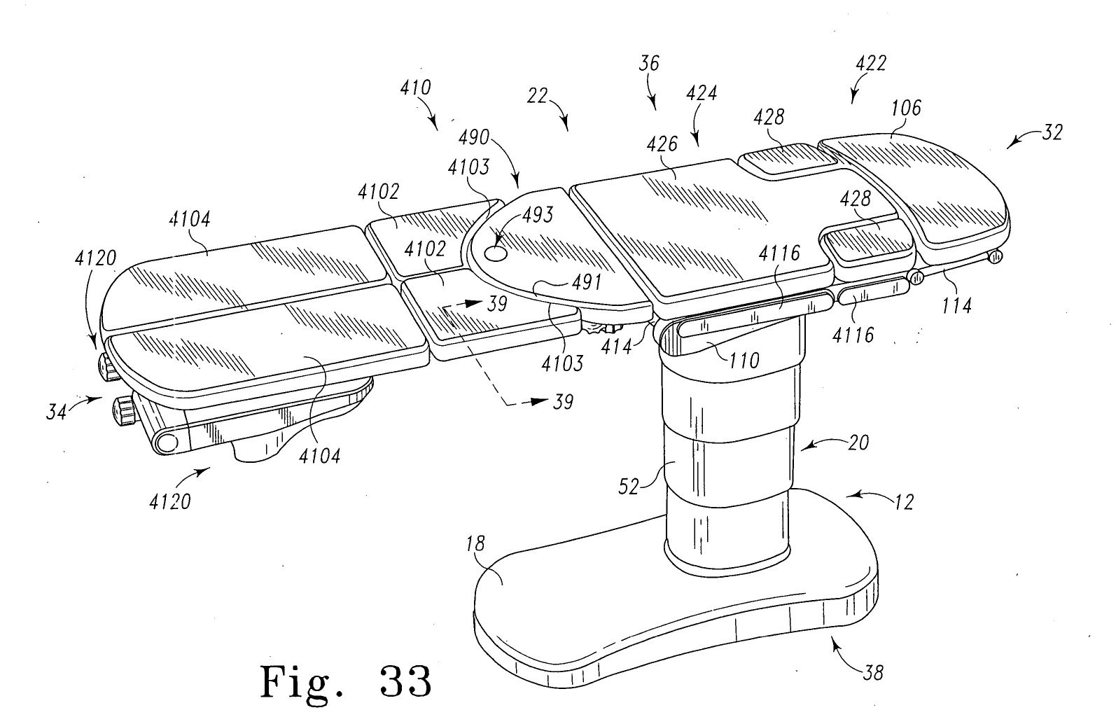

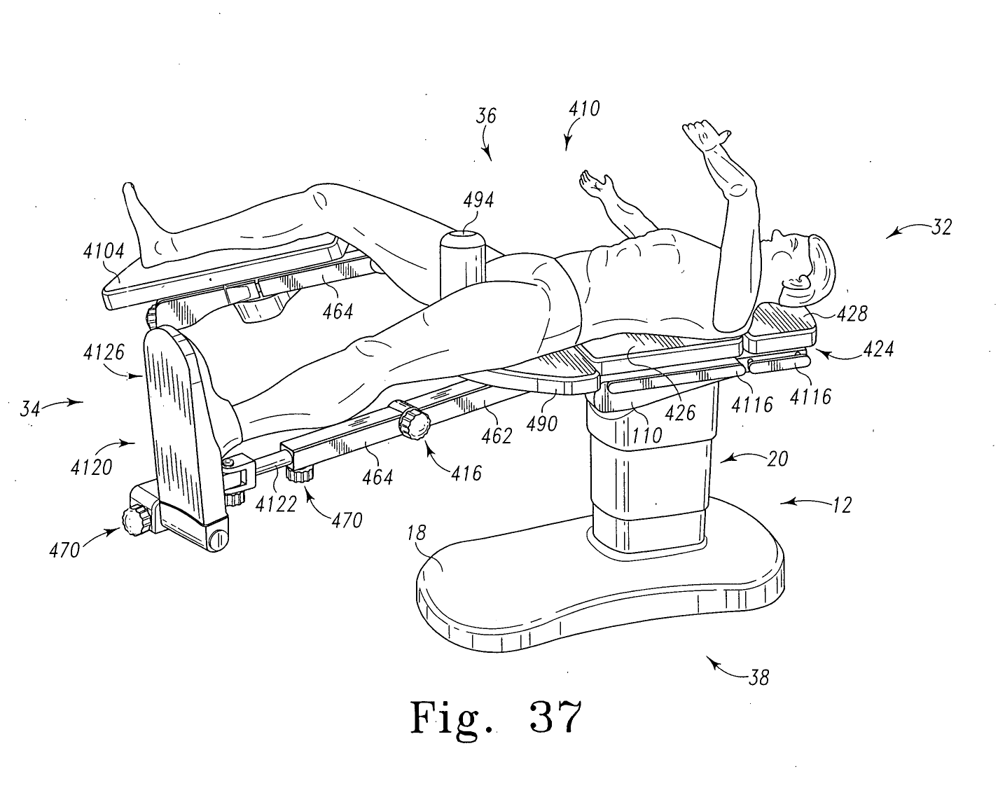

Various modules, deck sections, accessories, and the like are attachable to the base module 12 to configure the surgical table 410 for various types of surgeries, such as trauma, spinal and shoulder surgeries. Some of these modules, deck sections, etc. are coupled to the base module 12 by the traction bar assemblies 416. Some of these modules, deck sections, etc., on the other hand, are instead directly coupled to the transverse bar 414. For example, a seat section 490 of the patient support deck 422 is coupleable to the transverse bar 414 as shown in FIG. 33. A vertically-extending countertraction post 494 is coupleable to seat section 490 as shown in FIG. 37. The countertraction post 494 is removably received in vertical socket 493, shown in FIG. 33, formed in seat section 490. In some embodiments, the seat section 490 is instead coupled directly to the back section 24.

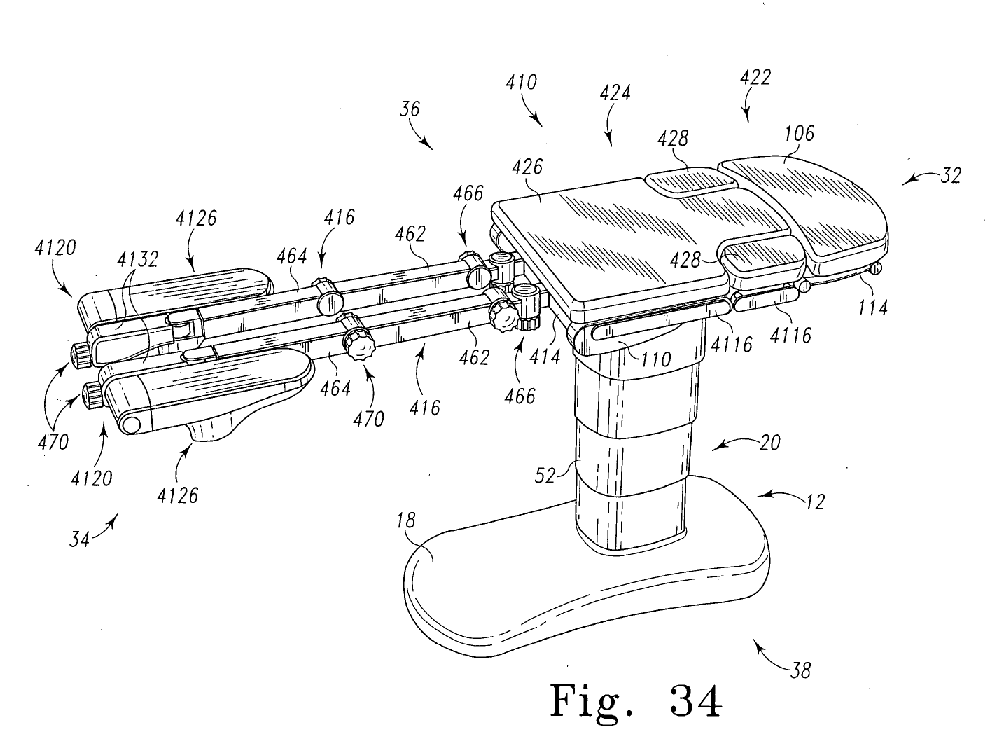

Other components that removably attach to the traction bar assemblies 416 include thigh sections 4102, calf sections 4104 and traction boot assemblies 4120 as shown in FIG. 33. The thigh sections 4102 attach to the respective first traction bars 462 of the traction bar assemblies 416 and, in the illustrative embodiment, have generally rounded, concave front edges 4103 that are complimentary in shape to a generally rounded, convex rear edge 491 of seat section 490. The complimentary shape of edges 491, 4103 permits abduction of sections 4102, 4104 relative to the seat section 490 while minimizing or reducing gap formation between the mattress pads of sections 490, 4102. The calf sections 4104 attach to respective second traction bars 464 and, in the illustrative embodiment, are generally rectangular in shape, although the foot ends 34 of the calf sections 4104 are slightly rounded to match the slight rounding of the head end 32 of head section 106. Traction boot assemblies 4120 also couple to the respective second traction bars 464. FIG. 33 shows the traction boot assemblies 4120 in their respective storage positions in which the traction boot assemblies 4120 are stowed under the associated calf sections 4104. FIG. 34 is a perspective view similar to FIG. 33 with the seat section 490 removed from the patient support deck 422, and the thigh and calf sections 4102, 4104 removed from the traction bar assemblies 416. Each of deck sections 490, 4102, 4104 comprises a mattress pad and a panel to which the associated mattress pad removably couples.

When the countertraction post 494 is removed from the seat section 490 and the traction boot assemblies 4120 are detached from the traction bar assemblies 416, the surgical table 410 may be used for general surgical procedures. The head section 106, the back section 424, the seat section 490, the thigh sections 4102 and the calf sections 4104 may be articulated to various positions and the entire deck 422 may be tilted to various inclinations to place the patient in desired positions for general surgical procedures. In the illustrative embodiment of the surgical table 410, the position of sections 106, 490, 4102, 4104 relative to the back section 424 are adjusted manually, whereas the position of the back section 424 relative to the vertical column 20 and the position of shoulder support portions 428 relative to back support portion 426 are adjusted by powered drive mechanisms such as hydraulic, electric, or pneumatic actuators.

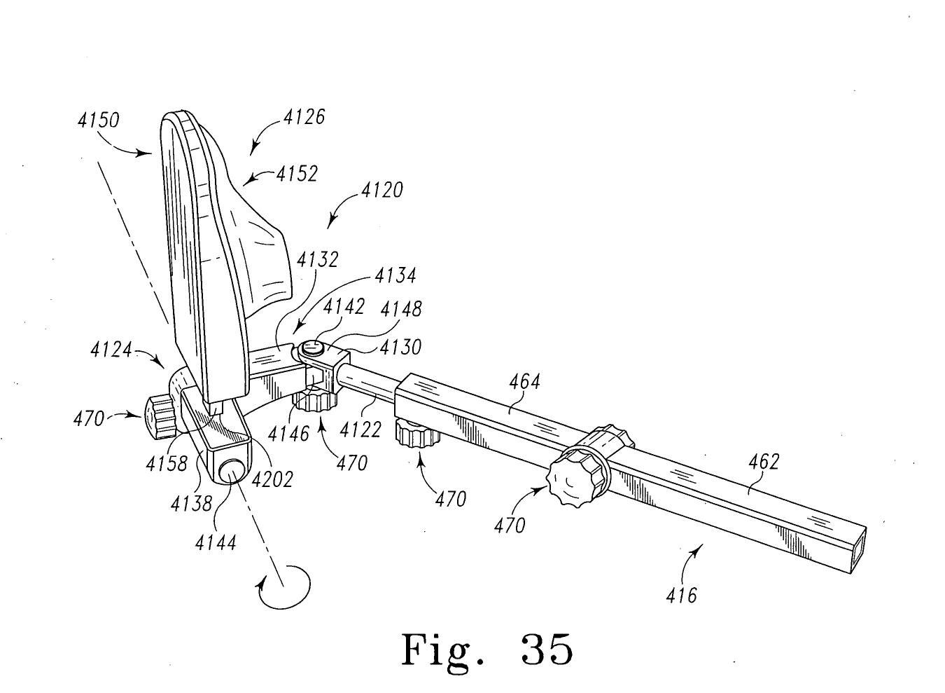

The following description of one of traction boot assemblies 4120 with reference to FIGS. 34-36 is applicable to both traction boot assemblies 4120 unless specifically noted otherwise. As shown in FIG. 35, the traction boot assembly 4120 comprises an elongated rod 4122, an adjustment assembly 4124 and a traction boot 4126. The second traction bar 464 of the traction bar assembly 416 is tubular, and has an open end 4128 as shown, for example, in FIG. 30. A proximal end of the elongated rod 4122 is inserted into the second traction bar 464 through the open end 4128 to couple the traction boot assembly 4120 to the traction bar assembly 416. The elongated rod 4122 is received in the second traction bar 464 for axial telescopic movement between a retracted position and an extended position. Rod 4122 is round in cross section and is rotatable about its long axis relative to bar 464. The traction boot assembly 4120 includes a manual adjuster 470 that, when rotated in a first direction, locks the traction boot assembly 4120 relative to the second traction bar 464, and that, when rotated in a second opposite direction, allows the traction boot assembly 4120 to be adjusted relative to the second traction bar 464.

The adjustment assembly 4124 comprises a bracket 4130 mounted to a distal end of the elongated rod 4122, a housing 4132 and a joint 4134 that couples the housing 4132 to the bracket 4130 for pivoting movement about a pivot pin 4142. The housing 4132 includes a cantilevered portion 4146 and the bracket 4130 includes a pair of spaced-apart flange portions 4148 that define a cantilevered portion-receiving space in which a proximal end of the cantilevered portion 4146 is received for rotation about the pin 4142. The adjustment assembly 4124 further comprises a manual adjuster 470 that, when rotated in a first direction, tightens the joint 4134 to prevent the housing 4132 from pivoting relative to the bracket 4130 and that, when rotated in a second opposite direction, loosens the joint 4134 to allow the housing 4132 to pivot relative to the bracket 4130 about the pin 4142 as shown, for example, in FIG. 35.

The adjustment assembly 4124 includes a cantilevered shaft 4144 rotatably mounted to the housing 4132 and a body 4138 coupled to the shaft 4144 for rotation therewith. The traction boot 4126 is configured to couple to the body 4138 as shown in FIG. 35. The adjustment assembly 4124 further includes a manual adjuster 470 that, when rotated in a first direction, prevents the shaft 4144 (along with the body 4138 and the traction boot 4126 secured thereto) from pivoting relative to the housing 4132 and that, when rotated in a second opposite direction, allows the shaft 4144 (along with the body 4138 and the traction boot 4126 secured thereto) to pivot relative to the housing 4132.

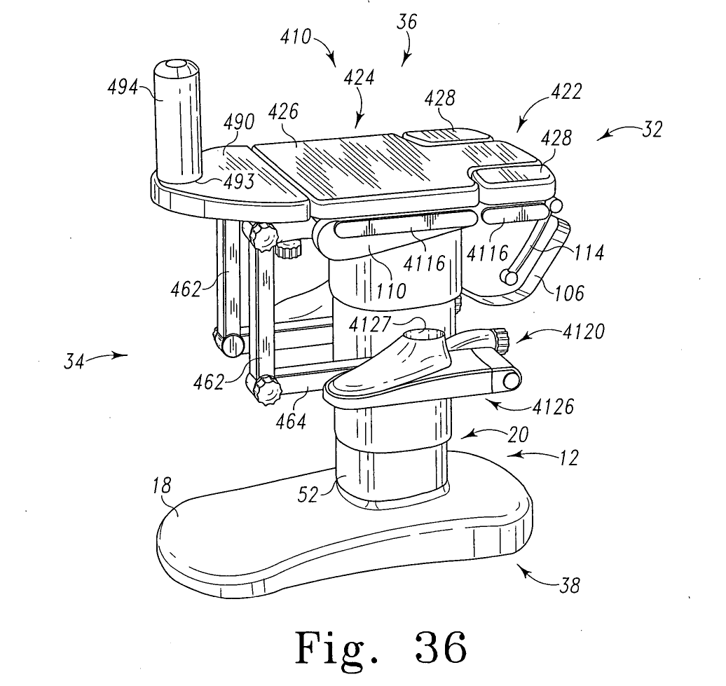

The traction boot 4126 is configured to couple to a patient's foot as shown, for example, in FIG. 37. Referring back to FIG. 35, the illustrative traction boot 4126 has a first portion 4150 and a second portion 4152 coupled to the first portion 4150. A square-shaped post 4158 extends from body 4138 into a heel portion of the first portion 4150. The body 4138 and the first portion 4150 each have a square-shaped opening 4202, and the square-shaped post 4158 is inserted into the openings 4202 to couple the traction boot 4126 to the body 4138. The edges of the body 4138 and the first portion 4150 that define the square-shaped openings 4202 are in close proximity to the outer side surfaces of the square-shaped post 4158 to prevent rotation of the traction boot 4126 relative to the body 4138 when the traction boot 4126 is coupled to the body 4138. However, boot 4126 is movable relative to body 4138 along post 4158 and is lockable on post 4158 with suitable locking mechanisms (not shown). The first portion 4150 is configured to engage the sole of a patient's foot. The second portion 4152 is configured to engage the top of the patient's foot and the patient's heel. The second portion 4152 includes an opening 4127 through which a patient's foot is inserted into the traction boot 4126 as shown in FIG. 36.

FIG. 34 shows a compact storage configuration of the traction boot assemblies 4120. As shown therein, the first and second traction bars 462, 464 of the two traction bar assemblies 416 are disposed in their respective in-line configurations, the housing 4132 is pivoted to a position where the housing 4132 is aligned with the first and second traction bars 462, 464, and the traction boot 4126 is pivoted to a position having the long dimension of the traction boot 4126 parallel with the long dimension of the housing 4132 and having the toe region of the traction boot 4126 pointed toward the head end 32 of the surgical table 410. In this position, the traction boots 4126 hang upside down and are situated beneath the associated calf sections 4104 as shown in FIG. 33. FIG. 36 shows a compact storage configuration of table 410. As shown therein, the traction bar assemblies 416 are articulated to a position in which the traction boot assemblies 4120 are situated beneath the back section 24 of the deck 422. The head section 106 is likewise pivoted to a position beneath the back section 24. In the storage configuration of table 410, bars 462 extend vertically beneath seat section 490 and bars 464 extend horizontally beneath back section 24.

To move the traction boot assembly 4120 from the storage position shown in FIG. 34 to an exemplary use position shown in FIG. 37, the first and second traction bars 462, 464 are moved to their respective in-line configurations, the elongated rod 4122 is moved from the retracted position to a desired extended position, the housing 4132 is pivoted to a position where the housing 4132 is aligned with the first and second traction bars 462, 464, and the traction boot 4126 is pivoted from the storage position shown in FIG. 34 to the use position shown in FIG. 37. In the use position, the associated manual adjusters 470 are used to lock the elongated rod 4122 relative to the second traction bar 464, to lock the housing 4132 relative to the elongated rod 4122 and to lock the traction boot 4126 relative to the housing 4132. To move the traction boot assembly 4120 back to the storage position shown in FIG. 34, the associated manual adjusters 470 are loosened and the above sequence of steps is reversed. FIG. 37 shows the traction bar assembly 416 associated with the patient's right leg articulated so that the respective calf section 4104 supports the patient's right leg in an elevated position, and shows the traction boot assembly 4120 associated with the patient's left leg applying unilateral hip traction to the patient supported on the surgical table 410 in a manner similar to FIG. 18. The traction boot assemblies 4120 can also be used for applying bilateral hip traction and lateral intramedullary nailing procedure in the manner shown in FIGS. 17 and 19. It should be appreciated, therefore, that traction boot assemblies 4120 are movable to and lockable in countless use positions, as desired.

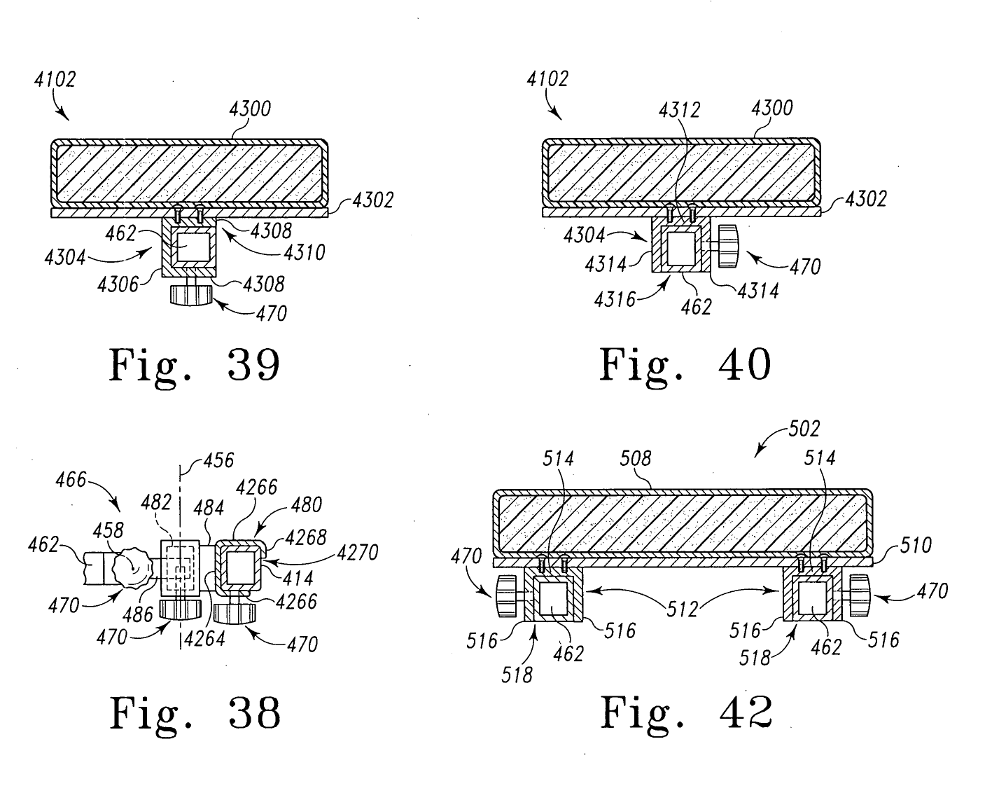

As shown in FIG. 38, each multi-joint coupler 466 comprises a bracket 480 that removably couples to the transverse bar 414, a cylinder 482, a block 484 that interconnects the bracket 480 and the cylinder 482 and a clevis 486 that is rotatably coupled to the cylinder 482 for rotation about a first pivot axis 456, which, in the illustrated embodiment, is vertical. Each clevis 486 has a pair of flange portions that define a bar-receiving space which receives a proximal end of the associated first traction bar 462 for rotation about a second pivot axis 458, which, in the illustrated embodiment, is horizontal. The bracket 480 of each traction bar assembly 416 includes a main body portion 4264 that is attached to the block 484 of the multi-joint coupler 466, top and bottom flange portions 4266 that extend forwardly from the ends of the main body portion 4264 and a catch portion 4268 that extends downwardly from the end of the top flange portion 4266 to wrap around the transverse bar 414 as shown in FIG. 38. The main body portion 4264, the top and bottom flange portions 4266 and the downwardly-extending catch portion 4268 of each bracket 480 define a bar-receiving space 4270 in which the transverse bar 414 is received, thereby permitting lateral movement of the traction bar assemblies 416 relative to the transverse bar 414. In alternative embodiments, a tubular bracket replaces bracket 480 to permanently couple traction bar assemblies 416 to transverse bar 414. Such a tubular bracket extends all the way around bar 414 with a minimal amount of clearance therebetween.

A manual adjuster 470 is movable to loosen the connection between each bracket 480 and the transverse bar 414 to allow lateral shifting of the associated traction bar assembly 416 along the bar 414, and is movable to tighten the connection between the bracket 480 and the transverse bar 414 to lock the associated traction bar assembly 416 in place on the bar 414. Another manual adjuster 470 is movable to loosen the connection between each clevis 486 and the associated cylinder 482 to allow rotation of the respective traction bar assembly 416 about the first pivot axis 456, and is movable to tighten the connection between the clevis 486 and the associated cylinder 482 to prevent rotation of the respective traction bar assembly 416 about the first pivot axis 456. Still another manual adjuster 470 is movable to loosen the connection between each clevis 486 and the associated first traction bar 462 to allow rotation of the associated first traction bar 462 about the second pivot axis 458, and is movable to tighten the connection between the clevis 486 and the associated first traction bar 462 to prevent rotation of the associated first traction bar 462 about the second pivot axis 458. In the illustrated embodiment, as previously indicated, the first pivot axis 456 is vertical and the second pivot axis 458 is horizontal when back section 24 is horizontal

Each thigh section 4102 includes a mattress pad 4300 and a panel 4302 to which the mattress pad 4300 removably attaches as shown in FIG. 39. One or more brackets 4304 are attached to the underside of the panel 4302 by any suitable means, such as a pair of threaded bolts or studs as shown. Each bracket 4304 includes a first portion 4306 and top and bottom flange portions 4308 that extend laterally outwardly from the ends of the first portion 4306 to define a bar-receiving space 4310 in which the associated first traction bar 462 is received. The top flange portion 4308 is secured to the underside of the thigh section panel 4302 by threaded bolts or studs. A manual adjuster 470 is movable to loosen the connection between each bracket 4304 and the associated first traction bar 462 to allow removal of the respective thigh section 4102 from the bar 462. Likewise, the manual adjuster 470 is movable to tighten the connections between each bracket 4304 and the associated first traction bar 462 to lock the respective thigh section 4102 in place on the bar 462.

FIG. 40 shows an alternative construction of the bracket 4304 for coupling the thigh section 4102 to the associated first traction bar 462. The alternative bracket includes a first portion 4312 and first and second sidewall portions 4134 that extend downwardly from the ends of the first portion 4312 to define a bar-receiving space 4316 in which the associated first traction bar 462 is received. The first portion 4312 is secured to the underside of the thigh section panel 4302 by threaded bolts or studs. A manual adjuster 470 is coupled to the outer one of portions 4314. The manual adjuster 470 is loosened to allow removal of the respective thigh section 4102 from the first traction bar 462, and is tightened to lock the respective thigh section 4102 in place on the first traction bar 462. Bracket 4304 of FIG. 39 is oriented for horizontal attachment and removal of the thigh section 4102 relative to the respective first traction bar 462, whereas bracket 4304 of FIG. 40 is oriented for vertical attachment and removal of the thigh section 4102 relative to the respective first traction bar 462. The calf sections 4104 are likewise coupled to the associated second traction bars 464 in a manner similar to the way in which the thigh sections 4102 are coupled to the first traction bars 462 as shown, for example, in FIGS. 39 and 40.

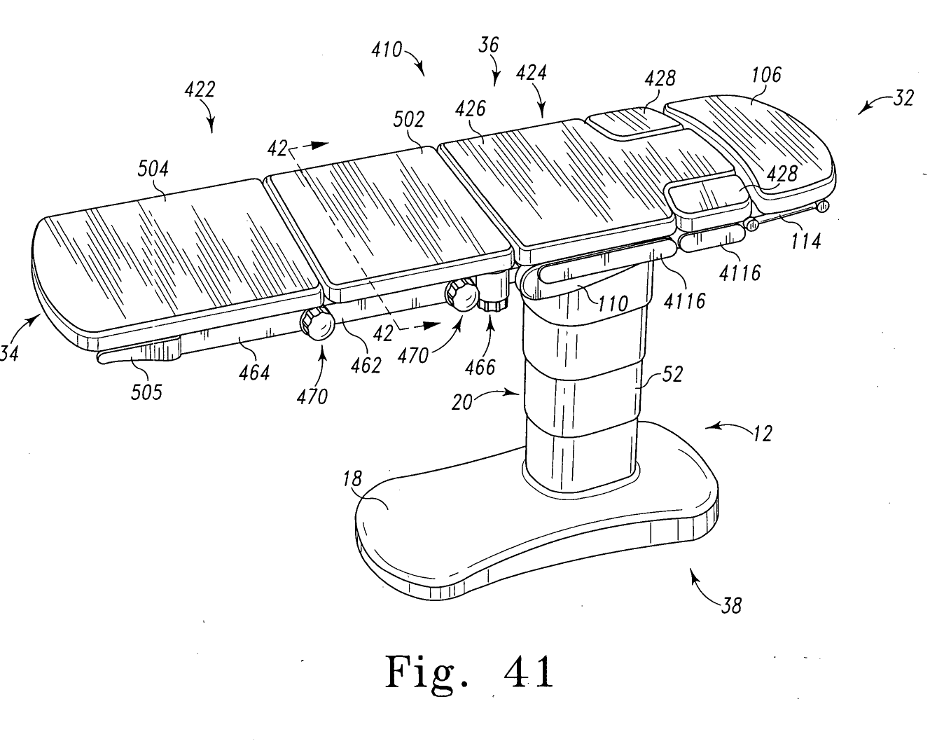

For spinal surgery, the seat section 490, the thigh sections 4102, the calf sections 4104 and the traction boot assemblies 4120 are all detached from the surgical table 410, and first and second spinal surgery sections 502, 504 are instead attached to the surgical table 410 as shown in FIG. 41. The configuration of table 410 in FIG. 41 may also be used for general surgery, if desired. The first spinal surgery section 502 is attached to the pair of first traction bars 462 as shown in FIG. 42, and the second spinal surgery section 504 may also be attached to the pair of second traction bars 464 in a manner similar to that shown in FIG. 42. However, because section 504 is longer than the second traction bars 464, section 504 has a pair of laterally-spaced extension members 505 that are situated adjacent the open ends 4128 of the second traction bars 464 when section 504 is coupled to the second traction bars 464. Thus, in alternative embodiments, posts (not shown) extend longitudinally from extension members 505 in a cantilevered manner, and are inserted through open ends 4128 of respective second traction bars 464 to couple the second spinal surgery section 504 to second traction bars 464.

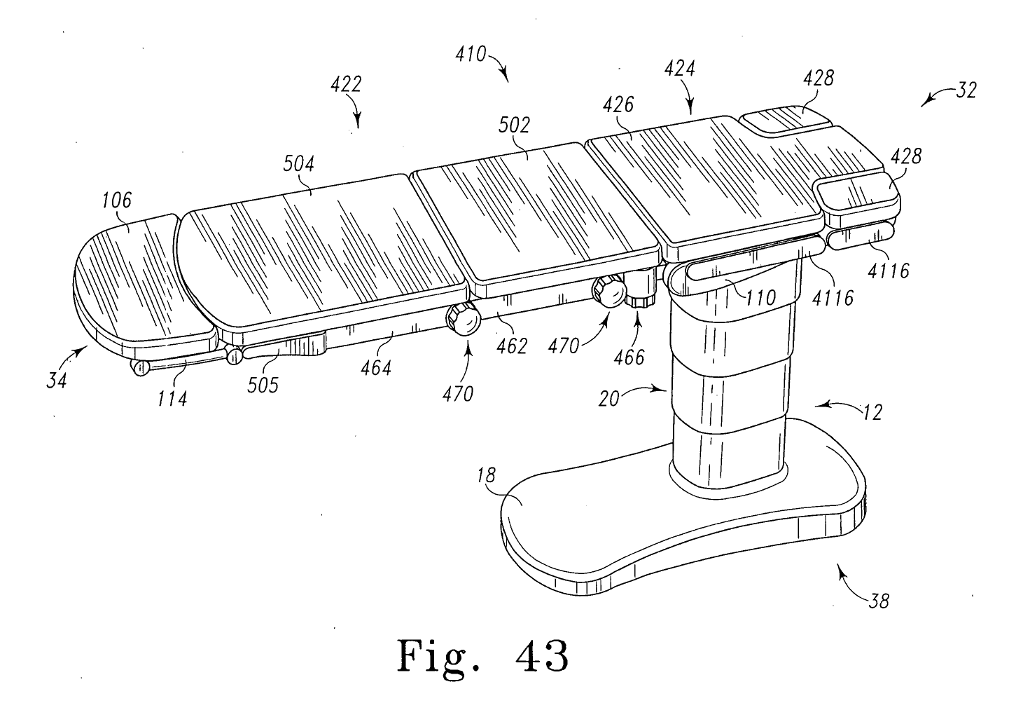

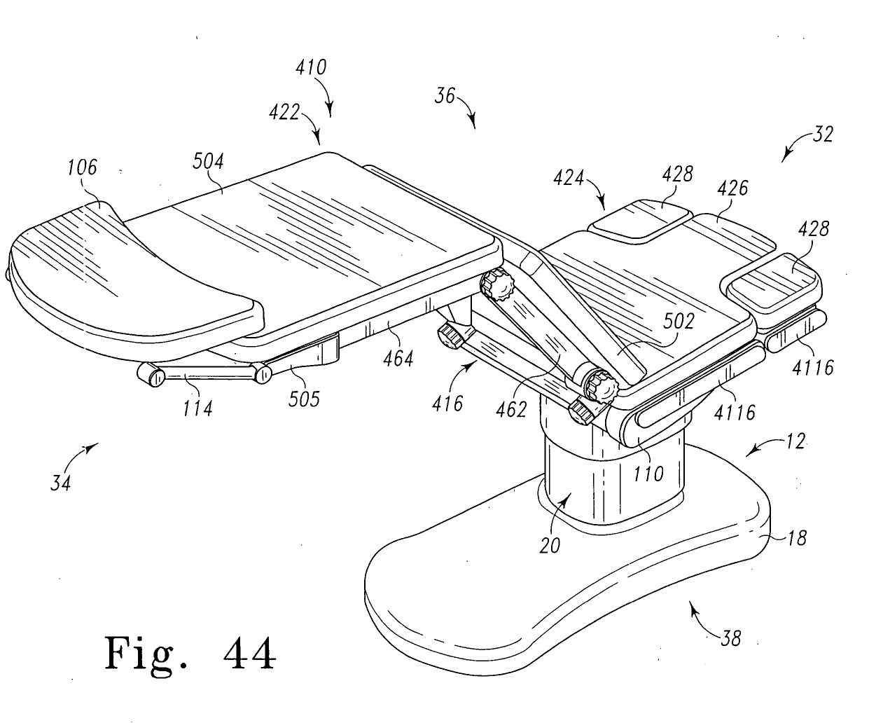

After sections 502, 504 are coupled to bars 462, 464, respectively, the head section 106 is removed from the back section 424 and instead coupled to the pair of extension members 505 which are situated near the foot end 34 as shown in FIG. 43. To this end, a pair of laterally-spaced sockets (not shown) are formed in extension members 505 and the laterally-spaced posts 230 of the head section 106 are configured for reception in the laterally-spaced sockets. The pivotally-mounted frame members 114 interconnecting the head section 106 with the laterally-spaced posts 230 allow the caregiver to adjust the position of the head section 106 relative to the second spinal surgery section 504, and then lock it in place. For example, the head section 106 may be moved to a position slightly higher in elevation than the second spinal surgery section 504 as shown in FIG. 44 and locked in place.

The first spinal surgery section 502 includes a mattress pad 508 and a panel 510 to which the mattress pad 508 removably attaches as shown in FIG. 42. A pair of brackets 512 are attached to the underside of the panel 510 by any suitable means, such as a pair of threaded bolts as shown. Each bracket 512 includes a first portion 514 and first and second sidewall portions 516 that extend downwardly from the ends of the first portion 514 to define a bar-receiving space 518 in which the associated first traction bar 462 is received. The first portion 514 of each bracket 512 is secured to the underside of the panel 510 by the threaded bolts. A manual adjuster 470 is coupled to an outer sidewall portion 516 of each bracket 512 as shown. The manual adjusters 470 are loosened to allow removal of the associated first spinal surgery section 502 from the first traction bars 462, and is tightened to lock the associated first spinal surgery section 502 in place on the first traction bars 462.

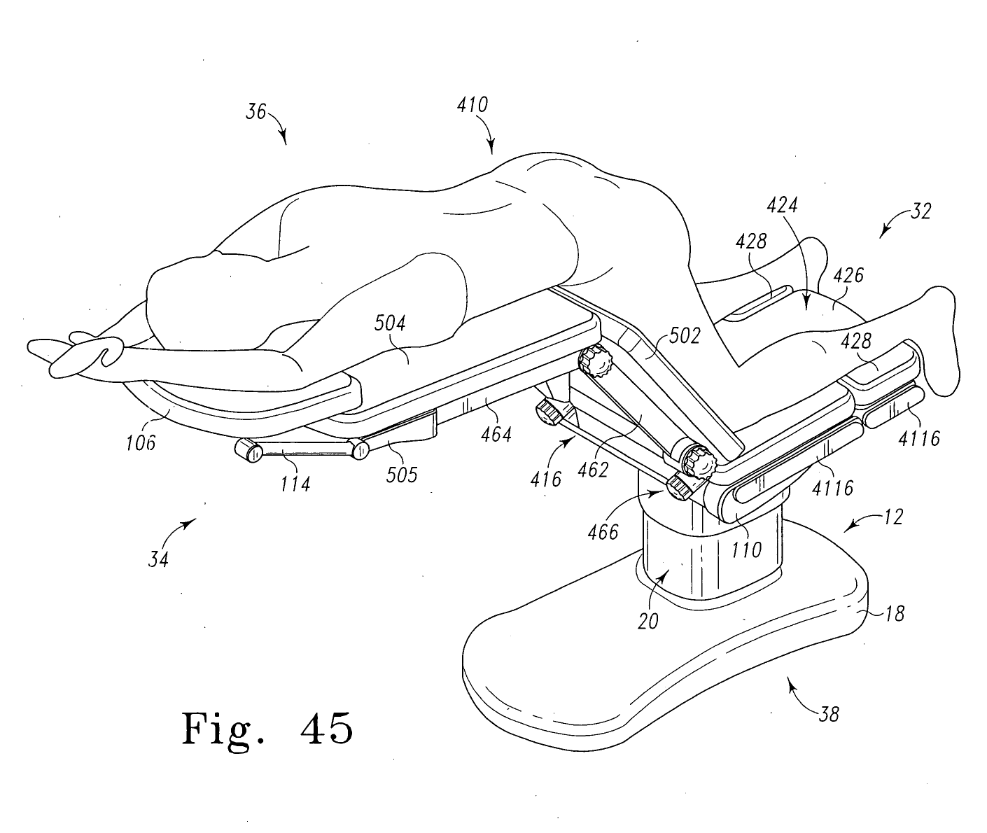

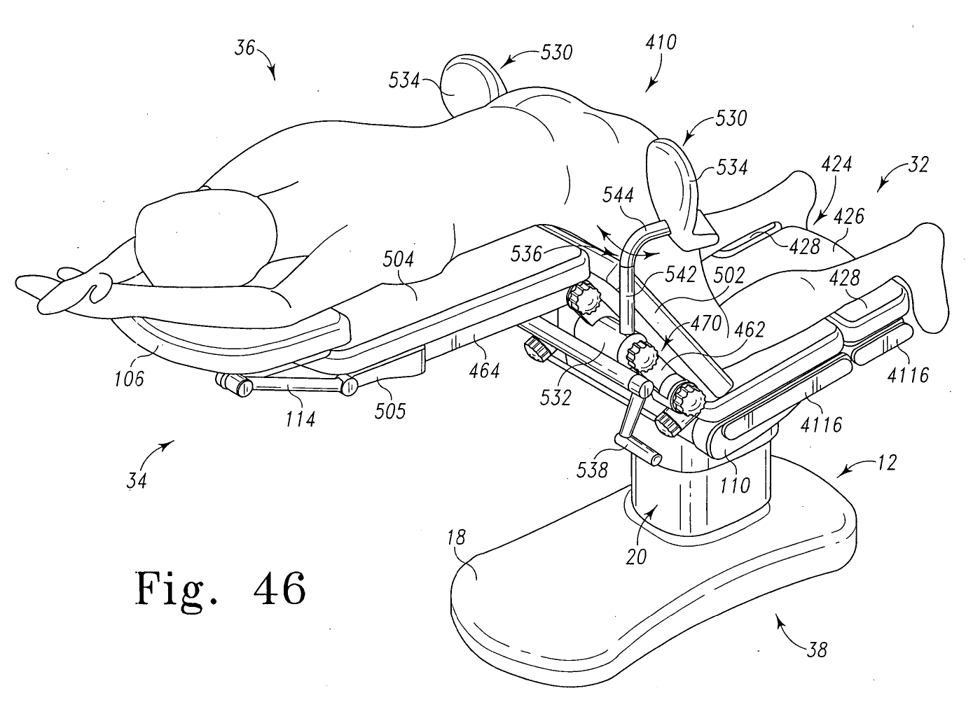

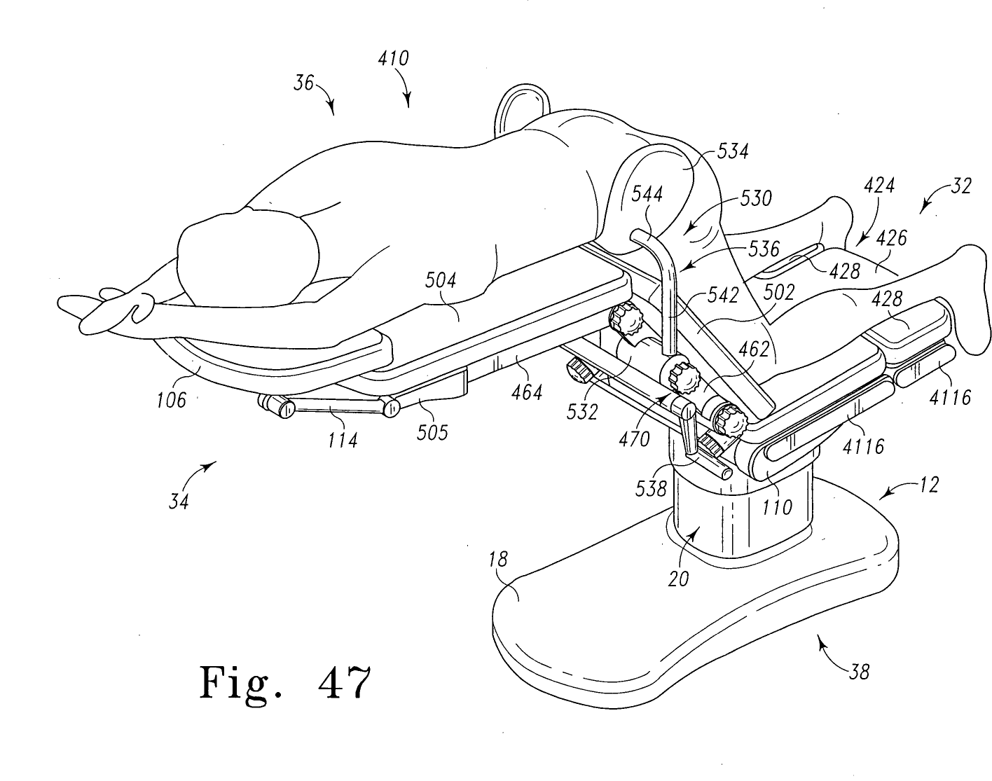

In one configuration of the surgical table 410, the traction bar assemblies 416 are articulated to a position having the first spinal surgery section 502 angling upwardly relative to the back section 24 and having the second spinal surgery section 504 extending horizontally from the first spinal surgery section 502 as shown in FIG. 44. The head section 106 is moved to a position slightly higher in elevation than the second spinal surgery section 504. A patient is supported on the deck 22 in a kneeling, face-down position for spinal surgery as shown in FIG. 45. In some embodiments, a hip lift 530 is coupled to the pair of first traction bars 462 beneath the first spinal surgery section 502 as shown in FIG. 46. The hip lift 530 includes a pair of bodies 532 that couple to respective first traction bars 462, a pair of hip pads 534 that are configured to engage the patient's hips as shown in FIG. 47, a pair of mounting rods 536 coupled to the associated hip pad 534 and coupled to the associated body 532 and a crank 538 that is rotatable about a pivot axis.

The mounting rods 536 each include a first portion 542 that is coupled to the associated body 532 and a swingable offset portion 544 that is coupled to the associated hip pad 534. Portions 544 are rotatable relative to portions 542 to swing hip pads 534 into (and out of) engagement with the patient's hips. The hip lift 530 includes a pair of manual adjusters 470 that can be loosened to allow removal of the hip lift 530, and that can be tightened to secure the hip lift 530 to the first traction bars 462. The crank 538 can be rotatably operated to lift (or lower) the rods 536 and hip pads 534 to, in turn, increase (or decrease) the amount of arch in the patient's spine as shown in FIG. 47. Thus, suitable mechanisms, such as rollers that frictionally engage portions 542 of rods 536 or gears that engage teeth formed in or coupled to portions 542 of rods 536, are housed in bodies 532 and are actuated by rotation of crank 538.

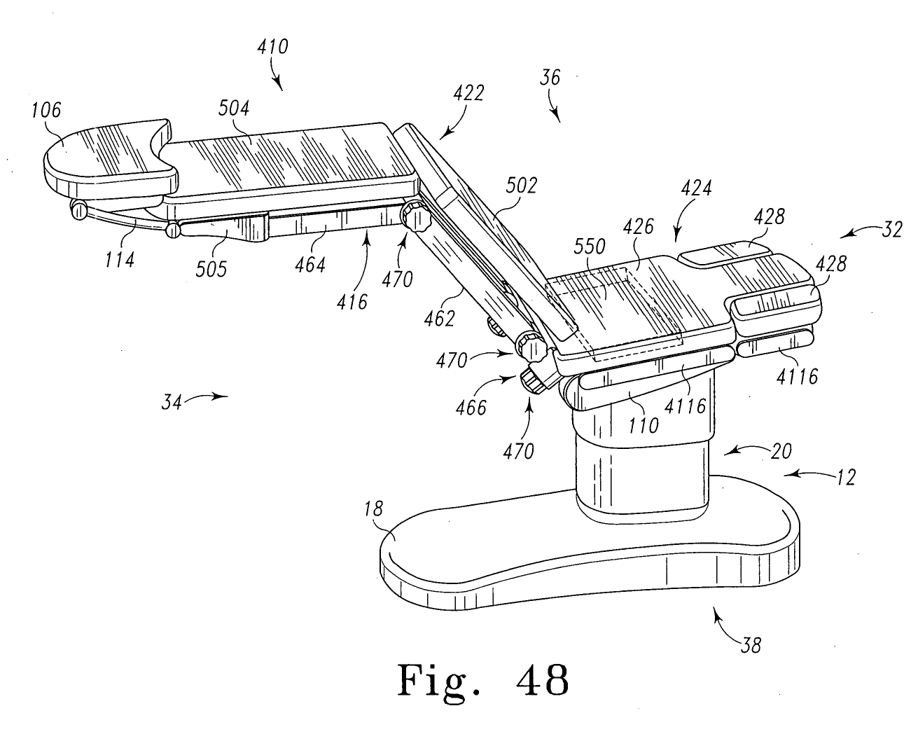

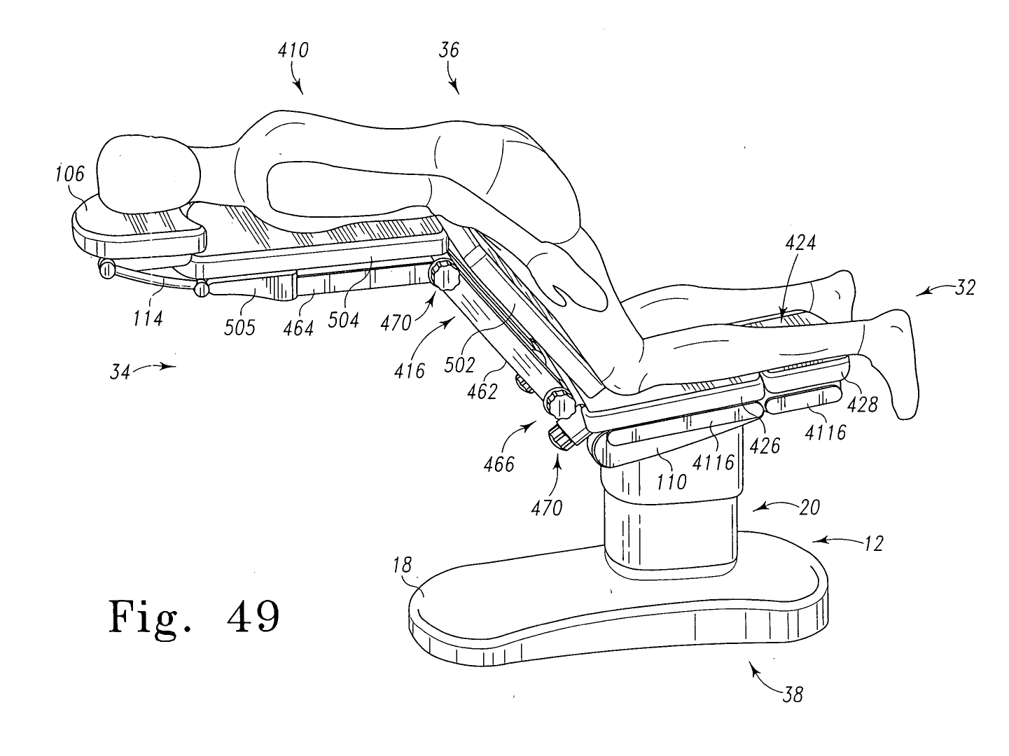

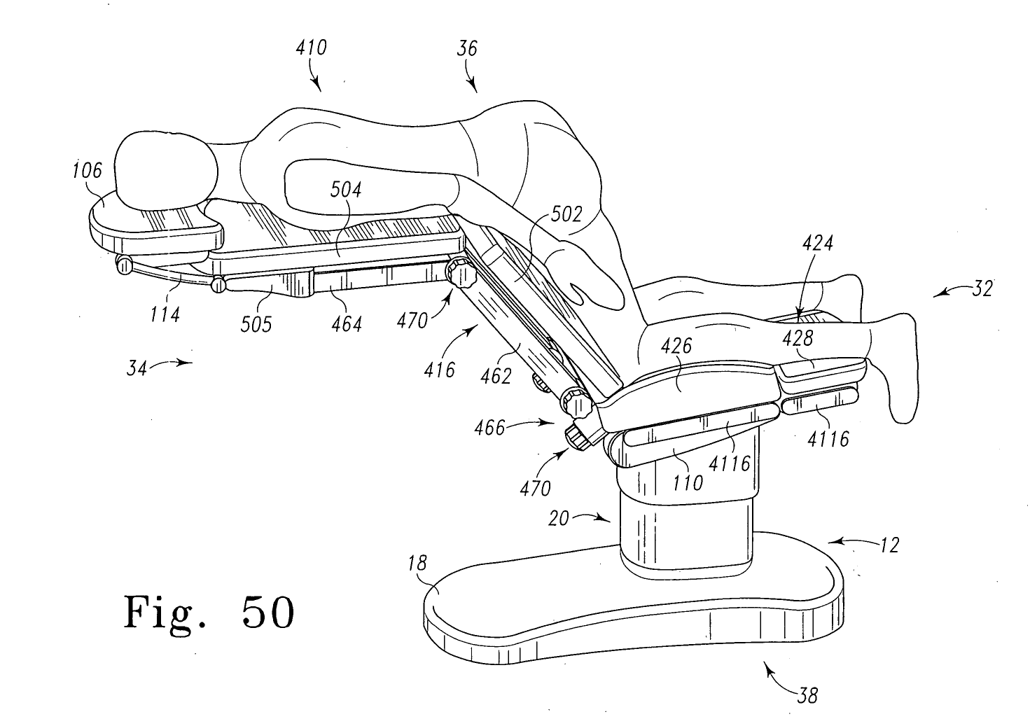

In some embodiments, the back section 24 includes an internal air bladder 550 as shown in phantom in FIG. 48. FIG. 49 shows a patient supported in a kneeling, face-down position on the deck 22 with the air bladder 550 deflated beneath the patient's knees. FIG. 50 shows the air bladder 550 inflated to raise the patient's knees to increase arching of the patient's spine. Thus, a suitable pneumatic system (for example, pump, manifold, valves, pressure sensors, hoses, and the like) is housed in base 18 and/or column 20 and/or patient support deck 422 and is operable to inflate and deflate bladder 550.

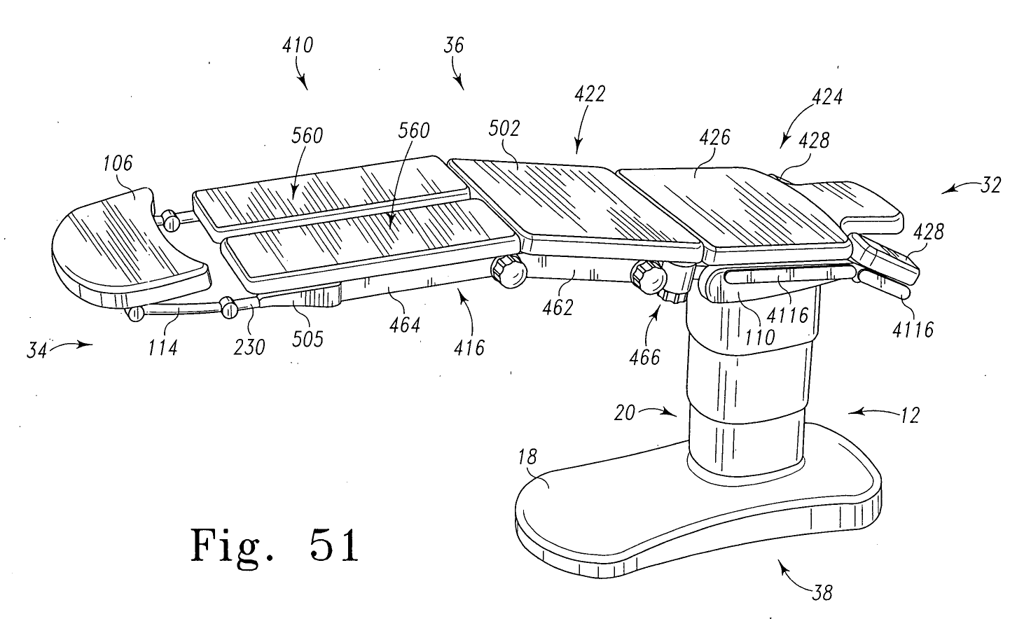

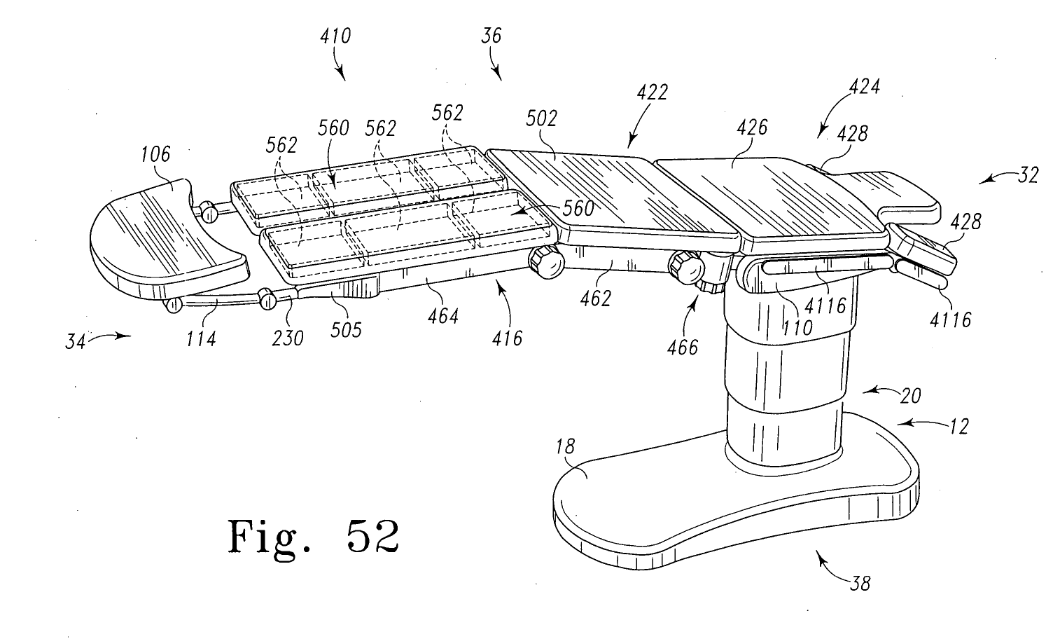

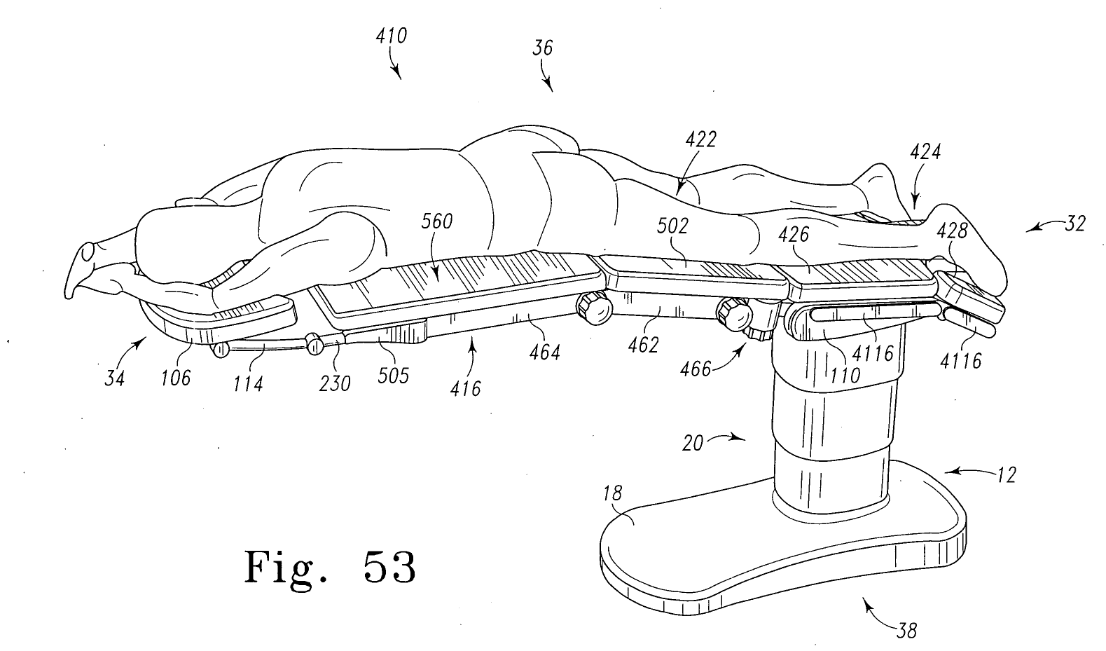

In some embodiments, the second spinal surgery section 504 is removed from the pair of second traction bars 464, and replaced with a pair of rectangular side-by-side spinal surgery sections 560 that are coupled to the associated second traction bars 464 between the head section 106 and the first spinal surgery section 502 as shown in FIG. 51. In some embodiments, sections 560 couple to bars 464 via brackets similar to brackets 512 shown in FIG. 42 and in other embodiments, sections 560 couple to bars 464 via posts (not shown) that extend from respective extension members 505 of sections 560 into open ends 4128 of associated bars 464. Each of the side-by-side spinal surgery sections 560 includes a set of three internal air bladders 562 as shown in phantom in FIG. 52. FIG. 53 shows a patient lying on the deck 22 in a face-down position with the air bladders 562 deflated beneath the patient's torso.

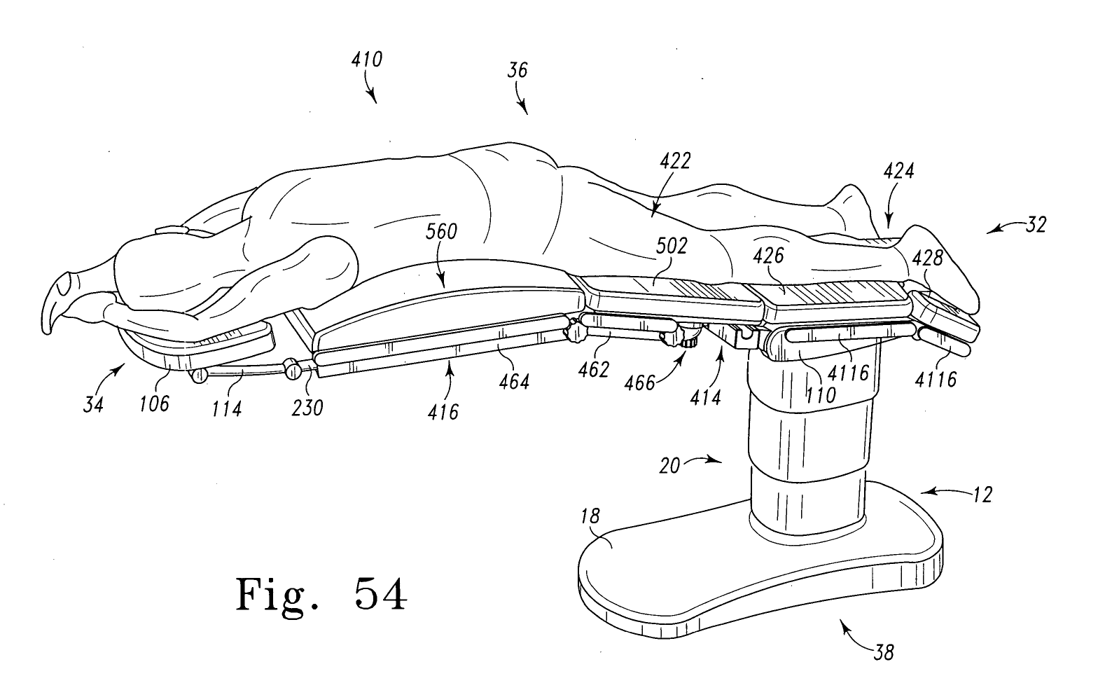

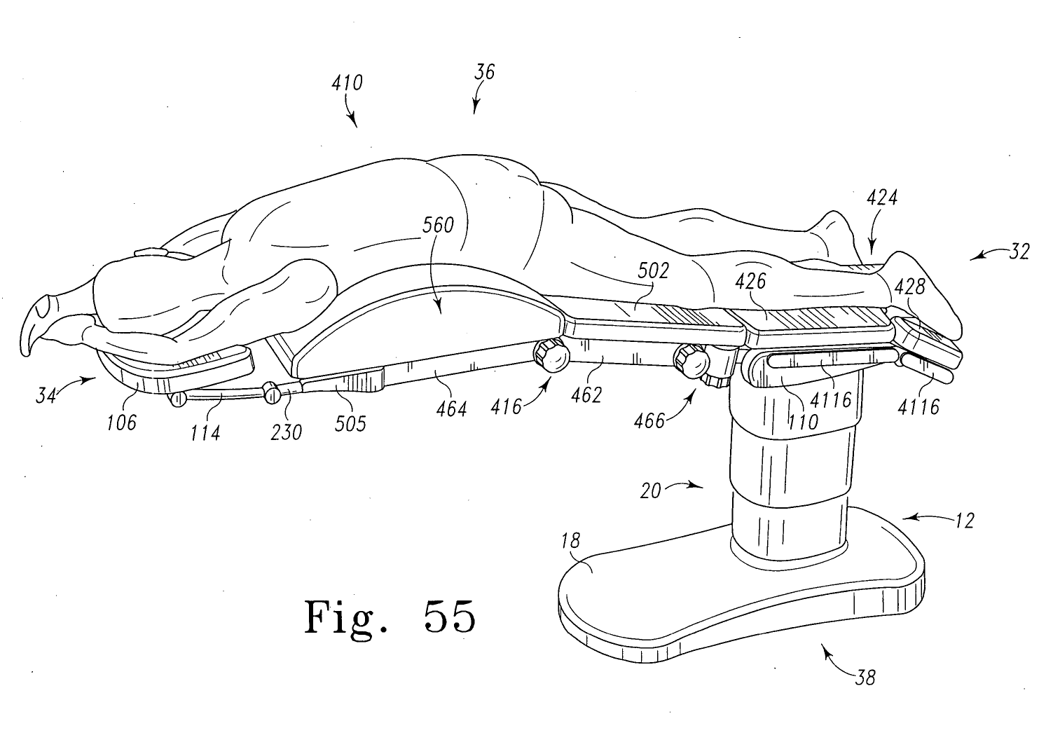

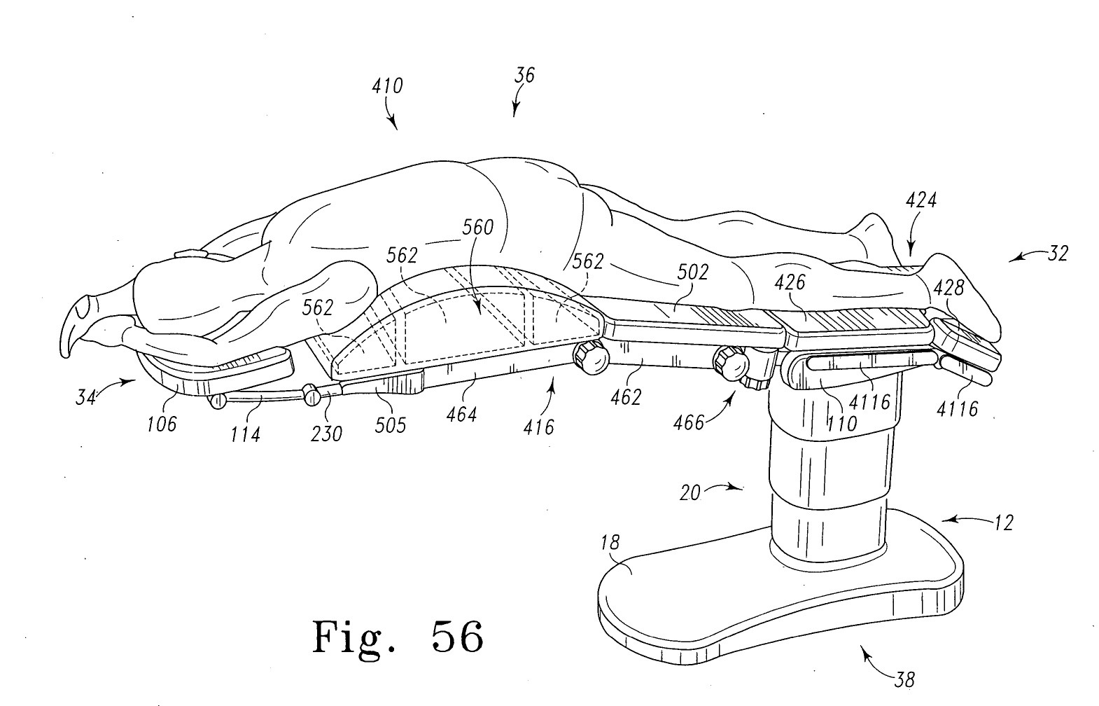

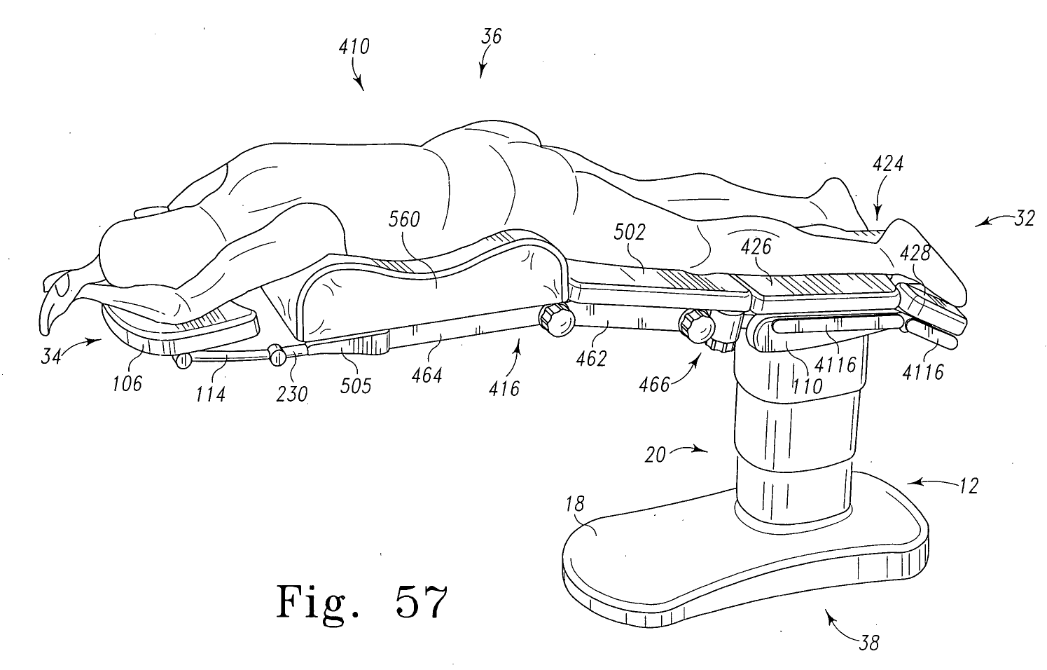

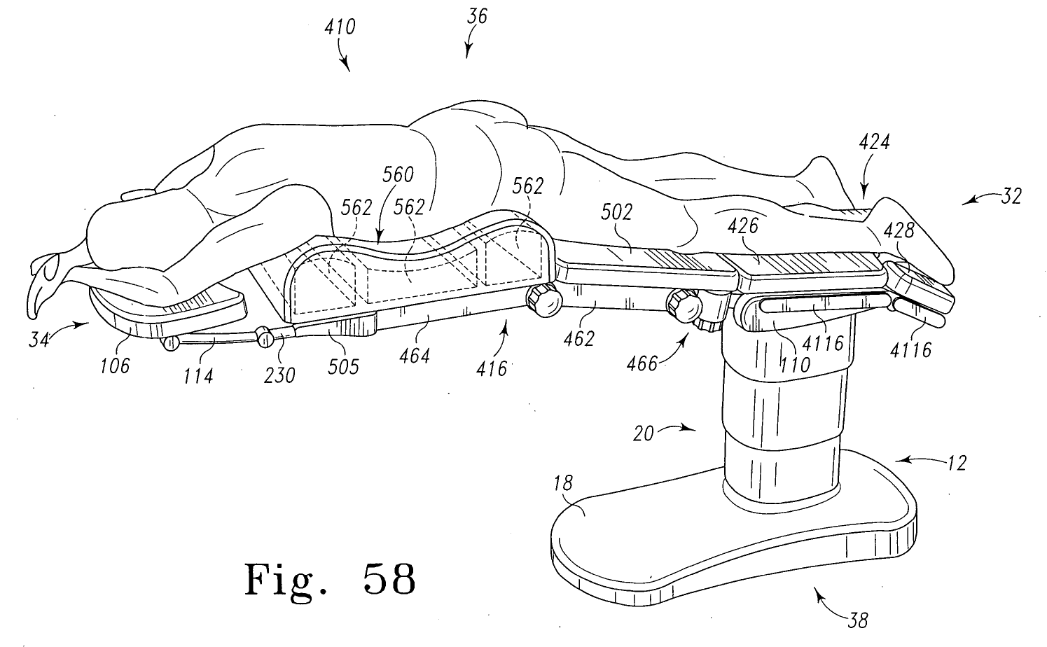

FIG. 54 shows the side-by-side spinal surgery sections 560 altered to a partial single-humped configuration by inflating the central regions of the side-by-side spinal surgery sections 560 more than the head end and foot end regions of the side-by-side spinal surgery sections 560 so that the arch in the patient's spine is decreased. FIG. 55 shows the side-by-side spinal surgery sections altered further to a full single-humped configuration by further inflating the central regions of the side-by-side spinal surgery sections 560 more than the head end and foot end regions of the side-by-side spinal surgery sections 560 so that the arch in the patient's spine is further decreased. FIG. 56 shows in phantom the approximate shape of three of the air bladders 562 of the side-by-side spinal surgery sections 560 when in the full single-humped configuration. FIG. 57 shows the side-by-side spinal surgery sections 560 altered to a full double-humped configuration by inflating the head end and foot end regions of the side-by-side spinal surgery sections 560 more than the central region of the side-by-side spinal surgery sections 560 so that the arch in the patient's spine is increased. FIG. 58 shows in phantom the approximate shape of three of the air bladders 562 of the side-by-side spinal surgery sections 560 when in the full double-humped configuration. Thus, a suitable pneumatic system is provided in table 410 for inflating and deflating bladders 562 in a desired manner. Such a system may have a connector port (for example, on the upper segment of column 20) to which couples a hose set that extends from bladders 562.

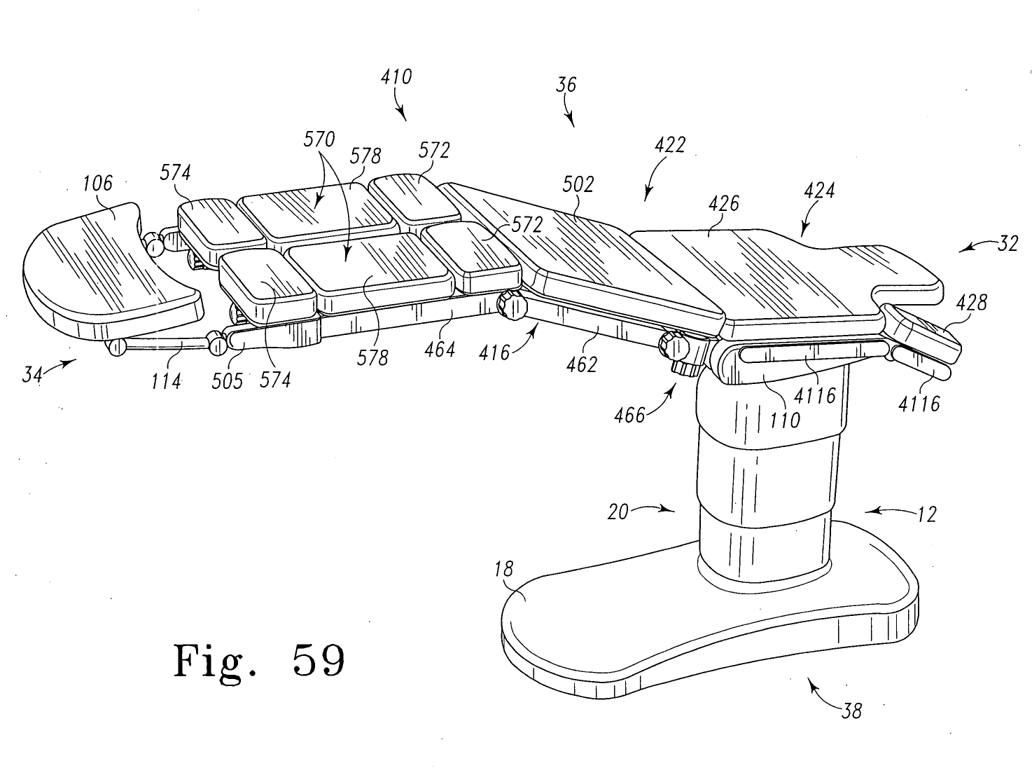

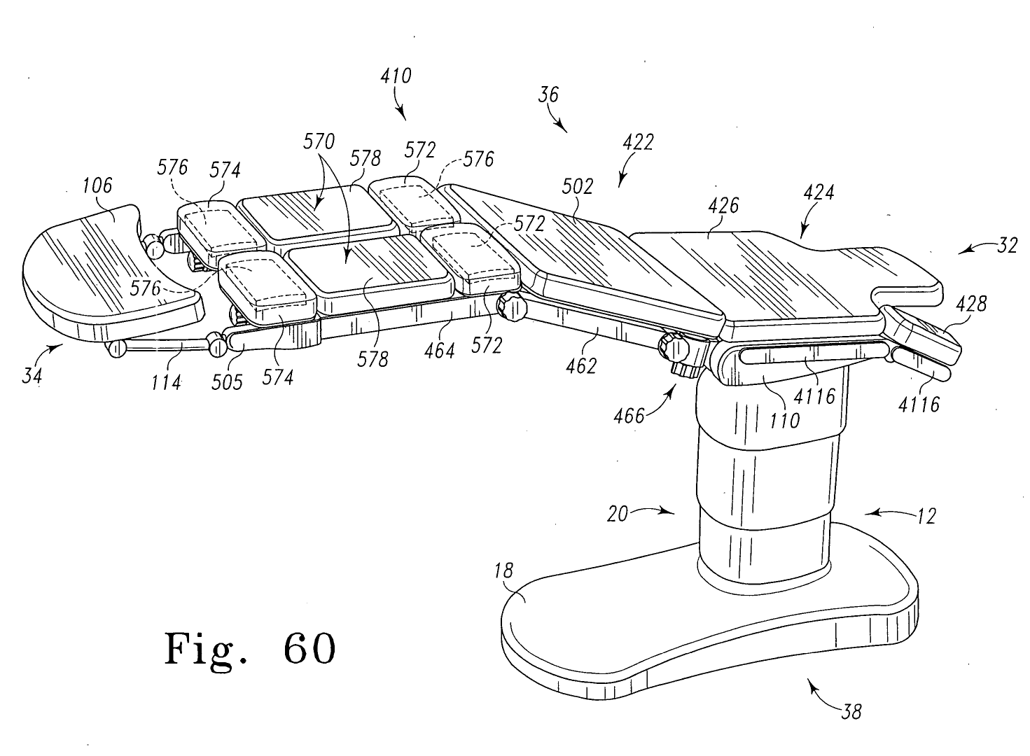

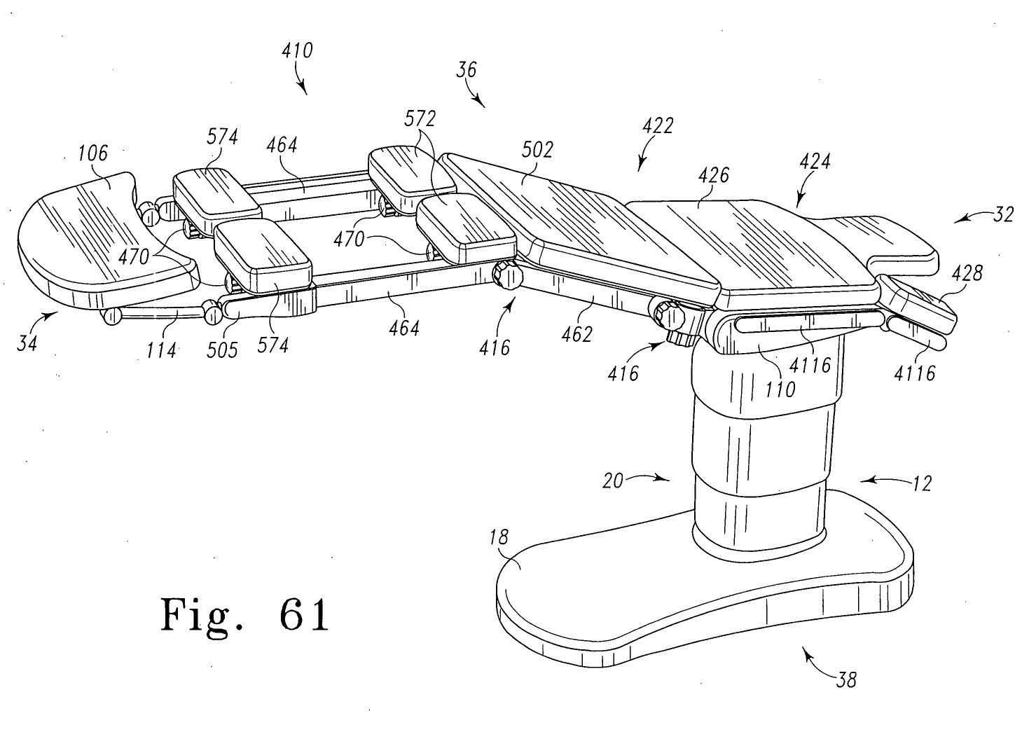

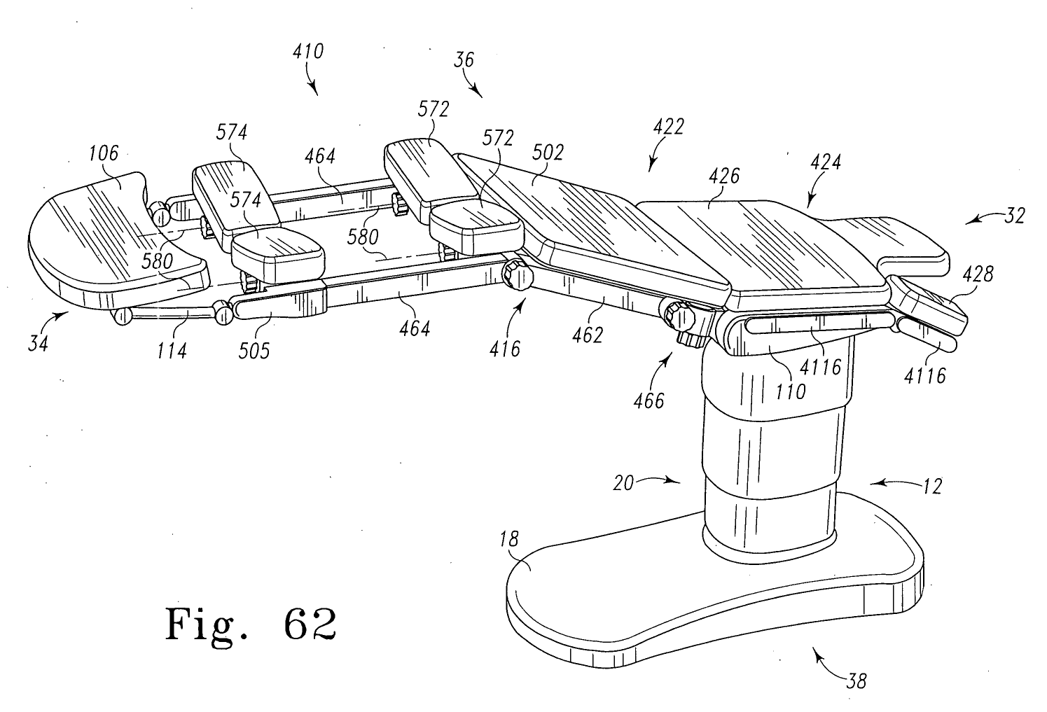

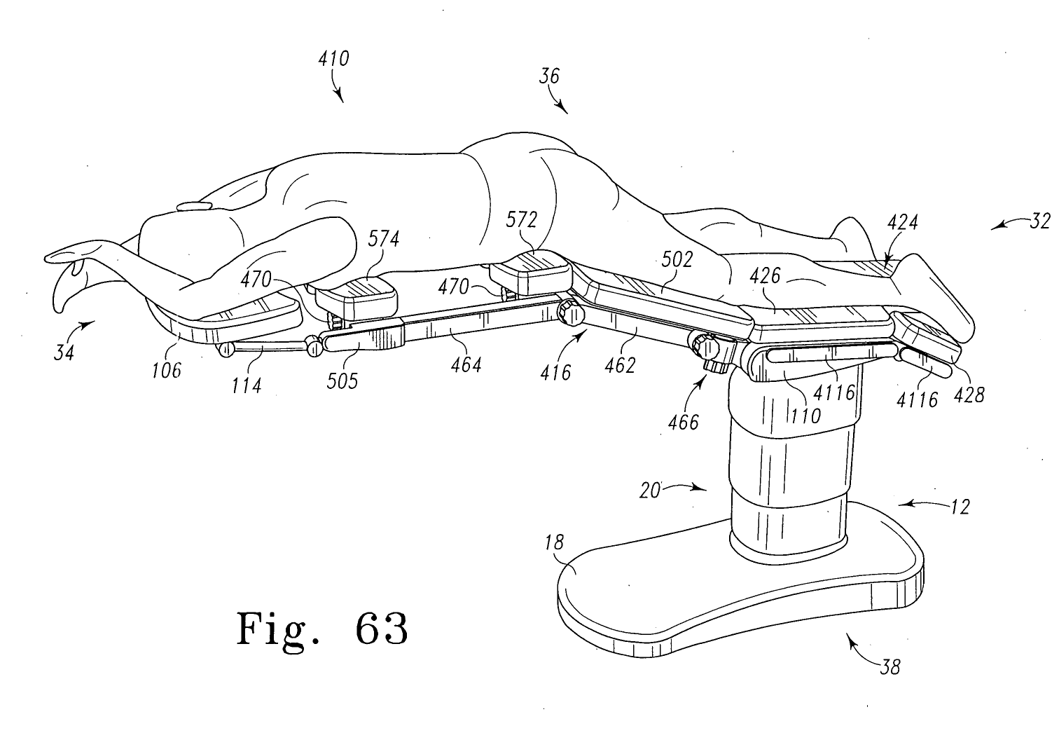

In some embodiments, a pair of multi-piece side-by-side spinal surgery sections 570 are coupled to the respective second traction bars 464 between the head section 106 and the first spinal surgery section 502 in lieu of the rectangular side-by-side spinal surgery sections 560 as shown in FIG. 59. Foot end sections 574 are coupled to associated extension members 505 which are, in turn, coupled via posts (not shown) to bars 464. Head end and middle sections 572, 578, on the other hand, are coupled to bars 464 via brackets that are similar to brackets 512 as shown in FIG. 42. The head end and foot end sections 572, 574 of the multi-piece side-by-side spinal surgery sections 570 each include internal gel pad layers 576 as shown in phantom in FIG. 60. The middle sections 578 of the multi-piece side-by-side spinal surgery sections 570 are removable from bars 464, if desired, as shown in FIG. 61. As shown in FIG. 62, the head end and foot end sections 572, 574 of the multi-piece side-by-side spinal surgery sections 570 are pivotable inwardly about respective pivot axes 580 that are parallel to the longitudinal axis 40 of the surgical table 410. FIG. 63 shows a patient supported by the patient support deck 22 in a face-down position with the patient's torso being supported by the head end and foot end sections 572, 574 of the multi-piece side-by-side spinal surgery sections 570. In addition, shoulder support portions 428 of back section 424 are articulated slightly downwardly from back support portion 426 to accommodate the patient's feet more comfortably.

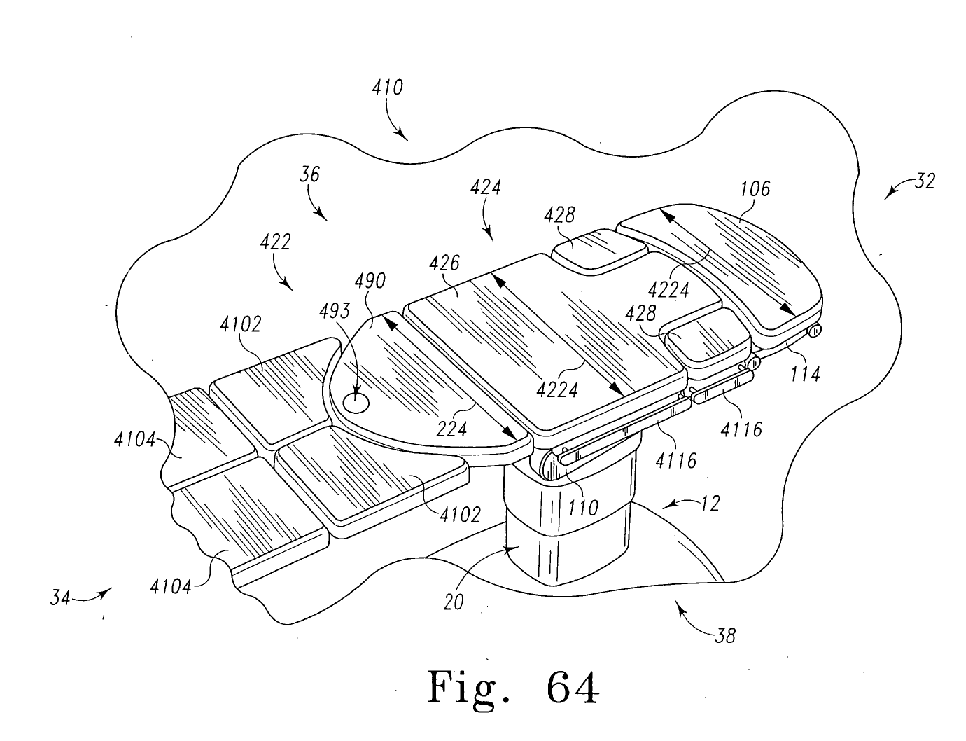

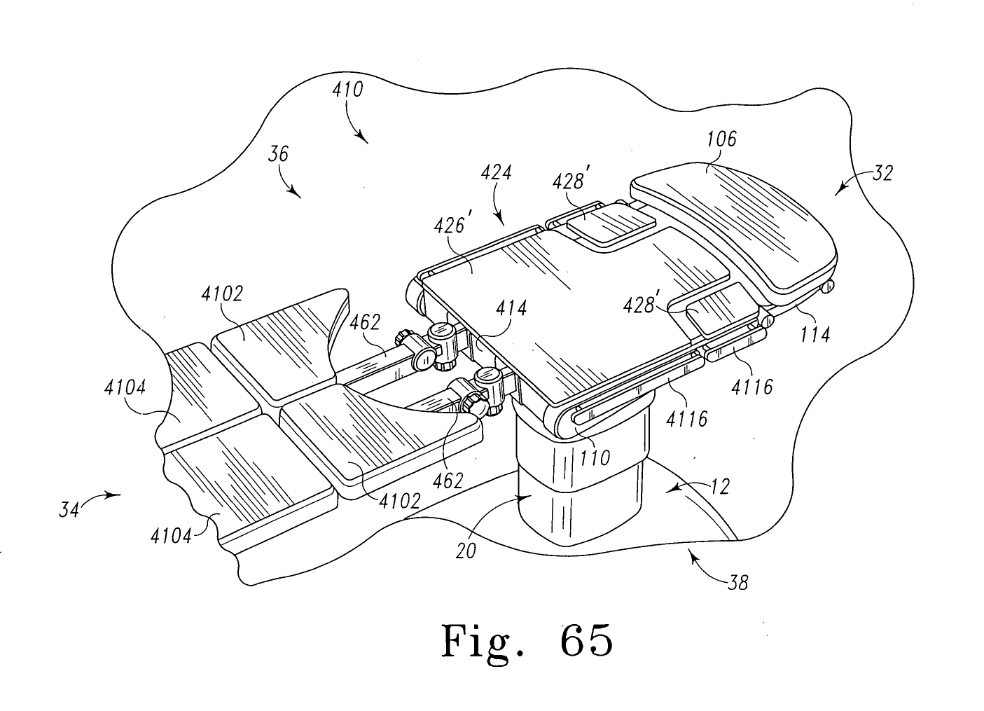

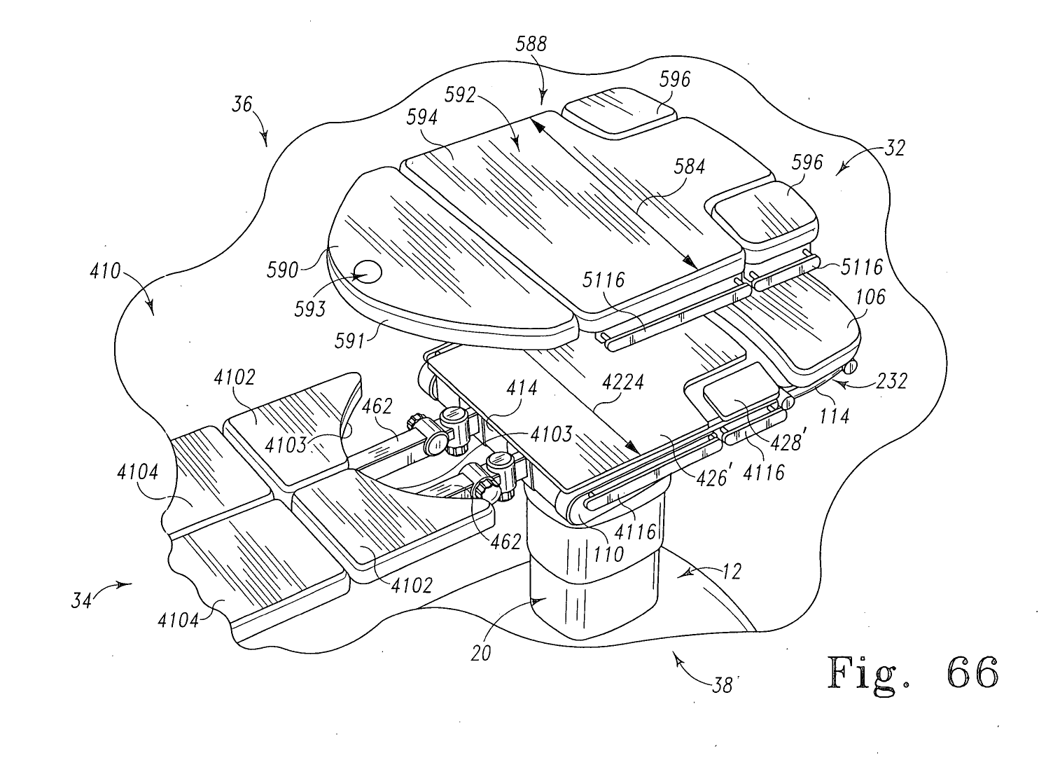

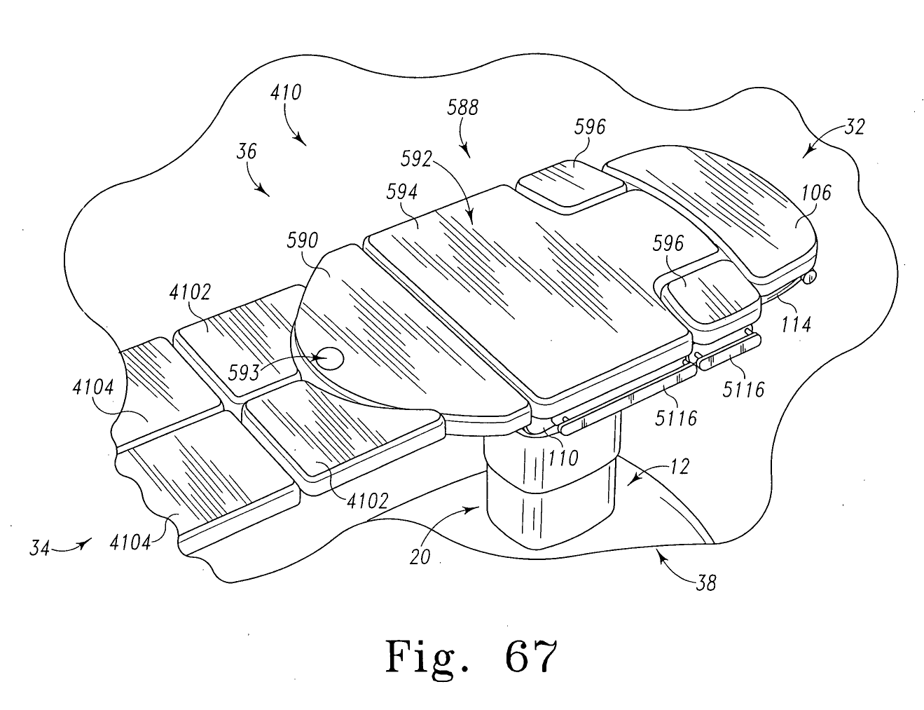

Sections 426, 106, 490 each have a standard transverse width 4224 for normal-sized patients as shown in FIG. 64. However, the width 4224 of sections 426, 490 may be too small for some obese or bariatric patients. A relatively wide bariatric overlay 588 shown in FIGS. 66 and 67 is coupleable to the surgical table 410 to accommodate such bariatric patients. Prior to attachment of overlay 588 to table 410, the seat section 490 is detached from the surgical table 410, the mattress pad of the back support portion 426 is removed from the associated panel 426′, and the mattress pads of the shoulder support portions 428 are removed from the associated panels 428′, as shown in FIG. 65.

FIG. 66 shows the bariatric overlay 588 arranged above the panels 426′, 428′ of the back support portion 426 and the shoulder support portions 428 of the back section 424. As shown therein, the bariatric overlay 588 is wider than the surgical table 410 to accommodate large patients. That is, width 584 of the relatively wide bariatric overlay 588 is larger than width 4224 of back section 424, for example. The bariatric overlay 588 includes a bariatric seat section 590 and a bariatric back section 592. The bariatric seat section 590 is configured to couple to the transverse bar 414 or, alternatively, may be pivotably coupled to the bariatric back section 592 or panel 426′. The bariatric back section 592 includes a bariatric back support portion 594 and bariatric shoulder support portions 596. The bariatric back support portion 594 is configured to couple to the panel 426′ of the back support portion 426 of the back section 424. The bariatric shoulder support portions 596 are configured to couple to the respective panels 428′ of the shoulder support portions 428 of the back section 424. FIG. 67 shows the relatively wide bariatric overlay 588 coupled to the surgical table 410. Details of suitable mechanisms for coupling overlay 588 to back section 424 are shown and described in U.S. Patent Application Publication No. 2001/0044971A1 which is titled BARIATRIC SURFACE FOR AN OPERATING ROOM TABLE and which is hereby incorporated by reference herein.

Seat section 590 of overlay 588 has a concave, rounded rear edge 591 that confronts edges 4103 of thigh sections 4102 in a manner similar to edge 491 of seat section 490, as discussed above, in order to accommodate abduction of assemblies 416 and sections 4102, 4104. Furthermore, seat section 590 has a vertical socket 593 that is configured to receive a countertraction post therein. Portions 594, 596 each have an accessory rail 5116 which lies laterally outboard of respective rails 4116 of portions 426, 428 when the bariatric overlay 588 is coupled to portions 426, 428. In addition, the pivot axis about which portions 596 pivot relative to portion 594 is substantially coincident with the pivot axis about which portions 428 pivot relative to portion 426 when the bariatric overlay 588 is coupled to portions 426, 428. Thus, when the bariatric overlay 588 is coupled to section 424, the bariatric shoulder portions 596 pivot along with shoulder portions 428 when shoulder portions 428 are pivoted by the respective drive mechanisms of table 410.

To recapitulate, the surgical table 410 is configurable for different types of orthopedic surgical procedures, as well as being usable for general surgery. For example, for trauma surgery, the traction boot assemblies 4120 are used to apply traction to a patient's legs are as shown, for example, in FIG. 37. For shoulder surgery, on the other hand, the back section 424 is articulated relative to the column 20 to a raised position in a manner similar to FIG. 24, and one or both of the shoulder support portions 428 are pivoted away to expose the posterior portions of a patient's shoulders in a manner similar to FIG. 25. For spinal surgery, the seat section 490, the thigh sections 4102, the calf sections 4104 and the traction boot assemblies 4120 are all detached from the surgical table 410, and the first and second spinal surgery sections 502, 504 are instead attached to the surgical table 410 as shown in FIGS. 43-50. In some embodiments, the second spinal surgery section 504 is removed from the pair of second traction bars 464, and replaced with a pair of rectangular side-by-side spinal surgery sections 560 that are coupled to the associated second traction bars 464 between the head section 106 and the first spinal surgery section 502 as shown in FIGS. 51-58. In still other embodiments, the rectangular side-by-side spinal surgery sections 560 are removed and replaced with a pair of multi-piece side-by-side spinal surgery sections 570 that are coupled to the respective second traction bars 464 between the head section 106 and the first spinal surgery section 502 as shown in FIGS. 59-63. For surgery on bariatric patients, the mattress pad of the back support portion 426 and the mattress pads of the shoulder support portions 428 are removed from the associated panels 426′, 428′ and the bariatric overlay 588 is then coupled to the panels 426′, 428′ of the back support portion 426 and the shoulder support portions 428 as shown in FIGS. 66, 67.

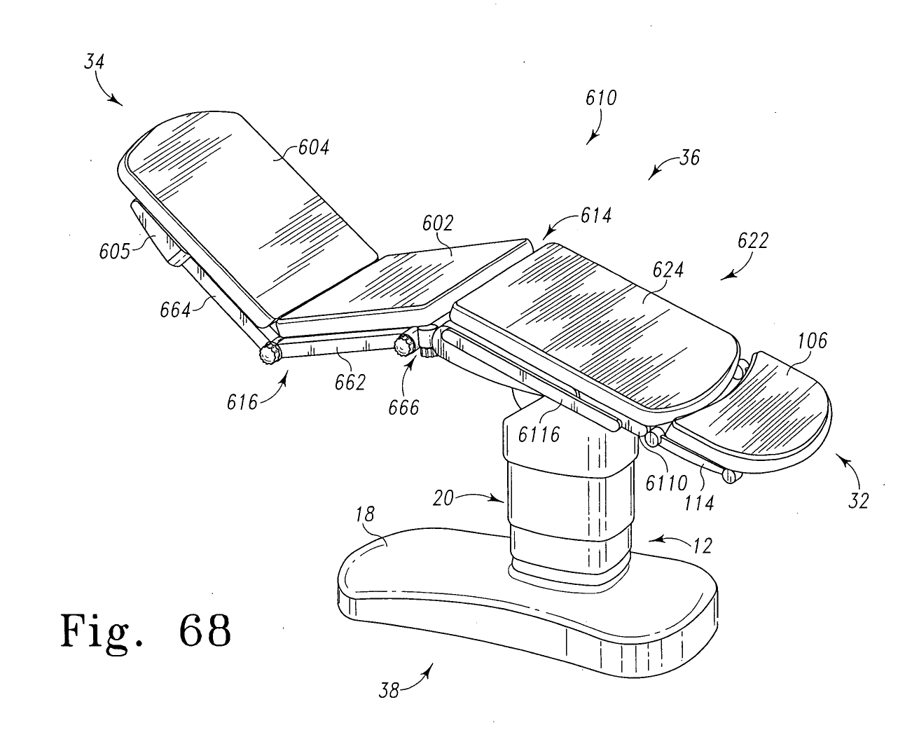

FIGS. 68-72 illustrate a third embodiment 610 of a surgical table according to this disclosure. As a general rule, the same components in the surgical tables 10, 610 are identified in the description below using the same reference numerals. For example, both surgical tables 10 and 610 include base 18, column 20, head end 32, and foot end 34. On the other hand, the components which are similar or perform similar functions in the two surgical tables 10, 610 bear the same reference numerals except that they are preceded by numeral “6” in the embodiment of FIGS. 68-72. For example, the traction bar assemblies and the patient support deck are identified by numerals “16” and “22” respectively in the embodiment of FIGS. 1-29, and identified by numerals “616” and “622” respectively in the embodiment of FIGS. 68-72.

Referring to FIG. 68, a pair of traction bar assemblies 616 are coupled to a transverse bar 614 that is substantially the same as transverse bars 14, 414 of tables 10, 410. The traction bar assemblies 616 each include a first traction bar 662, a second traction bar 664 and a multi-joint coupler 666. The first traction bar 662 is coupled to the multi-joint coupler 666 for pivoting movement about a first pivot axis and a second pivot axis that, in the illustrative embodiment, is orthogonal to the first pivot axis. The second traction bar 664 is coupled to the first traction bar 662 for pivoting movement about a third pivot axis. Thus, the first and second traction bars 662, 664 are configured to articulate relative to the associated transverse bar 614 to a variety of articulated positions.

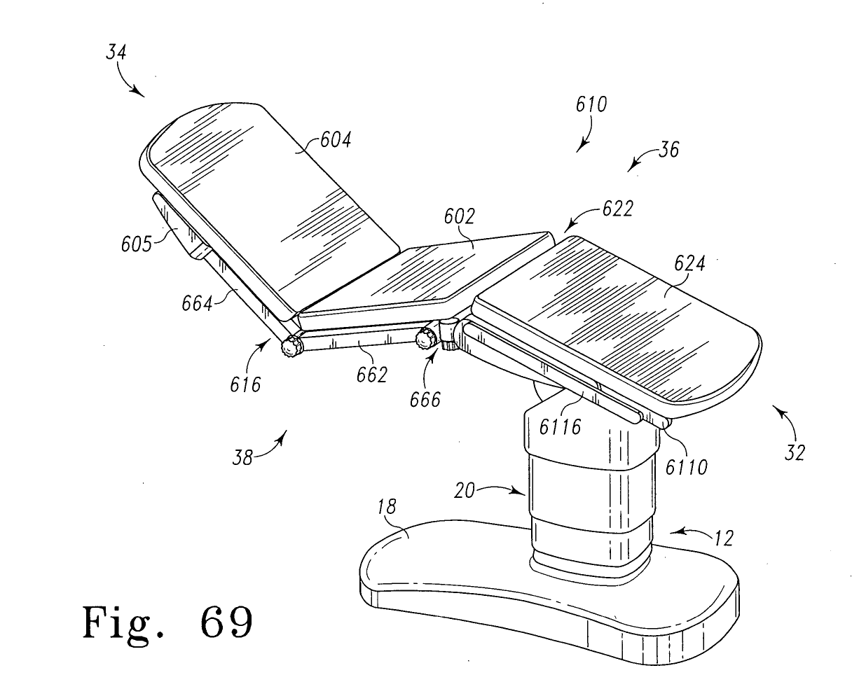

The patient support deck 622 includes a first section 624 supported by the vertical column 20, a second section 602 coupled to the first traction bars 662 adjacent to the first section 624 and a third section 604 coupled to the second traction bars 664 near the foot end 34. First section 624, in general, remains coupled to column 20 regardless of other modifications made to table 610 to configure table 610 for various types of surgery. In addition, unlike sections 24, 424 of tables 10, 410, section 624 of table 610 does not have pivotable shoulder support portions. The second and third sections 602, 604 are coupled to the first and second traction bars 662, 664 in a manner similar to the way in which the first and second spinal surgery sections 502, 504 are coupled to the first and second traction bars 462, 464 respectively, for example, as shown in FIG. 42. In some embodiments, a post (not shown) that extends from an extension member 605 of section 604 couples section 604 to bars 664. The head section 106 is coupled to the first section 624 near the head end 32 in a manner similar to the way in which the head section 106 is coupled to the back section 24, 424 of tables 10, 410. Thus, the first section 624 includes a pair of laterally-spaced sockets into which the laterally-spaced frame members 114 of the head section 106 are inserted to couple the head section 106 to the first section 624. The head section 106 can be detached from the first section 624 as shown in FIG. 69. For general surgical procedures, the deck sections 106, 624, 602, 604 may be articulated to various positions and the entire patient support deck 622 may be tilted to various inclinations to place a patient in desired positions.

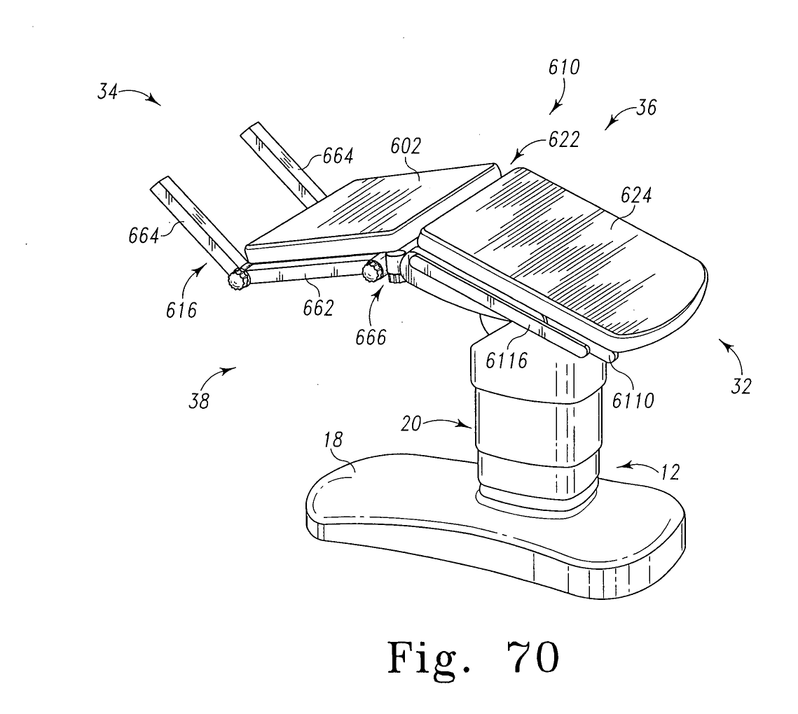

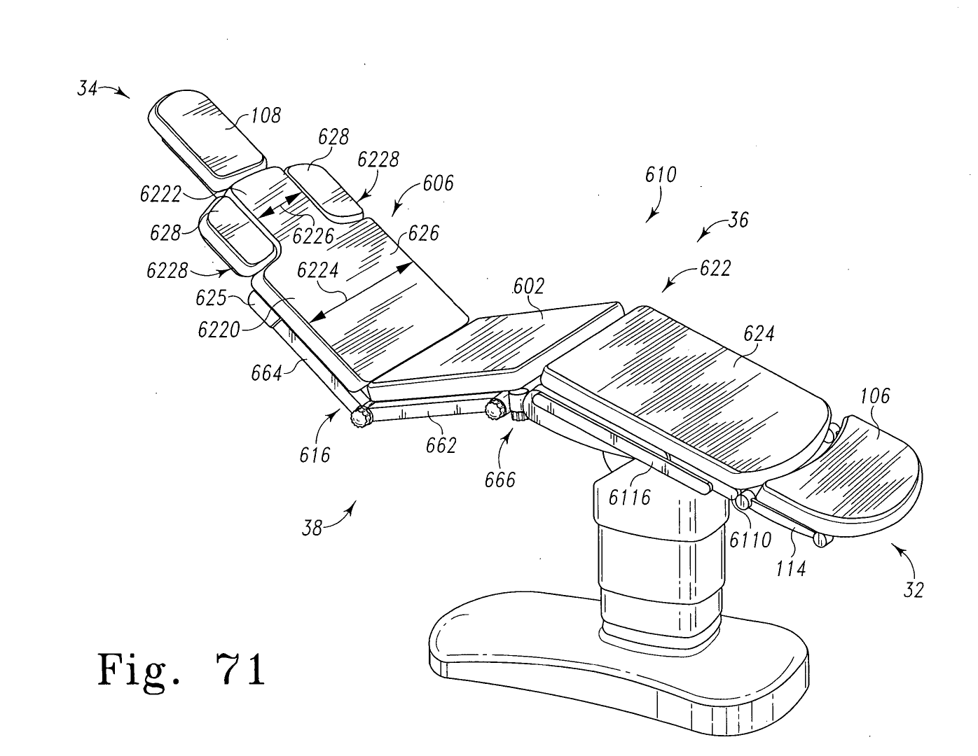

For shoulder surgery, the third section 604 is removed from the second traction bars 664 as shown in FIG. 70, and a shoulder surgery module 606 is instead coupled to the second traction bars 664, such as via suitable brackets or via a post extending from extension member 625 of module 606, as shown in FIG. 71. The shoulder surgery module 606 comprises a back support portion 626 and a pair of laterally spaced-apart shoulder support portions 628. The back support portion 626 includes a relatively wide first portion 6220 near the second section 602 and a relatively narrow second portion 6222 near the foot end 34. The relatively wide first portion 6220 of the back support portion 626 has a first transverse width 6224, and the relatively narrow second portion 6222 of the back support portion 626 has a second transverse width 6226 that is smaller than the first transverse width 6224 such that a pair of cut-outs 6228 are defined alongside the opposite sides 36, 38 of the relatively narrow second portion 6222 near the foot end 34 for receiving the generally rectangular shoulder support portions 628.

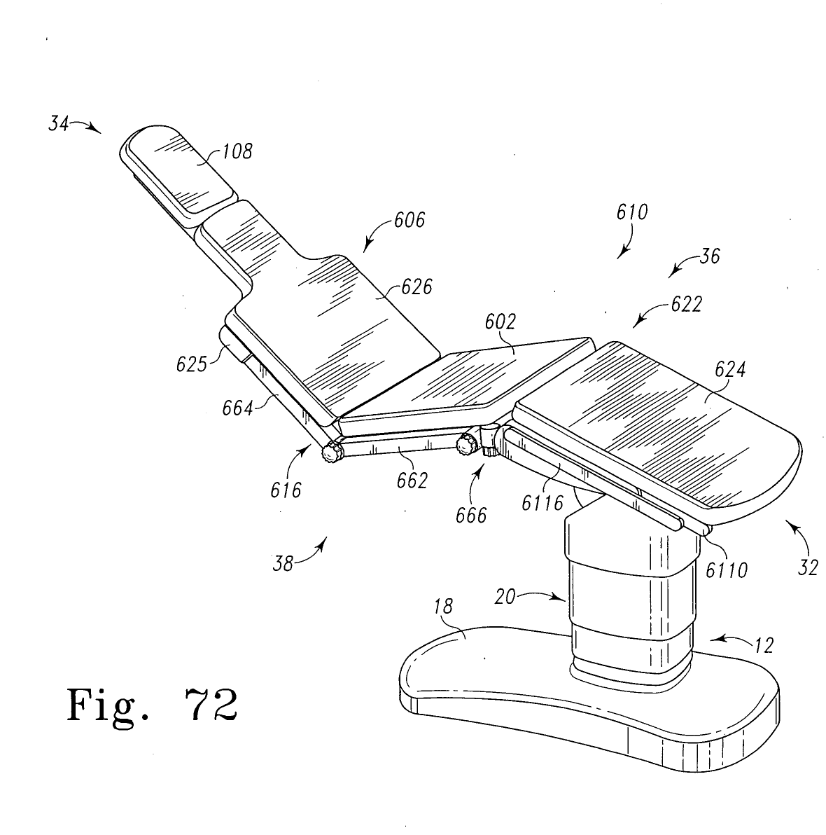

Each shoulder support portion 628 includes a post which is configured for reception in a socket coupled to the back support portion 626 to attach the shoulder support portion 628 to the back support portion 626 in a manner similar to the way the head section 106 is attached to the first section 624. The posts of shoulder support portions 628 and the corresponding sockets of back support portion 626 are non-round in cross section in some embodiments to prevent unwanted rotation of shoulder support portions 628 relative to back support portion 626 so that a substantially planar patient-support surface is provided by portions 626, 628. In other embodiments, posts of portions 628 and sockets of portions 626 are round in cross section and some other anti-rotation structure is provided to prevent unwanted rotation. In some embodiments, however, the shoulder support portions 628 are mounted in the respective cut-outs 6228 for movement between a first position where the shoulder support portions 628 are coplanar with the back support portion 626 and a second position where the shoulder support portions 628 are pivoted away from the first position in a manner similar to the way in which the shoulder support portions 28 are coupled to the back support portion 26 as shown in FIGS. 24 and 25. For shoulder surgery, the shoulder surgery module 606 of the patient support deck 622 is articulated upwardly and the first and second section 624, 602 are articulated slightly downwardly to support the patient in a sitting-up position. In addition, as shown in FIG. 72, the shoulder support portions 628 of the shoulder surgery module 606 are detached from the back support portion 626 to expose the posterior portions of the patient's shoulders for shoulder surgery.

To recapitulate, the surgical table 610 is configurable for different types of surgical procedures. For example, for general surgical procedures, the deck sections 106, 624, 602, 604 are articulated to various positions and the entire patient support deck 622 is tilted to various inclinations to place a patient in desired positions. For shoulder surgery, the third section 604 is removed from the second traction bars 664, and a shoulder surgery module 606 is instead coupled to the second traction bars 664. The shoulder surgery module 606 is articulated upwardly and the first and second section 624, 602 are articulated slightly downwardly to support the patient in a sitting-up position. The shoulder support portions 628 of the shoulder surgery module 606 are detached from the back support portion 626 or pivoted away to expose the posterior portions of the patient's shoulders for shoulder surgery. For trauma surgery, either of traction boot assemblies 120, 4120 may be coupled to traction bars 664 and operated to apply traction to a patient's legs in the manner described above in connection with tables 10, 410, respectively. Table 610 may use any of the mechanisms described above with regard to table 410 for spinal surgery. For example, sections 106, 602, 604, 624 may be moved to a position to support a patient in a kneeling, face-down position, for example, as shown in FIG. 45, and either a bladder (like bladder 550 in FIG. 48) in section 624 may be inflated or a hip lift (like lift 530 in FIG. 47) coupled to bars 662 may be operated to increase the arch in a patient's spine. Alternatively, either of spinal surgery sections 560, 570 may be coupled to bars 664, for example, as shown in FIGS. 51 and 59, and operated in a manner like that described above with regard to table 410.

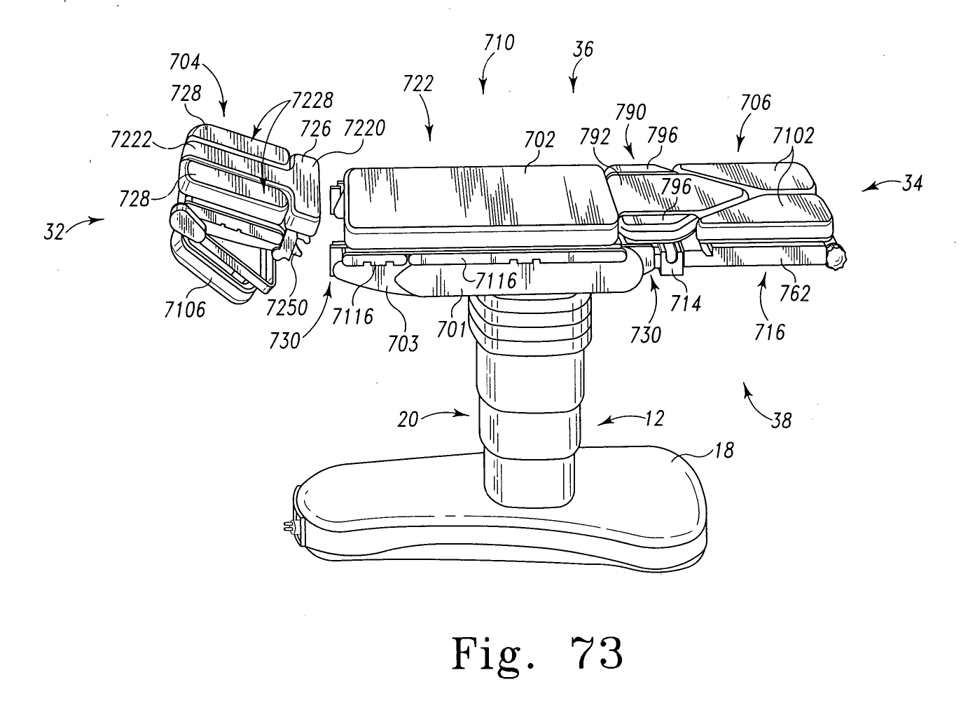

FIG. 73 illustrates a fourth embodiment 710 of a surgical table according to this disclosure. As a general rule, the same components in the two surgical tables 10, 710 are identified in the description below using the same reference numerals. For example, both surgical tables 10 and 710 include the base 18, the column 20, the head end 32 and the foot end 34. On the other hand, the components which are similar or perform similar functions in the two surgical tables 10, 710 bear the same reference numerals except that they are preceded by numeral “7” in the embodiment of FIG. 73. For example, the patient support deck is identified by numerals “22” in the embodiment of FIGS. 1-29, and identified by numeral “722” in the embodiment of FIG. 73.

Referring to FIG. 73, the patient support deck 722 includes a first section 702 supported by the column 20, a first pair of powered pivot couplers 730 coupled to the first section 702 adjacent to the head end 32 and a second pair of powered pivot couplers 730 coupled to the first section 702 adjacent to the foot end 34. Section 702 has a first frame member 701 (and associated panel, not shown) and a second frame member 703 (and associated panel, not shown) that is pivotable relative to the first frame member 701. However, section 702 has one mattress pad associated with both frame members 701, 703.

Various modules are attachable to couplers 730 to configure table 710 for orthopedic surgery. For example, a shoulder surgery module 704 is coupled to the first pair of powered pivot couplers 730 adjacent to the head end 32 to configure table 710 for shoulder surgery. A trauma surgery module 706 (shown partially) is coupled to the second pair of powered pivot couplers 730 adjacent to the foot end 34 to configure table 710 for trauma surgery. Module 706 includes traction bar assemblies 716 that are substantially the same as traction bar assemblies 16, 416 of tables 10, 410. To configure table 710 for spinal surgery, module 704 or module 706 may be replaced with a spinal surgery board, such as board 340 shown in FIGS. 28 and 29, or sections, similar to spinal surgery sections 502, 504, 560, 570 shown in FIGS. 41, 51 and 59, may be coupled to traction bar assemblies 716 of module 706. A hip lift, similar to hip lift 530 shown in FIG. 47, may be coupled to traction bars 762 of traction bar assemblies 716, if desired.

The shoulder surgery module 704 is substantially the same as the shoulder surgery module 606 described above in conjunction with FIG. 71. The shoulder surgery module 704 comprises a back support portion 726 and a pair of laterally spaced-apart shoulder support portions 728. The back support portion 726 includes a relatively wide first portion 7220 near the first section 702 and a relatively narrow second portion 7222 near the head end 32. The relatively wide first portion 7220 of the back support portion 726 has a first transverse width, and the relatively narrow second portion 7222 of the back support portion 726 has a second transverse width that is smaller than the first transverse width such that a pair of cut-outs 7228 are defined alongside the opposite sides 36, 38 of the relatively narrow second portion 7222 near the head end 32 for receiving the generally rectangular shoulder support portions 728.

Shoulder support portions 728 include suitable couplers, which may include posts that are configured for reception in associated sockets of the back support portion 726, to removably attach the shoulder support portions 728 to the back support portion 726. In some embodiments, however, the shoulder support portions 728 are mounted in the respective cut-outs 7228 for movement between a first position where the shoulder support portions 728 are coplanar with the back support portion 726 and a second position where the shoulder support portions 728 are pivoted away from the first position in a manner similar to the way in which the shoulder support portions 28 are mounted in the respective cut-outs 228 of the back support portion 26 as shown in FIGS. 24 and 25. Module 704 includes brackets 7250 that are substantially the same as brackets 250 of table 10 (shown in FIG. 21) and that mate with the associated couplers 730 at head end 32 of section 702. For shoulder surgery, the couplers 730 at head end 32 of section 702 are pivoted so that the shoulder surgery module 704 of the patient support deck 722 is articulated upwardly and the couplers 730 at foot end 34 of section 702 are pivoted so that the trauma surgery module 706 is articulated slightly downwardly to support the patient in a sitting-up position. In addition, the shoulder support portions 728 of the shoulder surgery module 704 are detached from the back support portion 726 to expose the posterior portions of the patient's shoulders.

Module 704 includes a “wide” head section 7106 that is removably coupled to shoulder support portions 728 in a manner similar to the manner in which head section 106 of table 10 couples to shoulder support portions 28. During shoulder surgery, head section 7106 is detached from shoulder support portions 728 and, optionally, a “narrow” head section, similar to head section 108 shown in FIG. 71, is coupled to second portion 7222 of back support portion 726 to support the patient's head. During other surgical procedures, including general surgical procedures, head section 7106 is pivoted from its storage position, shown in FIG. 73, to a desired use position out from under portions 726, 728.

The pair of traction bar assemblies 716 are coupled to the transverse bar 714 in a manner similar to the way in which the traction bar assemblies 16 are coupled to the transverse bar 14 as shown, for example, in FIG. 21. As previously indicated, the traction bar assemblies 716 are substantially the same as the traction bar assemblies 16, 416 of tables 10, 410. The traction bar assemblies 716 each include a first traction bar 762, a second traction bar (not shown) and a multi-joint coupler (not shown). The first traction bar 762 is coupled to the multi-joint coupler for pivoting movement about a first pivot axis and a second pivot axis that, in the illustrative embodiment, is orthogonal to the first pivot axis. The second traction bar is coupled to the first traction bar 762 for pivoting movement about a third pivot axis. Thus, the first and second traction bars are configured to articulate relative to the transverse bar 714 to a variety of articulated positions.

The trauma surgery module 706 is coupled to the traction bar assemblies 716 adjacent to the foot end 34. The trauma surgery module 706 includes a seat section 790, a pair of thigh sections 7102 and a pair of calf sections (not shown). The seat section 790 has a central portion 792, a countertraction post (similar to the countertraction post 94 shown in FIG. 6) and a pair of side portions 796 laterally outboard of the central portion 792. The seat section 790 is coupled to the transverse bar 714 in a manner similar to the way in which the seat section 90 is coupled to the transverse bar 14 as shown, for example, in FIG. 21. The thigh sections 7102 are coupled to the first traction bars 762 in a manner similar to the way in which the thigh sections 4102 are coupled to the first traction bars 462 as shown, for example, in FIG. 40. The calf sections are likewise coupled to the second traction bars. For trauma surgery, a pair of traction boot assemblies (not shown) are coupled to the second traction bars in a manner similar to the way in the traction boot assemblies 120 are coupled to the second traction bars 64 as shown, for example, in FIGS. 6-16.

To recapitulate, the surgical table 710 is configurable for different types of surgical procedures. For example, for shoulder surgery, the shoulder surgery module 704 of the patient support deck 722 is articulated upwardly and the trauma surgery module 706 is articulated slightly downwardly to support the patient in a sitting-up position. The shoulder support portions 728 of the shoulder surgery module 704 are detached from the back support portion 726 to expose the posterior portions of the patient's shoulders. For trauma surgery, a pair of traction boot assemblies are coupled to the second traction bars for applying traction to the patient's legs. For spinal surgery, a spinal surgery board, such as board 340 shown in FIGS. 28 and 29, may be coupled to couplers 730, or sections, like sections 502, 504, 560, 570 (shown in FIGS. 41, 51 and 59) discussed above, may be coupled to traction bar assemblies 716. Table 710 has head end and foot end powered couplers 730 for powered articulation of whatever modules are coupled thereto. For general surgery, a “standard” leg section may be attached to couplers 730 at the foot end 34 of table 710 in lieu of module 706 and a “standard” head section may be attached to couplers 730 at the head end 32 of table 710 in lieu of module 704.

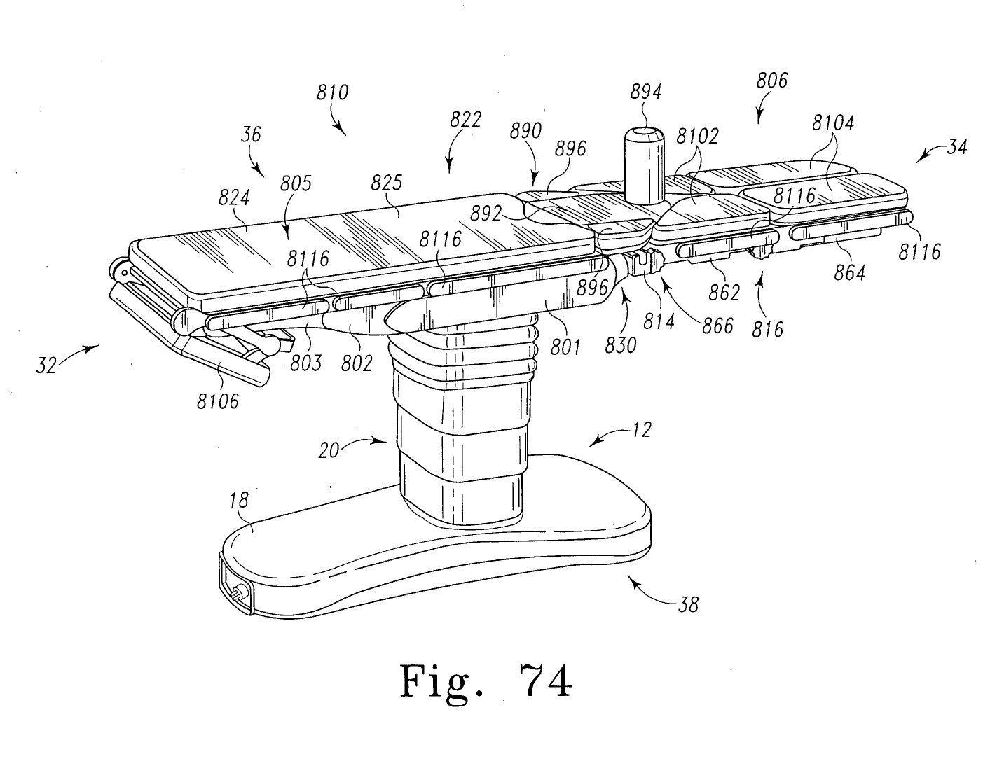

FIGS. 74-83 illustrate a fifth embodiment 810 of a surgical table according to this disclosure. As a general rule, the same components in the two surgical tables 10, 810 are identified in the description below using the same reference numerals. For example, both surgical tables 10 and 810 include the base 18, the column 20, the head end 32 and the foot end 34. On the other hand, the components which are similar or perform similar functions in the two surgical tables 10, 810 bear the same reference numerals except that they are preceded by numeral “8” in the embodiment of FIGS. 74-83. For example, the traction bar assemblies and the patient support deck are identified by numerals “16” and “22” respectively in the embodiment of FIGS. 1-29, and identified by numerals “816” and “822” respectively in the embodiment of FIGS. 74-83.

Referring to FIG. 74, a patient support deck 822 of table 810 includes a first frame 801 supported by column 20, a second frame 802 pivotably coupled to head end 32 of first frame 801, and a third frame 803 pivotably coupled to head end 32 of second frame 802. A mattress pad 805 is coupled to panels (not shown) associated with respective frames 801, 802, 803. Frames 802, 803 and the portion of mattress pad 805 associated therewith provide table 710 with a back section 824. Likewise, frame 801 and the portion of mattress pad 805 associated therewith provide table 810 with a seat section 825. A pair of powered pivot couplers 830 are coupled to the foot end 34 of frame 801. A head section 8106 is coupled to the back section 824 near the head end 32 in a manner similar to the way in which the head section 106 is coupled to the back section 24 of table 10. Thus, frame 803 of back section 824 includes a pair of laterally spaced sockets (not shown) into which laterally spaced posts (not shown) of the head section 8106 are inserted to couple the head section 8106 to the back section 824. The head section 8106 can be pivoted to an out-of-the-way position beneath the back section 824 as shown, for example, in FIG. 74 and can also be pivoted out from underneath back section 824 to a variety of use positions. Alternatively, the head section 8106 can be detached from the back section 824, and stored elsewhere.

Transverse bar 814 is coupleable to powered pivot couplers 830 and a pair of traction bar assemblies 816 are coupleable to the transverse bar 814 in a manner similar to the way in which transverse bar 14 is coupleable to powered pivot couplers 30 and the traction bar assemblies 16 are coupleable to the transverse bar 14 as shown, for example, in FIG. 21. The traction bar assemblies 816 each include a first traction bar 862, a second traction bar 864 and a multi-joint coupler 866. The first traction bar 862 is coupled to the multi-joint coupler 866 for pivoting movement about a first pivot axis and a second pivot axis that, in the illustrative embodiment, is orthogonal to the first pivot axis. The second traction bar 864 is coupled to the first traction bar 862 for pivoting movement about a third pivot axis. Thus, the first and second traction bars 862, 864 are configured to articulate relative to the transverse bar 814 to a variety of articulated positions.

A trauma surgery module 806, which includes traction bar assemblies 816, is coupled to the surgical table 810 near the foot end 34. The trauma surgery module 806 includes a seat section 890, a pair of thigh sections 8102 and a pair of calf sections 8104 as shown in FIG. 74. The seat section 890 has a central portion 892, a countertraction post 894 and a pair of side portions 896 laterally outboard of the central portion 892. Seat section 890 is coupled to transverse bar 814 in a manner similar to the way in which the seat section 90 is coupled to transverse bar 14 as shown, for example, in FIG. 21. The thigh sections 8102 are coupled to the first traction bars 862 in a manner similar to the way in which the thigh sections 102 are coupled to the first traction bars 62 as shown, for example, in FIG. 40. The calf sections 8104 are likewise coupled to the second traction bars 864. For trauma surgery, a pair of traction boot assemblies (not shown) are coupled to the second traction bars 864 in a manner similar to the way in the traction boot assemblies 120 are coupled to the second traction bars 64 as shown, for example, in FIGS. 6-16. The traction boot assemblies are used as described above for applying traction to the patient's legs.

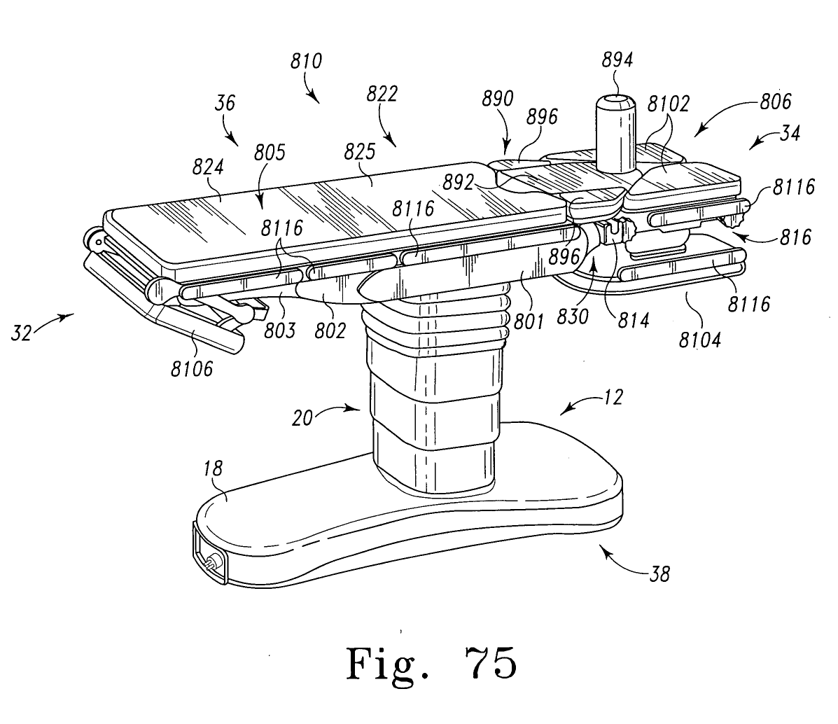

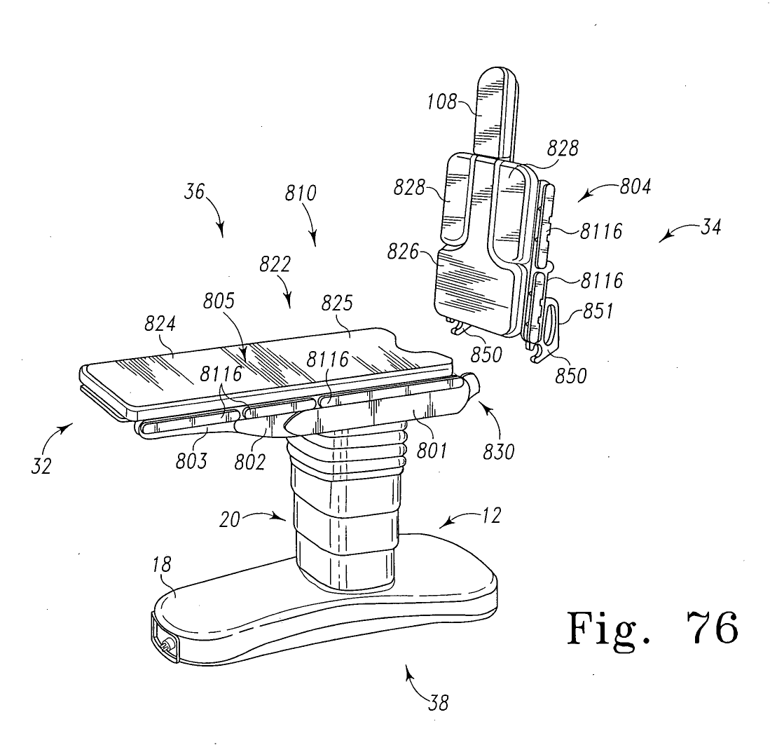

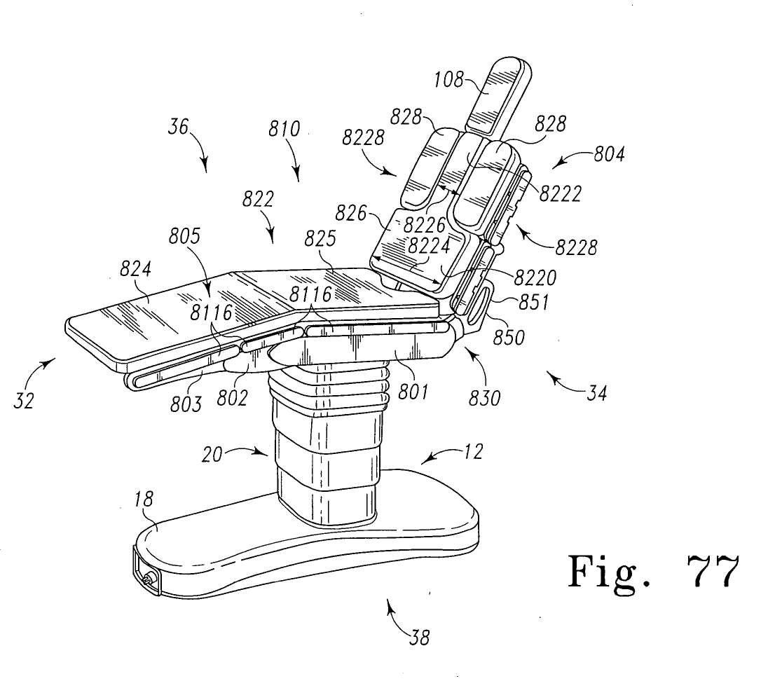

For shoulder surgery, the transverse bar 814 and the trauma surgery module 806 comprising traction bar assemblies 816, seat section 890, thigh sections 8102, calf sections 8104, and associated traction boat assemblies are all detached from the powered pivot couplers 830, and a shoulder surgery module 804 is instead coupled to the powered pivot couplers 830 as shown in FIGS. 76 and 77. To this end, the calf sections 8104 are first folded beneath the seat and thigh sections 890, 8102 as shown in FIG. 75 in a manner similar to the way in which the calf sections 104 are folded beneath the seat and thigh sections 90, 102 as shown, for example, in FIG. 26. The seat section 890, the thigh sections 8102, the calf sections 8104 (along with the countertraction post 894, the transverse bar 814 and the traction bar assemblies 816) are all decoupled, as a module or unit, from the remainder of the patient support deck 822. FIG. 76 shows the surgical table 810 after the seat, thigh and calf sections 890, 8102, 8104 (along with the countertraction post 894, the transverse bar 814 and the traction bar assemblies 816) have all been removed, and a shoulder surgery module 804 is arranged for coupling to the powered pivot couplers 830 in its place. FIG. 77 shows the shoulder surgery module 804 attached to the powered pivot couplers 830 of the surgical table 810.

The shoulder surgery module 804, like the shoulder surgery module 606 shown in FIG. 71, comprises a back support portion 826 and a pair of laterally spaced-apart shoulder support portions 828. The back support portion 826 includes a relatively wide first portion 8220 near the seat section 825 and a relatively narrow second portion 8222 near the foot end 34 of the surgical table 810. The relatively wide first portion 8220 of the back support portion 826 has a first transverse width 8224, and the relatively narrow second portion 8222 of the back support portion 826 has a second transverse width 8226 that is smaller than the first transverse width 8224 such that a pair of cut-outs 8228 are defined alongside the opposite sides 36, 38 of the relatively narrow second portion 8222 near the foot end 34 for receiving the generally rectangular shoulder support portions 828.

In some embodiments, each shoulder support portion 828 includes a post which is configured for reception in an associated socket (not shown) of the back support portion 826 to attach the shoulder support portion 828 to the back support portion 826 in a manner similar to the way the head section 106 is attached to the back section 24 as shown, for example, in FIG. 19b. In some embodiments, however, the shoulder support portions 828 are mounted to portion 826 for pivoting movement between a first position where the shoulder support portions 828 are situated in respective cut-outs 8228 so as to be coplanar with the back support portion 826 and a second out-of-the-way position in a manner similar to the way in which the shoulder support portions 28 are movable into and out of the respective cut-outs 228 of the back support section 26 as shown in FIGS. 24 and 25. However, portions 828 are movable manually relative to portion 826 whereas portions 28 are movable by powered drivers. Suitable manually releasable locking mechanisms, such as latches or spring-biased pins, are provided in module 804 to lock portions 828 relative to portion 826 in the first positions. For shoulder surgery, the shoulder surgery module 804 of the patient support deck 822 is articulated upwardly and the back section 824 is articulated slightly downwardly to support the patient in a sitting-up position as shown in FIG. 77. The shoulder support portions 828 of the shoulder surgery module 804 are then detached from the back support portion 826 and stowed, or are pivoted out of cut-outs 8228 to expose the posterior portions of the patient's shoulders.

As shown best in FIG. 76, shoulder surgery module 804 comprises a pair of brackets 850 that are configured to mate with powered pivot couplers 830. In the illustrative embodiment, brackets 850 each have a grip handle 851 that may be gripped by a caregiver to position shoulder surgery module 804 for attachment to couplers 830. A release lever or button may be coupled to handle 851 and may be actuated by a caregiver to move a lock or latch (not shown) out of engagement with couplers 830 to permit decoupling of shoulder surgery module 804 from couplers 830. In alternative embodiments, handles 851 are separate from the portions of brackets 850 that mate with couplers 830.

For spinal surgery, modules 804, 806 may be replaced with a spinal surgery board, such as spinal surgery board 340 shown in FIGS. 28 and 29, which couples to powered pivot couplers 830. Alternatively, sections 890, 8102, 8104 may be removed from traction bar assemblies 816 and sections, similar to spinal surgery sections 502, 504, 560, 570 (shown in FIGS. 41, 51 and 59) discussed above, may be coupled to traction bar assemblies 816 of module 806. Furthermore, a hip lift, similar to hip lift 530 (shown in FIG. 47) described above, may be coupled to first traction bars 862 of traction bar assemblies 816, if desired.

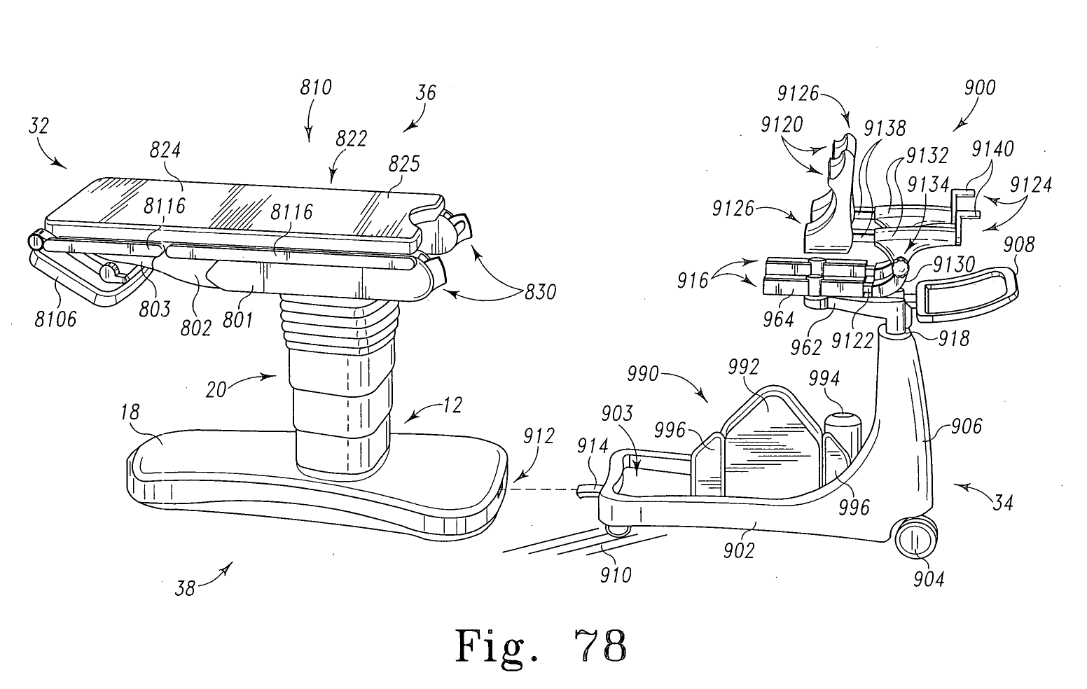

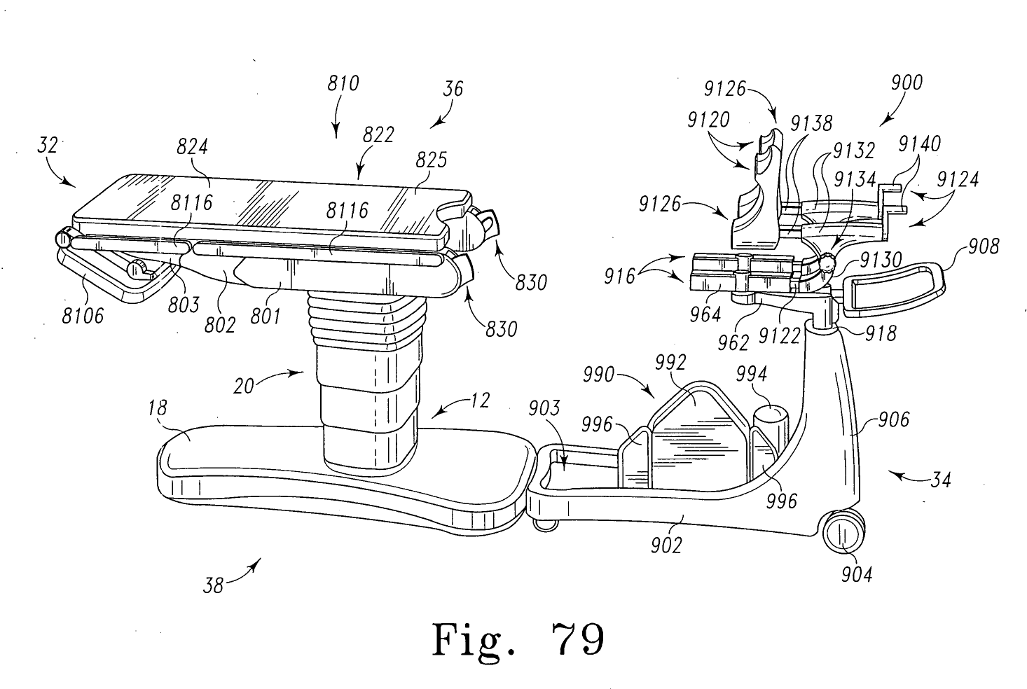

In some embodiments, a trauma surgery cart 900 having a pair of traction boot assemblies 9120 is used for trauma surgery as shown in FIGS. 78-83, instead of the trauma surgery module 806 shown in FIG. 74. To set up the surgical table 810 for trauma surgery using the trauma surgery cart 900, the transverse bar 814, the traction bar assemblies 816 and the trauma surgery module 806 comprising the seat section 890, the thigh sections 8102 and the calf sections 8104 are all detached from the powered pivot couplers 830, and the trauma surgery cart 900 is instead arranged for docking to the surgical table 810 as shown in FIG. 78. The trauma surgery cart 900 includes a base 902 supported on a set of wheels 904 and a column 906 extending upwardly from the base 902 near the foot end 34 of the cart 900. A push handle 908 is coupled to the column 906 to permit maneuvering of the cart 900 along a floor 910. The base 18 of the surgical table 810 includes a docking port 912, and the base 902 of the trauma surgery cart 900 includes a docking probe 914 that is configured for reception in the docking port 912 to ensure proper alignment of the trauma surgery cart 900 with the surgical table 810 as shown in FIG. 79. The docking port 912 includes one or more grippers or couplers, such as, for example, latches or clutches, that automatically grasp onto the docking probe 914 to lock the cart 900 to the surgical table 810 upon entry of the probe 914 into the docking port 912. Suitable release mechanisms are likewise provided to actuate the grippers or couplers to release the trauma surgery cart 900 from the surgical table 810 when desired.

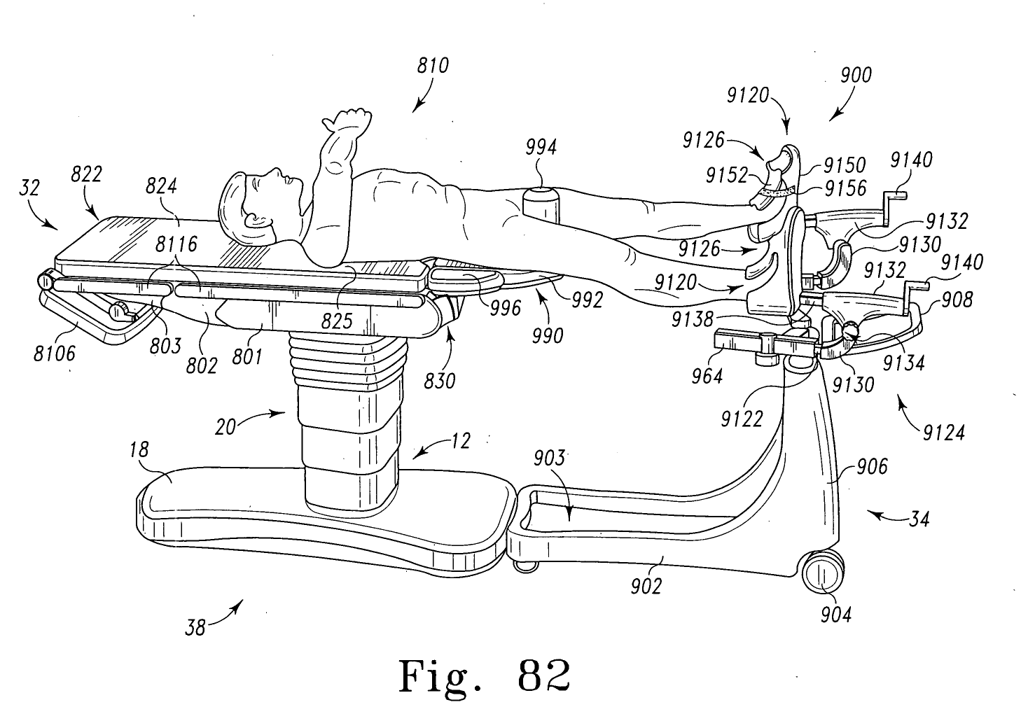

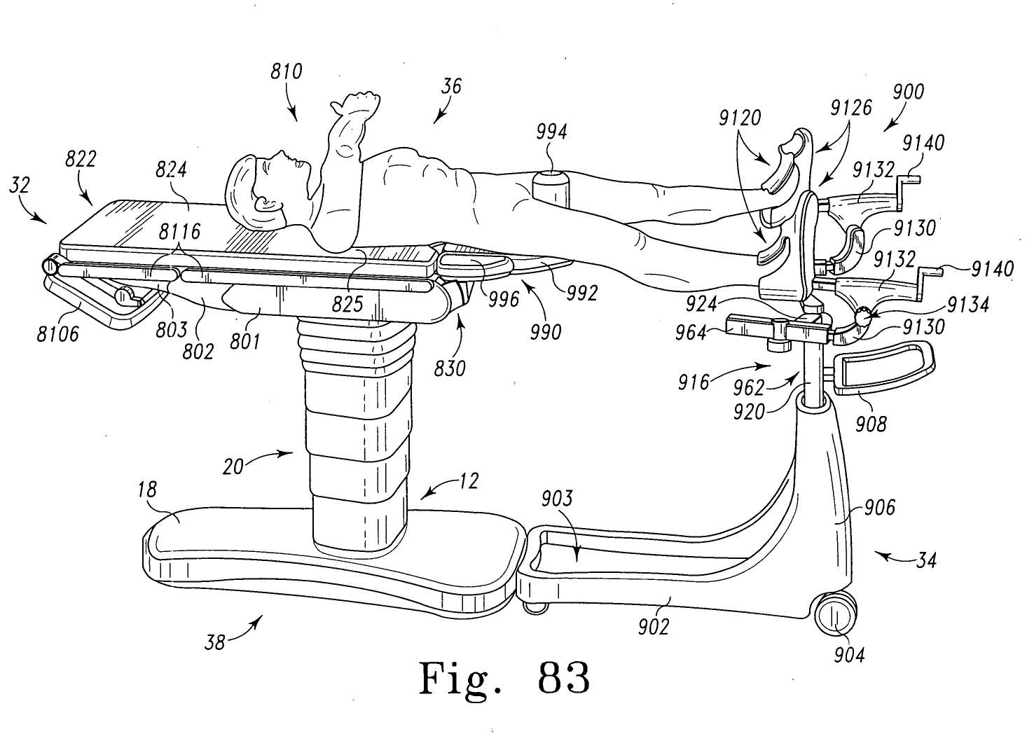

The traction boot assemblies 9120 are coupled to a pair of traction bar assemblies 916, which are, in part, received in column 906 for telescopic movement. A majority of assemblies 916, however, are situated above a top wall 918 of the column 906. The traction bar assemblies 916 each include a pivotally-mounted support 962 and a pivotally-mounted traction bar 964. As shown in FIG. 81, the support 962 has a vertically-extending first portion 920 coupled to column 906 for pivoting movement about a first vertical pivot axis 922 and a horizontally-extending second portion 924 extending forwardly from the first portion 920. The traction bar 964 is coupled to a distal end of the second portion 924 for pivoting movement about a second vertical pivot axis 926. The supports 962 are raiseable and lowerable relative to the base 902 of the cart 900. The pivotal mounting of the supports 962 relative to the column 906 and the pivotal mounting of the traction bars 964 relative to the associated supports 962 permit the caregiver to adjust the lateral positions of the traction boot assemblies 9120 so that the patient can rest comfortably on the surgical table 810 with the patient's feet coupled to the traction boot assemblies 9120 and with the countertraction post 894 received between the patient's legs and engaging the patient's pelvic region as shown in FIGS. 82 and 83. Suitable locking mechanisms are provided to lock supports 962 and bars 964 in desired positions.

The surgical table 810 includes a first hydraulic system that operates to raise, lower, and tilt the patient support deck 822. The trauma surgery cart 900 includes a second hydraulic system that operates to raise and lower the supports 962, and the traction boot assemblies 9120 coupled thereto. The first hydraulic system includes at least one first pump and at least one first valve that are electrically coupled to a first electric circuit to receive first control signals therefrom. The second hydraulic system includes at least one second pump and at least one second valve that are electrically coupled to a second electric circuit to receive second control signals therefrom. The second electric circuit of the cart 900 interfaces with the first electric circuit of the surgical table 810 to coordinate the raising and lowering of the traction boot assemblies 9120 with the raising and lowering of the patient support deck 822 as shown, for example, in FIGS. 82 and 83. FIGS. 82 and 83 show the patient support deck 822 and the traction boot assemblies 9120 in their lowered and raised positions respectively. Thus, an electrical connection is made when probe 914 enters port 912 so that the first and second electrical circuits associated with table 810 and cart 900, respectively, can communicate such as, for example, in a peer-to-peer arrangement or a master-slave arrangement. In addition, electrical power may be provided to cart 900 from table 810 through port 912 and probe 914.

In some embodiments, these hydraulic systems include hydraulic actuators such as the ones described above in connection with the hi/lo drive mechanism of the surgical table 10 which are operable to raise and lower the patient support deck 22. Illustratively, the first hydraulic system and the first electric circuit are housed within the base 18, the column 20 and portions of the deck 822 of the table 810, and the second hydraulic system and the second electric circuit are housed within the base 902 and the column 906 of the cart 900 in any suitable arrangement as is well-known in the art. In addition, the surgical table 810 has a user input device, such as a hand-held remote or pendant controller, that is used to command the operation of the various drive mechanisms of the table 810 and the cart 900.

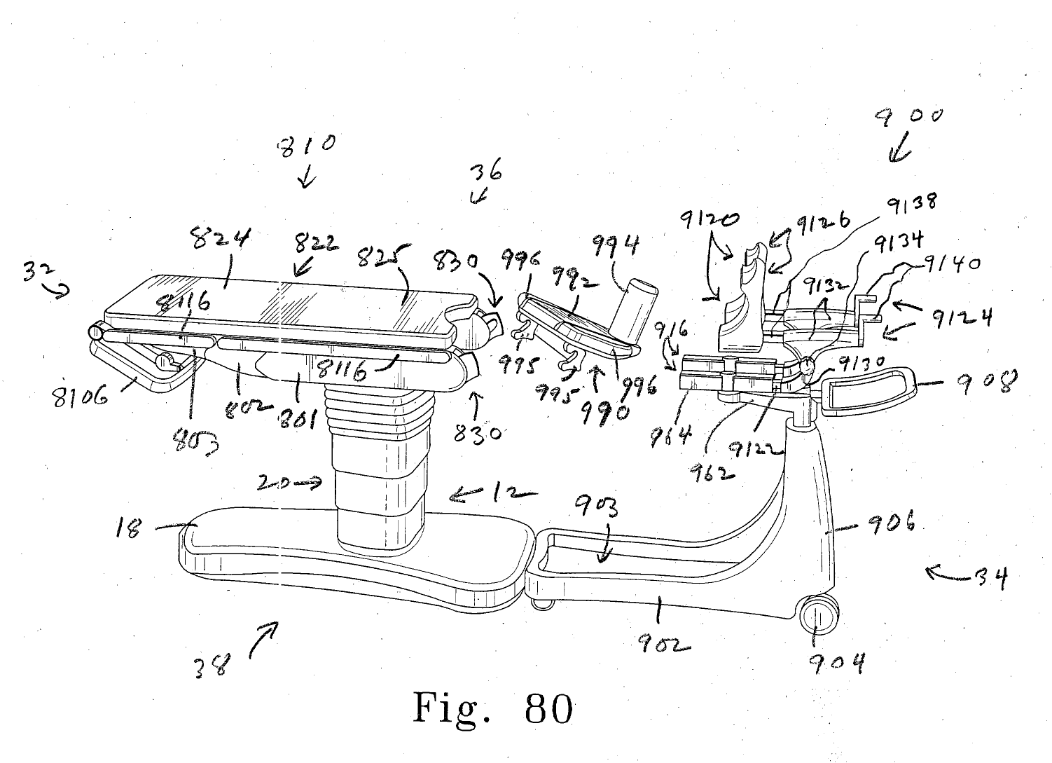

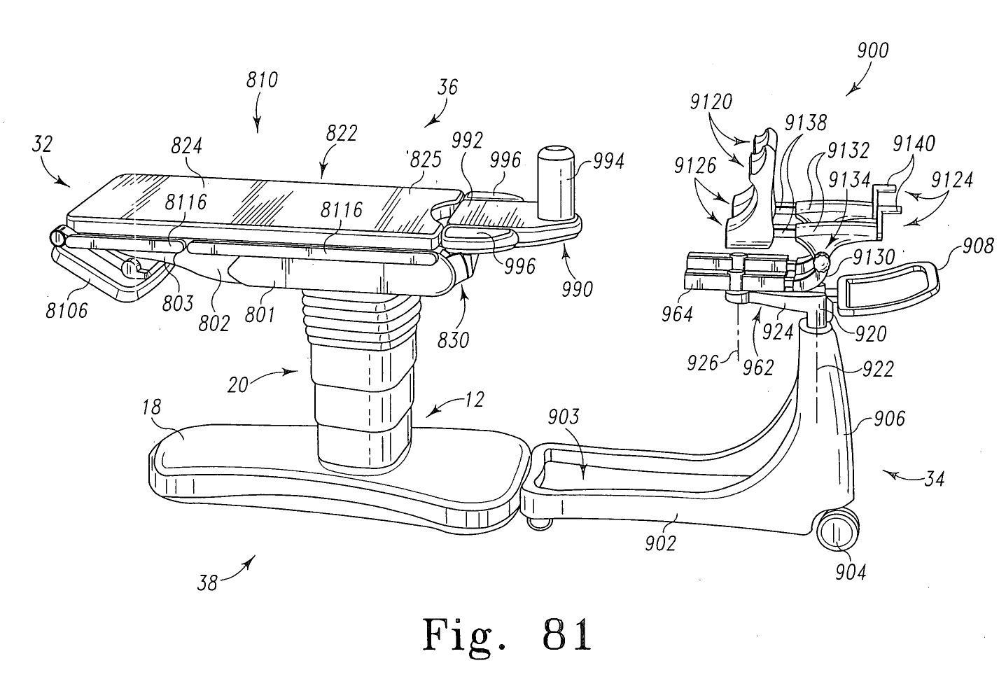

Seat section 990 used with cart 900 is substantially the same as seat section 890 of module 806 except that the seat section 990 used with cart 900 has brackets 995, shown in FIG. 80, that mate with powered pivot couplers 830 of the table 810, whereas seat section 890 of module 806 is coupled to transverse bar 814. Seat section 990 has a central portion 992, a countertraction post 994 and a pair of side portions 996 laterally outboard of the central portion 992. Base 902 has a recessed area 903 in which the associated seat section 890 may be stored and transported with cart 900. Other items (not shown) may also be placed in recessed area 903 to be transported with cart 900.

The traction boot assemblies 9120 are substantially the same as the traction boot assemblies 120 described previously in conjunction with FIGS. 6-16. The following description of one of traction boot assemblies 9120 with reference to FIGS. 78-83 is applicable to both traction boot assemblies 9120. The traction boot assembly 9120 comprises an elongated rod 9122, an adjustment assembly 9124 and a traction boot 9126. The bar 964 of the traction bar assemblies 916 is tubular and has an open end through which the elongated rod 9122 is inserted into the interior region of the bar 964 to couple the traction boot assembly 9120 to the support 962. The traction bar 964 and the elongated rod 9122 are each nonround in transverse cross-section to prevent rotation of the elongated rod 9122 relative to the bar 964 about an axis defined along the lengths thereof. The positions of the traction boot assemblies 9120 relative to the bars 964 are adjustable along the longitudinal axes of the respective bars 964. Suitable locking mechanisms (not shown) are provided to lock the position of the traction boot assemblies 9120 relative to the bars 964 as previously described in conjunction with FIGS. 6-16.

The adjustment assembly 9124 comprises a first member 9130 mounted to a distal end of the elongated rod 9122, a housing 9132 and a ball joint 9134 that couples the housing 9132 to the first member 9130 for pivoting movement about a plurality of pivot axes. The adjustment assembly 9124 further includes a tube 9138 that extends from the housing 9132 and a crank 9140 that is coupled to the housing 9132. When the crank 9140 is rotated in one direction, the tube 9138 retracts relative to the housing 9132. When the crank 9140 is rotated in an opposite direction, the tube 138 extends relative to the housing 132. The traction boot 9126 is configured to couple to a patient's foot as shown in FIGS. 82 and 83. Referring to FIG. 82, the illustrative traction boot 9126 has a first portion 9150, a second portion 9152 coupled to the first portion 9150 for pivoting movement, a strap 9156 to lock the second portion 9152 to the first portion 9150 and a post 9158. The first portion 9150 is configured to engage both the sole of a patient's foot and the back of the patient's heel. The second portion 9152 is movable to a variety of positions including an opened position in which a patient's foot may be inserted into the traction boot 9126, and a closed position engaging a top of the patient's foot as shown in FIGS. 82 and 83.

For applying bilateral hip traction to a patient's feet, the seat section 890 along with the countertraction post 894 is coupled to the pair of powered pivot couplers 830 as shown in FIGS. 80 and 81. The patient is supported on the surgical table 810 with his feet coupled to the traction boot assemblies 9120 as shown in FIG. 82. The lateral positions of the traction boot assemblies 9120 are adjusted to allow the patient to rest comfortably on the surgical table 810 with the countertraction post 894 between the patient's legs, and engaging the patient's pelvic region. Bilateral hip traction is applied to the patient as shown in FIG. 82 in a manner similar to the way in which bilateral hip traction is applied to the patient as shown, for example, in FIG. 17. The trauma surgery cart 900 is likewise used for applying unilateral hip traction and lateral intramedullary nailing procedure in the manner shown in FIGS. 18 and 19.

To recapitulate, the surgical table 810 is configurable for different types of orthopedic surgical procedures, and can also be configured for general surgical procedures. For example, for trauma surgery, the traction boot assemblies are coupled to the traction bar assemblies 816 to apply traction to a patient's legs. Alternatively, the trauma surgery cart 900 having a pair of traction boot assemblies 9120 may be used as shown, for example, in FIG. 82, For shoulder surgery, the trauma surgery module 806 is removed from the powered pivot couplers 830, and a shoulder surgery module 804 is instead coupled to the powered pivot couplers 830 as shown, for example, in FIG. 77. A spinal board (like board 340 shown in FIGS. 28 and 29) or spinal surgery sections (like sections 502, 504 560, 570 shown in FIGS. 41, 51 and 59) may be coupled to couplers 830 or traction bar assemblies 816, respectively, to configure table 810 for spinal surgery.

Although the present invention has been described in detail with reference to certain preferred embodiments, variations and modifications exist within the scope and spirit of the present invention as described and defined in the following claims.

1. A patient support apparatus comprising
an elongated patient support deck having a first section configured to support a first portion of a patient, a transverse bar coupled to the first section, and a pair of traction bar assemblies coupled to the transverse bar, the pair of traction bar assemblies being movable transversely along the transverse bar.

2. The patient support apparatus of claim 1, wherein the transverse bar and the pair of traction bar assemblies are pivotable relative to the first section about a transverse pivot axis.

3. The patient support apparatus of claim 2, further comprising a drive mechanism that is operable to pivot the transverse bar and the pair of traction bar assemblies relative to the first section.

4. The patient support apparatus of claim 1, wherein the transverse bar is formed to include a transversely extending channel, each traction bar assembly comprises a bracket, and a portion of each bracket is received in the transversely extending channel.

5. The patient support apparatus of claim 4, wherein each traction bar assembly has a clevis pivotable about a first pivot axis relative to the bracket and each traction bar assembly has a first bar pivotable about a second pivot axis relative to the clevis.

6. The patient support apparatus of claim 5, wherein the second pivot axis is orthogonal to the first pivot axis.

7. The patient support apparatus of claim 5, wherein each traction bar assembly has a first manual adjuster that tightens to prevent the respective clevis from pivoting relative to the associated bracket and each traction bar assembly has a second manual adjuster that tightens to prevent the respective first bar from pivoting relative to the associated clevis.

8. The patient support apparatus of claim 4, wherein each traction bar assembly has a second bar pivotable about a third pivot axis relative to the first bar.

9. The patient support apparatus of claim 8, wherein the third pivot axis is parallel with the second pivot axis.

10. The patient support apparatus of claim 8, wherein each traction bar assembly has a manual adjuster that tightens to prevent pivoting of the respective second bar relative to the associated first bar.

11. The patient support apparatus of claim 1, further comprising a second section configured to support a second portion of the patient and the second section being coupleable to the transverse bar.

12. The patient support apparatus of claim 11, wherein the second section is movable along the transverse bar.

13. The patient support apparatus of claim 12, wherein the transverse bar has a surface formed to include a transversely extending channel, the second section has a bracket, and a portion of the bracket is received in the transversely extending channel.

14. The patient support apparatus of claim 11, wherein the second section includes a countertraction post.

15. The patient support apparatus of claim 11, wherein the second section includes a central portion and a pair of side portions that are removably coupled to the central portion.

16. The patient support apparatus of claim 1, wherein each traction bar assembly includes a first bar that is pivotable relative to the transverse bar about at least one first pivot axis and a second bar that is pivotable relative to the second bar about at least one second pivot axis.

17. The patient support apparatus of claim 1, further comprising a leg section configured to couple to at least one of the pair of traction bars, the leg section being configured to support at least a portion of a patient's leg.

18. The patient support apparatus of claim 17, wherein the leg section has a panel, a mattress pad coupled to a top surface of the panel, and a bracket coupled to a bottom surface of the panel, each traction bar assembly has a bar of nonround cross section, and the bracket is shaped to fit onto the bar of nonround cross section.

19. The patient support apparatus of claim 18, wherein the leg section has a manual adjuster that tightens against the traction bar to lock the leg section in place relative to the traction bar.

20. The patient support apparatus of claim 1, further comprising a pair of traction boot assemblies configured to couple to the pair of traction bar assemblies, the traction bar assemblies each having an elongated traction bar, and each traction boot assembly being movable longitudinally along the respective elongated traction bar.

21. The patient support apparatus of claim 20, wherein each traction boot assembly has a traction boot that is configured to couple to a patient's foot and each traction boot is movable relative to the respective elongated traction bar.

22. The patient support apparatus of claim 21, wherein each traction boot has a first portion configured to engage a bottom of a patient's foot, a second portion coupled to the first portion for pivoting movement between a first position engaging a top of the patient's foot and a second position away from the first position, and a lock that engages the first and second portions to lock the second portion in the first position.

23. A patient support apparatus comprising
a first section configured to support a first portion of a patient,
a pair of articulated traction bar assemblies coupled to the first section,
a plurality of orthopedic surgery modules configured to couple to the pair of traction bar assemblies, the plurality of orthopedic surgery modules including a pair of first modules that are configured to apply traction to a patient's legs, a second module of the plurality of orthopedic surgery modules being configured to support an upper portion of a patient during shoulder surgery, and a third module of the plurality of modules being configured to support an upper portion of a patient during spinal surgery.

24. The patient support apparatus of claim 23, wherein each of the pair of traction bar assemblies has an elongated traction bar, each elongated traction bar is tubular defining an interior region, each elongated traction bar has an open end, and at least one of the orthopedic surgery modules has an elongated member that extends through the open end into the interior region of at least one of the traction bars when the at least one orthopedic surgery module is coupled to the traction bar assemblies.

25. The patient support apparatus of claim 23, wherein each of the pair of traction bar assemblies has an elongated traction bar with a first end and a second end, and at least one of the orthopedic surgery modules has a bracket that is removably attachable to a region of at least one of the traction bars between the first and second ends of the respective traction bar.

26. The patient support apparatus of claim 25, wherein the third module has a pair of brackets, each bracket of the pair of brackets being removably attachable to a respective one of the traction bars.

27. The patient support apparatus of claim 23, wherein the third module comprises a pad having an inflatable bladder.

28. The patient support apparatus of claim 23, wherein the third module comprises a pad having a plurality of inflatable bladders.

29. The patient support apparatus of claim 23, wherein the third module and the pair of traction bar assemblies are movable to a position to support a patient in a kneeling, face-down position having the patient's knees resting upon the first section and the first section has a bladder that is inflatable to increase the arch in the patient's spine when the patient is in the kneeling, face-down position.

30. The patient support apparatus of claim 23, wherein the third module and the pair of traction bar assemblies are movable to a position to support a patient in a kneeling, face-down position having the patient's knees resting upon the first section and further comprising a hip lift assembly coupled to the pair of traction bar assemblies, the hip lift assembly being configured to engage the patient's hips, and the hip lift assembly being operable to change the arch in the patient's spine.

31. The patient support apparatus of claim 30, wherein the hip lift assembly comprises a crank, a pair of rods that move upwardly when the crank is rotated in a first direction and that move downwardly when the crank is rotated in a second direction opposite to the first direction, and a pair of hip-engaging pads mounted to respective rods and configured to engage the patient's hips.

32. A patient support apparatus comprising
a first section configured to support a first portion of a patient,
a traction bar assembly having a first bar pivotable relative to the first section and a second bar pivotable relative to the first bar, the second bar being elongated to define a longitudinal axis, and
a traction boot assembly having a rod that is movable along the longitudinal axis, a traction boot configured to couple to a patient's foot, and an adjustment assembly coupled to the traction boot and coupled to the rod, the adjustment assembly being configured to permit rotational and translational adjustment of the traction boot relative to the rod.

33. The patient support apparatus of claim 32, wherein the adjustment assembly comprises a housing to which the traction boot couples and a ball joint that couples the housing to the rod.

34. The patient support apparatus of claim 33, wherein the adjustment assembly comprises a hand crank coupled to the housing, the hand crank is rotatable about an axis relative to the housing, and rotation of the hand crank about the axis translates the traction boot relative to the rod.

35. The patient support apparatus of claim 33, wherein the adjustment assembly comprises a manual adjuster that tightens to lock the ball joint to prevent rotation of the housing and traction boot relative to the rod and that loosens to unlock the ball joint to allow rotation of the housing and traction boot relative to the rod.

36. The patient support apparatus of claim 33, wherein the traction boot assembly has a post extending from the traction boot, the adjustment assembly has a tube extending from the housing, the tube has a first opening that receives the post when the traction boot is coupled to the tube in a first orientation, and the tube has a second opening that receives the post when the traction boot is coupled to the tube in a second orientation.

37. The patient support apparatus of claim 36, wherein the post is perpendicular to the tube when the traction boot is coupled to the tube in the first orientation and the post is substantially coaxial with the tube when the traction boot is coupled to the tube in the second orientation.

38. The patient support apparatus of claim 32, wherein the traction boot comprises a first portion configured to engage a bottom of a patient's foot, a second portion coupled to the first portion for pivoting movement between a first position engaging a top of the patient's foot and a second position away from the first position, and a lock that engages the first and second portions to lock the second portion in the first position.

39. The patient support apparatus of claim 38, wherein the lock comprises a strap that extends across a top surface of the second portion between a first side of the first portion and a second side of the first portion when the second portion is locked in the first position.

40. The patient support apparatus of claim 38, wherein the first portion is configured also to engage a back of a patient's heel.

41. The patient support apparatus of claim 40, wherein the first portion comprises a shell that is substantially rigid and a cushioning material coupled to at least part of the shell.

42. The patient support apparatus of claim 38, wherein the second portion comprises a shell that is substantially rigid and a cushioning material coupled to the at least part of the shell.

43. The patient support apparatus of claim 42, wherein the cushioning material engages the top of the patient's foot when the second portion is in the first position.

44. The patient support apparatus of claim 32, wherein the traction boot assembly has a post extending from the traction boot, the adjustment assembly has a tube, the tube has a first opening that receives the post when the traction boot is coupled to the tube in a first orientation, and the tube has a second opening that receives the post when the traction boot is coupled to the tube in a second orientation.

45. The patient support apparatus of claim 32, wherein the traction boot has a sole portion configured to engage a bottom of a patient's foot and a post extending from the sole portion, the sole portion having a long axis, the adjustment assembly has a tube, the tube having an interior region and an opening at an end of the tube, the post being insertable through the opening into the interior region to couple the traction boot to the tube having the long axis in a first orientation, and the post being insertable through the opening into the interior region to couple the traction boot to the tube having the long axis in a second orientation.

46. The patient support apparatus of claim 45, wherein the post has a square-shaped cross section, the tube has a tube wall of square-shaped cross section, and the tube wall engages the post to prevent the post and traction boot from rotating relative to the tube when the post is inserted into the interior region of the tube.

47. The patient support apparatus of claim 45, wherein the tube has a tube wall that is configured to engage the post when the post is inserted into the interior region of the tube to prevent rotation of the post relative to the tube.

48. A patient support apparatus comprising
a first section having a first portion and a second portion extending longitudinally away from a central region of the first portion, the first portion having a first transverse width, the second portion having a second transverse width that is smaller than the first transverse width such that a pair of cut-out areas are defined alongside opposite sides of the second portion,
a pair of shoulder sections coupled to the first portion for pivoting movement between respective first positions received in the respective cut-out areas and respective second positions away from the first positions, and
a head section having a frame with a pair of posts, a panel coupled to the frame, and a mattress pad coupled to the panel, the pair of shoulder sections having a pair of first sockets that are able to receive the pair of posts when the shoulder sections are in the first positions, and the first section having a pair of second sockets that are able to receive the posts when the shoulder sections are in the second positions.

49. The patient support apparatus of claim 48, further comprising a column, the first section being coupled to the column, the column being extendable to raise the first section, and the column being retractable to lower the first section.

50. The patient support apparatus of claim 49, wherein the first section has a patient support surface that is generally planar and the first section is tiltable relative to the column between a first position in which the patient support surface is horizontal and a second position in which the patient support surface is inclined relative to horizontal.

51. The patient support apparatus of claim 48, further comprising a driver that is operable to pivot at least one of the pair of shoulder sections relative to the first section.

52. The patient support apparatus of claim 48, further comprising a pair of accessory rails, each accessory rail being coupled to a respective one of the pair of shoulder sections.

53. The patient support apparatus of claim 48, wherein the frame of the head section further comprises a pair of frame members, the panel is pivotably coupled to the frame members, and the pair of posts are pivotably coupled to the pair of frame members.

54. The patient support apparatus of claim 53, wherein the pair of frame members angle upwardly from the pair of posts to support the panel and mattress pad of the head section above the second portion of the first section when the posts are received in the pair of second sockets.

55. A patient support apparatus comprising
a first section configured to support a first portion of a patient,
a pair of pivotable couplers coupled to the first section,
a pair of drivers that are operable to pivot the a pair of pivotable couplers relative to the first section,
a trauma surgery module coupleable to the pair of pivotable couplers, the trauma surgery module being configured to apply traction to the patient's legs, and
a spinal surgery module coupleable to the pair of pivotable couplers, the spinal surgery module being configured to support the patient's upper body.

56. The patient support apparatus of claim 55, wherein the trauma surgery module has a pair of articulated traction bars, a plurality of leg support sections removably coupled to the traction bars, and a traction boot assembly coupled to the traction bars.

57. The patient support apparatus of claim 55, wherein the spinal surgery module comprises an elongated, non-articulated panel, a frame coupled to the panel, and an elongated mattress pad coupled to the panel.

58. The patient support apparatus of claim 55, wherein the first section has a back support portion with a pair of cut-outs, the back section has a pair of shoulder support portions, each shoulder support portion being pivotable between a first position received in the respective cut-out and a second position moved out of the respective cut-out to expose a posterior portion of the patient's shoulder region for shoulder surgery.

59. The patient support apparatus of claim 55, wherein each of the pair of pivotable couplers has a lobe, the trauma surgery module comprises a pair of brackets each having a lobe-receiving space that receives a respective lobe to couple the trauma surgery module to the pair of pivot couplers.

60. The patient support apparatus of claim 55, wherein each of the pair of pivotable couplers has a lobe, the spinal surgery module comprises a pair of brackets each having a lobe-receiving space that receives a respective lobe to couple the spinal surgery module to the pair of pivot couplers.

61. A surgical table apparatus comprising
a base module, and
a spinal surgery module configured for attachment to the base module, the spinal surgery module having a plurality of air bladders, the plurality of air bladders being inflatable to a first configuration in which a central region of an upper surface of the spinal surgery module is higher in elevation than a head end region and a foot end region of the upper surface of the spinal surgery module, and the plurality of air bladders being inflatable to a second configuration in which the head end region and the foot end region of the upper surface of the spinal surgery module are higher in elevation than the central region of the upper surface of the spinal surgery module.

62. The surgical table apparatus of claim 61, further comprising a blower in the base module and a controller that controls the blower to inflate the plurality of air bladders to the first configuration and to the second configuration.

63. The surgical table apparatus of claim 62, further comprising a pneumatic coupler coupled to the base module, the pneumatic coupler being coupled pneumatically to the blower, and the spinal surgery module having a plurality of pneumatic lines that are coupled to the plurality of air bladders and that are configured to couple to the pneumatic coupler.

64. The surgical table apparatus of claim 61, wherein the plurality of air bladders comprises six air bladders that are arranged in three pairs of side-by-side air bladders.

65. A patient support apparatus comprising a patient support deck having a plurality of articulated deck sections, the patient support deck being movable to a configuration to support a patient in a kneeling, face-down position having knees of the patient resting upon a first deck section, and the first deck section having at least one bladder that, when inflated, raises the knees of the patient to arch a spine of the patient more than the spine of the patient is arched when the at least one bladder is deflated.

66. The patient support apparatus of claim 65, further comprising a base and a column extending upwardly from the base, the patient support deck being coupled to the column, and a pneumatic system being situated in the base and in the column, and the pneumatic system being operable to inflate the air bladder.

67. A patient support apparatus comprising
a patient support deck having a plurality of articulated deck sections, the patient support deck being movable to a configuration to support a patient in a kneeling, face-down position, and
a hip lift coupled to the patient support deck, the hip lift being configured to engage the hips of the patient, the hip lift is movable to raise the patient's hips to increase arching of a spine of the patient.

68. The patient support apparatus of claim 67, wherein the hip lift comprises a pair of hip pads that are configured to engage the patient's hips, a pair of rods coupled to the pair of hip pads, and a lift mechanism that moves the rods to change the elevation of the hip pads.

69. The patient support apparatus of claim 68, wherein the patient-support deck has a pair of frame members, the lift mechanism comprises a pair of bodies that couple to the pair of frame members, the pair of rods are coupled to the pair of bodies, and the lift mechanism comprises a crank that is coupled to the pair of bodies and that is rotatable to move the rods relative to the bodies.

70. The patient support apparatus of claim 68, wherein the pair of rods each have a first portion coupled to the lift mechanism and a second portion that is coupled to the respective hip pad, the second portions are rotatable relative to the first portions in respective first directions to move the hip pads toward the patient's hips, and the second portions are rotatable relative to the first portions in a second direction to move the hip pads away from the patient's hips.

71. The patient support apparatus of claim 67, wherein a portion of the hip lift is situated below an overlying portion of the patient support deck.

72. The patient support apparatus of claim 71, wherein the portion of the hip lift situated below the overlying portion of the patient support deck comprises a hand crank that is rotatable to raise the patient's hips.

73. A surgical table apparatus comprising
a patient support deck having at least one deck section configured to support at portion of a patient,
a pair of spaced, elongated bars coupled to the patient support deck, and
a spinal surgery module coupled to the spaced, elongated bars, the spinal surgery module having a plurality of patient support sections, at least one of the plurality of patient support sections being adjustable about a pivot axis that is parallel to the spaced, elongated bars.

74. The surgical table apparatus of claim 73, wherein the plurality of patient support sections comprise three pairs of side-by-side patient support sections.

75. The surgical table apparatus of claim 74, wherein the patient support sections of a middle pair of the side-by-side patient support sections are longer than the patient support sections of the other two pairs of side-by-side patient support sections.

76. The surgical table apparatus of claim 75, wherein the middle pair of side-by-side patient support sections is removable from the spaced, elongated bars.

77. The surgical table apparatus of claim 74, wherein each of the patient support sections of two of the pairs of side-by-side patient support sections are pivotable relative to the spaced, elongated bars.

78. The surgical table apparatus of claim 73, wherein the spinal surgery module comprises a manual adjuster that is movable to a first position permitting the at least one patient support section to pivot about the axis relative to the spaced, elongated bars and that is movable to a second position preventing the at least one patient support section from pivoting about the axis relative to the spaced, elongated bars.

79. A bariatric overlay apparatus for use with a patient support apparatus having a first section including a pair of cut-out areas and a pair of shoulder sections coupled to the first section for pivoting movement between respective first positions received in the respective cut-out areas and respective second positions away from the first positions, the bariatric overlay apparatus comprising
a first bariatric section that is attachable to the first section and that is wider than the first section, and
a pair of bariatric shoulder sections that are attachable to the pair of shoulder sections and that are wider than the shoulder sections, the bariatric shoulder sections being pivotable along with the shoulder sections when the bariatric shoulder sections are attached to the shoulder sections.

80. The bariatric overlay apparatus of claim 79, wherein the pair of bariatric shoulder sections are coupled to the first bariatric section such that the first bariatric section and the pair of bariatric shoulder sections couple to the first section and the pair of shoulder sections of the patient support apparatus as a unit.

81. The bariatric overlay apparatus of claim 79, wherein the first bariatric section has at least one accessory rail that lies laterally outboard of the first section when the first bariatric section is coupled to the first section.

82. The bariatric overlay apparatus of claim 79, wherein the pair of bariatric shoulder sections have a pair of accessory rails that lie laterally outboard of the pair of shoulder section when the pair of bariatric shoulder sections are coupled to the pair of shoulder sections.

83. The bariatric overlay apparatus of claim 79, further comprising a bariatric seat section coupled to the first bariatric section, the bariatric seat section replacing a seat section of the patient support apparatus when the first bariatric section is coupled to the first section, and the bariatric seat section being wider than the seat section.

84. The bariatric overlay apparatus of claim 83, wherein the bariatric seat section is pivotable relative to the first bariatric section.

85. The bariatric overlay apparatus of claim 83, wherein the bariatric seat section has a rounded, convex edge that faces away from the first bariatric section.

86. A patient support apparatus comprising
a patient support deck having a first deck section and a pair of first couplers coupled to the first deck section for pivoting movement,
a pair of drivers coupled to the first deck section and to the pair of couplers, the pair of drivers being operable to pivot the couplers relative to the first deck section, and
a plurality of orthopedic surgery modules, each orthopedic surgery module having a pair of second couplers that mate with the first couplers to couple the respective orthopedic surgery module to the first deck section for pivoting movement, each of the pair of second couplers having a lobe-receiving space, each of the pair of first couplers having a lobe that is received in the lobe-receiving space when respective second couplers are mated with the first couplers.

87. The patient support apparatus of claim 86, wherein the plurality of orthopedic surgery modules includes a pair of first modules that are configured to apply traction to a patient's legs, a second module that is configured to support an upper portion of a patient during shoulder surgery, and a third module that is configured to support an upper portion of a patient during spinal surgery.

88. An orthopedic surgery system comprising
a base module having a first base and a patient support deck supported above the first base, the patient support deck being configured to support a torso of a patient, and
a cart having a second base, a plurality of wheels coupled to the second base to permit maneuvering of the cart along a floor, and a pair of traction boot assemblies coupled to the second base, the cart being dockable to the base module, the traction boot assemblies being operable to apply traction forces to legs of the patient when the cart is docked to the base module.

89. The orthopedic surgery system of claim 88, wherein the patient support deck is raiseable and lowerable relative to the first base and the traction boot assemblies are raiseable and lowerable relative to the second base.

90. The orthopedic surgery system of claim 89, wherein the base module has a first electric circuit, the cart has a second electric circuit, and the second electric circuit interfaces with the first electric circuit to form a system electric circuit that coordinates the raising and lowering of the traction boot assemblies with the patient support deck.

91. The orthopedic surgery system of claim 90, wherein the base module includes a first hydraulic system that operates to raise and lower the patient support deck, the first hydraulic system having at least one first pump and at least one first valve that are coupled electrically to the system electric circuit to receive first control signals therefrom, the cart includes a second hydraulic system that operates to raise and lower the traction boot assemblies, the second hydraulic system having at least one second pump and at least one second valve that are coupled electrically to the system electric circuit to receive second control signals therefrom.
